(19) United States
(12) Patent Application Publication
(10) Pub. No.: US 2015/0294591 A1
(43) Pub. Date: Oct. 15, 2015

(54) NEUROPERFORMANCE

(71) Applicant: ASPEN PERFORMANCE TECHNOLOGIES, Jerusalem (IL)

(72) Inventors: Jose Roberto KULLOK, Jerusalem (IL); Saul KULLOK, Jerusalem (IL)

(21) Appl. No.: 14/681,690

(22) Filed: Apr. 8, 2015

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.
Application No. 14/251,041 is a continuation-in-part of application No. 14/468,930, filed on Aug. 26, 2014.
Application No. 14/468,930 is a continuation-in-part of application No. 14/468,951, filed on Aug. 26, 2014.
Application No. 14/468,951 is a continuation-in-part of application No. 14/468,975, filed on Aug. 26, 2014.
Application No. 14/468,975 is a continuation-in-part of application No. 14/468,990, filed on Aug. 26, 2014.
Application No. 14/468,990 is a continuation-in-part of application No. 14/468,985, filed on Aug. 26, 2014.
Application No. 14/468,985 is a continuation-in-part of application No. 14/469,011, filed on Aug. 26, 2014.

(51) Int. Cl. G09B 19/00; G09B 5/02

(52) U.S. Cl. CPC G09B 19/00; G09B 5/02

(57) ABSTRACT

Methods of promoting fluid intelligence abilities in a subject are described herein. In particular, exemplary exercises are directed at sensorially perceptually searching and discriminating one or more similarities between the serial order of letters in non-word name label groups, belonging to a relational category represented by a preselected relational non-word name label, and one or more word name labels from a group of words. Correctly sensory motor selected word name labels are highlighted to the subject by displaying the same with at least one changed spatial and/or time perceptual related attribute. Embedded relational open proto-bigrams are further highlighted in the correctly selected word name labels by at least one additional changed spatial and/or time perceptual related attribute.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014; and U.S. patent application Ser. No. 14/468,930, U.S. patent application Ser. No. 14/468,951, U.S. patent application Ser. No. 14/468,975, U.S. patent application Ser. No. 14/468,990, U.S. patent application Ser. No. 14/468,985, and U.S. patent application Ser. No. 14/469,011, all filed on Aug. 26, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential, statistical and combinatorial properties of alphanumerical series of symbols (e.g., in alphabetical series, letter sequences and series of numbers). These sequential, statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This non-pharmacological technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling sufficient transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of natural numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-alphabetical-linguistic plasticity, thus preventing or decelerating the chemical break-down initiation of the biological neural machine as it grows old.

The present non-pharmacological technology accomplishes this by principally focusing on the root base component of language, its alphabet. In particular, the constituent parts, namely the letters and letter sequences (chunks) are intentionally organized without altering the intrinsic direct or inverse alphabetical order to create rich and increasingly complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on numerical series of natural numbers. Specifically, the natural numerical constituent parts, namely single natural number digits and number sets (numerical chunks), are intentionally organized without altering the intrinsic direct or inverse serial order in the natural numbers numerical series to create rich and increasingly novel serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition).

Further, the present non-pharmacological technology also derives its effectiveness by promoting strong arousal when reasoning in order to efficiently problem solve provided serial order(s) of symbols and numbers. Arousal when reasoning is promoted via an intentional sensorial perceptual discrimination and processing of phonological and visual serial order information among alphabetical structures (e.g., relative serial ordinal positions of letters and serial orders of letter chunks and statistical regularities and combinatorial properties of the same, including non-word serial order letter patterns). Accordingly, neuronal plasticity, in general, across several distant brain regions and hemispheric related language neural plasticity, in particular, are promoted.

The scope of the present non-pharmacological technology is not intended to be limited to promoting fluent reasoning abilities by promoting selective discrimination of serial orders of single letters in letter chunk patterns and/or frequency distribution of the same in letter sequences to enable the subject to implicitly transfer acquired knowledge about the letters' sequential order(s) and explicitly formulate strategies that facilitate lexical-semantic recognition. The present non-pharmacological technology teaches novel ways of problem solving by the sensorial-perceptual-motor grounding of higher order relational lexical knowledge. Accordingly, the present exercises intentionally promote fluid reasoning to quickly enact an abstract conceptual mental web where a number of relational direct, inverse, and incomplete alphabetic arrays interrelate, correlate, and cross-correlate with each other such that the processing and real-time manipulation of these arrays is maximized in short-term memory. In other words, the alphabetic arrays utilized herein are purposefully selected and arranged with the intention of bypassing long-term memory processing of semantic information in a subject. By presenting selected alphabetic arrays in the novel configurations described herein, the subject is not required to use cognitive resources, e.g. recall-retrieval of prior semantic knowledge and/or learning strategies based on categorical and associative semantic learning, to solve the present exercises. More specifically, the present exercises are designed to minimize or eliminate the subject's need to access prior known semantic knowledge by focusing on the intrinsic seriality of the alphabetic arrays even for the case where the alphabetic array(s) conveys a semantic meaning. Principally, the novel problem solving of the serial order(s) of alphabetical and number symbols exercises disclosed herein grants fast and direct access to higher order cognitive conceptualization constructs involving degrees of interrelated, correlated and cross-correlated lexical relational knowledge while providing minimal access, if any, to stored lexical meaning (e.g., recall-retrieval) from long term memory.

The advantage of the non-pharmacological cognitive intervention technology disclosed herein is that it is effective, safe, and user-friendly. This technology principally concentrates on the novel cognitive and sensorial perceptual grounding of symbol terms occupying intrinsic relational serial orders in alphabetic, numerical, and alphanumerical arrays through the on-line performance of the sensorial perceptual search, discrimination and sensory motor selection of the same. This technology also demands little or no arousal towards semantic constructs, and thus low attentional drive to automatically recall/retrieve semantic information from long term memory storage is expected. Further advantages include that this technology is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the method that the present exercises use in promoting fluid intelligence abilities in a subject by sensorially perceptually searching and discriminating one or more similarities between the serial order of letters in non-word name label groups, belonging to a relational category designated by a preselected relational non-word name label, and at least one word name label from a group of words.

FIGS. 2A and 2B depict a number of non-limiting examples of the block 1 exercises for sensorially perceptually searching and discriminating one or more similarities between the serial order of letters in non-word name labels and at least one word name label from a group of words. FIG. 2A shows a first group of non-word name labels and a preselected relational non-word name label. A second group of word name labels are displayed underneath the first group and the preselected relational non-word name label. In FIG. 2B, the correctly selected name label TOY is shown as highlighted with a white font over a black background and the embedded ROPB ‘TO’ is further highlighted therein by the changed time perceptual related attribute of font color from default to blue.

FIGS. 3A and 3B depict another example of the block 1 exercises for sensorially perceptually searching and discriminating one or more similarities between the serial order of letters in non-word name labels and at least one word name label from a group of words. FIG. 3A shows a first group of non-word name labels and a preselected relational non-word name label. A second group of word name labels are displayed underneath the first group and the preselected relational non-word name label. In FIG. 3B, the correctly selected name label ANT is displayed with a yellow font over a black background having the changed spatial perceptual related attribute of font size. The embedded ROPB ‘AN’ is further highlighted by the changed spatial perceptual related attribute of font boldness. Likewise, the embedded ROPB ‘AT’ is further highlighted by the changed spatial perceptual related attribute of font size.

FIGS. 4A and 4B depict another example of the block 1 exercises for sensorially perceptually searching and discriminating one or more similarities between the serial order of letters in non-word name labels and at least one word name label from a group of words. FIG. 4A shows a first group of non-word name labels and a preselected relational non-word name label. A second group of word name labels are displayed underneath the first group and the preselected relational non-word name label. In FIG. 4B, the correctly selected word name label ICE is displayed with a white font over a black background and is further highlighted by the changed spatial perceptual related attribute of font size.

FIGS. 5A and 5B depict a number of non-limiting examples of the block 2 exercises for sensorially perceptually searching and discriminating one or more similarities between the serial order of letters in non-word name labels and at least one word name label from a group of words. FIG. 5A shows a first group of non-word name labels and a preselected relational non-word name label. A second group of word name labels are displayed underneath the first group and the preselected relational non-word name label. In FIG. 5B, the correctly selected word name label TOMB is shown as highlighted by the changed spatial perceptual related attribute of font boldness and the embedded ROPB ‘TO’ is further highlighted therein by the changed spatial perceptual related attribute of font type.

FIGS. 6A and 6B depict another example of the block 2 exercises for sensorially perceptually searching and discriminating one or more similarities between the serial order of letters in non-word name labels and at least one word name label from a group of words. FIG. 6A shows a first group of non-word name labels and a preselected relational non-word name label. A second group of word name labels are displayed underneath the first group and the preselected relational non-word name label. In FIG. 6B, the correctly selected word name label BEAM is shown as highlighted by the changed spatial perceptual related attribute of font letter case. Embedded ROPB's ‘BE’ and ‘AM’ are further highlighted therein by the changed time perceptual related attribute of font color from default to red and blue, respectively.

### DETAILED DESCRIPTION

II. Higher-Order Cognitive Relational Knowledge in Words within Words

### Introduction

To what degree is natural language involved in human cognition? Do thought processes involve language? To what extent is human thinking dependent upon possession of one or more natural language? Humboldt (1836) viewed language as the formative organ of thought and held that thought and language are inseparable (Gumperz, J., and Levinson, S. (1996). Rethinking Linguistic Relativity. Cambridge: Cambridge University Press; Lucy, J. A. (1996). The scope of linguistic relativity: An analysis and review of empirical research. In J. J. Gumperz & S. C. Levinson (Eds.), Rethinking Linguistic Relativity (pp. 37-69). Cambridge, England: Cambridge Press). The anthropologist Lee Whorf proposed ways by which natural language serves to structure and shape human cognition. Whorf, the same as Humboldt, was concerned with the relevance of language to thought, and he argued that the language we acquire influences how we see the world (and therefore the grammatical structure of a language shapes a speakers' perception of the world). Whorl's influential hypothetical views can be summarized in the following two conjectures:

### 1. the Strong Conjecture

“We dissect nature along lines laid down by our native language. The categories and types that we isolate from the world of phenomena we do not find there because they stare every observer in the face; on the contrary, the world is presented in a kaleidoscope flux of impressions which has to be organized by our minds—and this means largely by the linguistic systems of our minds” (Whorf, B. L. (1956). Language, Thought and Reality. Selected Writings. Ed.: J. B. Carroll. MIT, New York: J. Wiley/London: Chapinaon & Hall).

### 2. The Weaker Conjecture

“My own studies suggest, to me, that language, for all its kingly role, is in some sense a superficial embroidery upon deeper processes of consciousness, which are necessary before any communication, signaling, or symbolism whatsoever can occur” (Whorf, B. L. (1956). Language, Thought and Reality. Selected Writings. Ed.: J. B. Carroll. MIT, New York: J. Wiley/London: Chapinaon & Hall).

Nonetheless, the strongly contested but influential hypothesis that has come to be known as the Whorfian hypothesis, or alternatively as the Sapir-Whorf hypothesis, states that (1) languages vary in their semantic partitioning of the world; (2) the structure of one's language influences the manner in which one perceives and (conceptually) understands the world; (3) therefore, speakers of different languages will perceive the world differently. Since the early 1990s, however, Whorfianism has been undergoing something of a revival, albeit in a weakened form (Hunt, E., and Agnoli, F. (1991). The Whorfian hypothesis: A Cognitive psychology perspective. Psychological Review 98: 377-89; Lucy, John A. (1992a). “Grammatical Categories and Cognition: A Case Study of the Linguistic Relativity Hypothesis”. Cambridge: Cambridge University Press, and (1992b). “Language Diversity and Thought: A Reformulation of the Linguistic Relativity Hypothesis”. Cambridge: Cambridge University Press; Gumperz, J., and Levinson, S. (1996). Rethinking Linguistic Relativity. Cambridge: Cambridge University Press).

This new wave of research no longer argues that language has a structuring effect on cognition (meaning that the absence of language makes certain sorts of thoughts or cognitive processes completely unavailable/unattainable to people). Rather, one or another natural language can make certain sorts of thought and cognitive processes more likely, and more accessible to people. The basic point can be expressed in terms of Slobin's (1987) idea of “thinking for speaking” (Slobin D. (1987). Thinking for speaking. Proceeding of the Berkeley Linguistics Society 13: 435-45). Variants of this idea have been considered before. Pinker, for example, states that “Whorf was surely wrong when he said that one's language determines how one conceptualizes reality in general. But he was probably correct in a much weaker sense: one's language does determine how one must conceptualize reality when one has to talk about it” (Pinker, S. (1989). Learnability and cognition: The acquisition of argument structure. Cambridge, Mass.: MIT Press).

Yet, after decades of neglect, the question of the relevance of language to cognition has resurfaced and has become an arena of active scientific investigation. Three influential themes can be credited for this subject's reemergence.

The first theme developed from the work of Talmy, Langacker, Bowerman, and other language researchers who, beginning in the 1970s, analyzed the semantic systems of different languages and demonstrated convincingly that an important difference exists in how languages carve up the world. For example, the English and Korean languages offer their speakers very different ways of talking about joining objects. In English, placing a video cassette in its case or an apple in a bowl is described as putting one object in another. However, Korean makes a distinction according to the fit between the objects: a videocassette placed in a tight-fitting case is described by the verb kkita, whereas an apple placed in a loose-fitting bowl is described by the verb nehta. Indeed, in Korean, the ‘fitting’ notion is more important than the ‘containment’ notion. Unlike English speakers, who say that the ring is placed on the finger and that the finger is placed in the ring, Korean speakers use kkita to describe both situations since both involve a tightfitting relation between the objects (Choi, S., and Bowerman, M. (1991). Learning to express motion events in English and Korean: The influence of Language-specific lexicalization patterns. Cognition, 41, 83-121). As a consequence, a number of researchers have taken the task to explore ways in which semantic structure can influence conceptual structure.

The second theme developed from a set of theoretical arguments. These include the revival of Vygotsky's constructivist approach centering in the importance of language in cognitive development, namely how abstract cognitive cognition develops through the child's interaction with cultural and linguistic systems (Vygotsky, L. (1962). Thought and Language. Cambridge, Mass.: MIT Press). Soviet psychologist Lev Vygotsky developed his ideas on interrelations existing between language and thought in the course of child development as well as in mature human cognition. One of Vygotsky's ideas concerned the ways in which language deployed by adults can scaffold children's development, yielding what he called a “zone of proximal development.” He argued that what children can achieve alone and unaided is not a true reflection of their understanding. Rather, there is also a need to consider what they can do when supported (scaffold) by the instructions and suggestions of an adult. Moreover, such scaffolding not only enables children to achieve with others what they would be incapable of achieving alone, but plays a causal role in enabling children to acquire new skills and abilities.

Consequently, Vygotsky focused on the overt speech of children, arguing that it plays an important role in problem solving, partly by serving to focus their attention, and partly through repetition and rehearsal of adult guidance. Vygotsky claimed that this role does not cease when children stop accompanying their activities with overt monologues, but disappears inwards. Vygotsky argued that in older children and in adults, inner (subvocal) speech serves many of the same functions. For example, Diaz and Berk studied the self-directed verbalizations of young children during problem-solving activities (Diaz, R., and Berk, L. (eds.) (1992). Private Speech: From Social Interaction to Self-Regulation. Hillsdale, N.J.: Erlbaum). They found that children tended to verbalize more when the tasks were more difficult, and that children who verbalized more often were more successful in their problem solving. Likewise, Clark draws attention to the many ways in which language is used to support human cognition, ranging from shopping lists and post-it notes, to the mental rehearsal of instructions and mnemonics, to the performance of complex arithmetic calculations on pieces of paper. By writing an idea down, for example, one can present himself with more leisured reflection, leading to criticism and further improvement (Clark, A. (1998). Magic words: How language augments human computation. In P. Carruthers and J. Boucher (eds.), Language and Thought. Cambridge: Cambridge University Press).

Another influential review paper was Hunt and Agnoli's, making the case that language influences thought by instilling cognitive habits (Hunt, E., & Agnoli, F. (1991). The Whorfian hypothesis: a cognitive psychology perspective. Psychological Review, 98(3), 377-389). They proposed a different line of approach that produced evidence in support of the Whorfian linguistic relativity hypothesis. This approach calculates the number of decisions a person has to make while choosing a word or constructing an utterance (an analogy of computational models). One factor to consider is the coding conditions, which place a demand on the user's psychological capacity, depending on the language used. Recognition and selection of lexical terms, and analysis of structures, place certain demand on the long term and short term memory. This suggests that the language a user employs to think most efficiently about topics have efficient codes provided by the lexicon (Whorf believed that the grammar of a language is a more important determinant of thought than the categorizations of the lexicon). Hunt and Agnoli concluded that a sample of these lexicons could be objectively chosen and a minimal size effect tested. Therefore, if it is possible to find cross linguistic effects are as large as intralingual effects, the Whorfian hypothesis could be tested.

In order to explore the possible effect of language on thought, Miller and Stigler chose to concentrate first on representational level thinking, where two sources of information seemed particularly important for this area of study: the lexically identified concepts and the culturally developed schema. They argued that people consider the cost of computation when they reason about a topic and different languages involve different costs for transmission of messages, thus language influences cognition. Miller and Stigler's exploration on the possible effect of language on thought was carried out in research on cross linguistic differences in number systems and their influence on learning arithmetic (Miller, K. F., & Stigler, J. W. (1987). Counting in Chinese: Cultural variation in a basic cognitive skill. Cognitive Development, 2, 279-305).

The research of Leslie et al. concentrated on exact numerical concepts for numbers larger than four (“five”, “six”, “seven”, “eight”, “fifteen”, “seventy-four”, “two million” and so forth). Most researchers agree that such numbers' acquisition is dependent upon language, specifically on the mastery of count-word lists (“five”, “six”, “seven”, “eight”, “nine”, and so on) together with the procedures of counting; that is, exact number information is stored along with its natural language encoding (see Leslie et al. (2007). Where Do the Integers Come From? In P. Carruthers, S, Laurence, and S. Stich (EDS.), The Innate Mind: Volume 3: Foundations and the Future. Oxford: Oxford University Press). Moreover, Lucy conducted important research on how cognition is affected by classifier grammars (Lucy, J. A. (1994). Grammatical categories and cognition. Cambridge: Cambridge University Press).

The third important theme was the investigation of ‘the spatial domain’, rather than focusing on studying a particular phenomenon, such as color. Domains, such as space, offer much richer possibilities for cognitive effects. Spatial relations are highly variable cross linguistically and this fact suggests the possibility of corresponding cognitive variability (e.g., Bowerman, M. (1980). The structure and origin of semantic categories in the language-learning child. In M. L. Foster and S. Brandes (Eds.), Symbol as sense (pp. 277-299). New York: Academic Press and, Bowerman, M. (1989). Learning a semantic system: What role do cognitive predispositions play? In M. L. Rice and R. L. Schiefelbusch (Eds.), The teachability of language (pp. 133-168). Baltimore: Brookes and Bowerman, M. (1996). Learning how to structure space for language: A cross-linguistic perspective. In P. Bloom, M. A. Peterson, L. Nadel, and M. F. Garret (Eds.), Language and space (pp. 385-436). Cambridge, Mass.: MIT Press; Brown, P. (1994). The INs and ONs of Tzeltal locative expressions: The semantics of static descriptions of locations. Linguistics, 32, 743-790; Casad, E. H., and Langacker, R. W. (1985). “Inside” and “outside” in Cora grammar. International Journal of American Linguistics, 51, 247-281; Levinson, S. C., and Brown, P. (1994). Immanuel Kant among the Tenejapans: Anthropology as applied philosophy. Ethos, 22, 3-41; Talmy, L. (1975). Semantics and syntax of motion. In J. Kimball (Ed.), Syntax and semantics (Vol. 4, pp. 181-238). New York: Academic Press and (1985). Lexicalization patterns: Semantic structure in-lexical forms. In T. Shopen (Ed.), Language typology and syntactic description: Vol. 3. Grammatical categories and the lexicon (pp. 57-149). New York: Cambridge University Press). Further, spatial relational terms provide framing structures for the encoding of events and experience. Therefore, spatial relational terms play a more interesting cognitive role than color names.

Finally, spatial relations, like color concepts, are amenable to objective testing in a more direct way than, say, people's concepts of justice or causality. The work of Levinson's research group demonstrates the cognitive differences that follow from differences in spatial language, specifically from the use of absolute spatial terms (analogous to north-south) versus geocentric terms (e.g., right/left/front/back). If, for example, a speaker's language requires him/her to describe spatial relationships in terms of compass directions, then the speaker will continually need to pay attention to and compute geocentric spatial relations. In contrast, if descriptions in terms of “left” and “right” are the norm, then geocentric relations will barely need to be noticed. This might be expected to have an impact on the efficiency with which one set of relations is processed relative to the other, and on the ease with which they are remembered (Levinson, S. C. (1996). Relativity in spatial conception and description. In J. J. Gumperz and S. C. Levinson (Eds.), Rethinking linguistic relativity (pp. 177-202). Cambridge: Cambridge University Press).

Levinson's work has been extremely influential in attracting renewed interest to the Whorfian hypothesis, either arguing for the effect or against it (Levinson, S. C. (1996). Relativity in spatial conception and description. In J. J. Gumperz and S. C. Levinson (Eds.), Rethinking linguistic relativity (pp. 177-202). Cambridge: Cambridge University Press and (1997). From outer to inner space: Linguistic categories and non-linguistic thinking. In J. Nuts and E. Pederson (Eds.), Language and conceptualization (pp. 13-45). Cambridge: Cambridge University Press; Levinson and Brown 1994; Pederson 1995) or against it (Li, P., and Gleitman, L. (2002). Turning the tables: Language and spatial reasoning. Cognition, 83, 265-294). Whether language has an impact on thought depends, of course, on how we define language and how we define thought. But, it also depends on our definition of ‘impact’. Language can act as a lens through which we see the world. It can provide us with tools that enlarge our capabilities. It can help us appreciate simple and complex relations and groupings in the world that we might not have otherwise grasped.

### Cognition

Cognition is a term that refers to the mental faculty of knowledge. Specifically, it refers to mental processes involved in the acquisition of knowledge and comprehension. These processes include thinking, reasoning, knowing, learning, remembering, judging, inferring (inductively or deductively), decision-making and problem-solving. These are higher-level functions of the brain and they encompass language, imagination, perception, and planning. Still, these mental functions or cognitive abilities are based on specific neuronal networks or brain structures. It can be said that cognition is an abstract property of advanced living organisms. Therefore, it is studied as a direct property of the brain or of an abstract mind on sub-symbolic and symbolic levels. Still, cognition is an (embodied) experience of knowledge that can be distinguished from an (embodied) experience of feeling or will. Cognition is one of the only words/terms that is associated to the brain as well as to the mind. Recently, advanced cognitive research has extended its domain to especially focus on the capacities of abstraction, generalization, concretization/specialization, and meta-reasoning, which descriptions involve concepts such as beliefs, knowledge, desires, preferences, and intentions of intelligent individuals/objects/agents/systems. In a wider sense, cognition also means the act of knowing or knowledge, and may be interpreted in a social or cultural sense to describe the emergent development of knowledge and concepts within a group that culminates in both thought and action.

### Remarkable Abilities of Human Cognition and Language

Humans specialize in thinking and knowing—in cognition—and our extraordinary cognitive powers have enabled us to do remarkable things that have transformed every aspect of our lives. We are complex social, political, economic, scientific and artistic creatures living and adapted to a vast range of habitats, many of our own creation. Humans' cognitive accomplishments can be attributed to their use of language and to their culture. Humans derive great cognitive power from the use of language. How has evolution produced creatures with minds capable of these remarkable feats? What is the nature of this ability? Gentner has proposed the following relevant list of cognitive skills that characterizes us (In D. Gentner and S. Goldin-Meadow (eds.), Language in Mind. Cambridge, Mass.: MIT Press. Pages 195-196 The MIT Press: 2003):
The ability to maintain hierarchies of abstraction, so that we can store information about Fido, about dachshunds, about dogs, or about living things
The ability to concatenate assertions and arrive at a new conclusion
The ability to reason outside of the current context—to think about different locations and different times and even to reason hypothetically about different possible worlds
The ability to compare and contrast two representations to discover where they are consistent and where they differ
The ability to reason analogically—to notice common relations across different situations and project further inferences
The ability to learn and use external symbols to represent numerical, spatial, or conceptual information.

Language abilities include:
The ability to learn a generative, recursive grammar, as well as a set of semantic conceptual abilities
The ability to learn symbols that lack any iconic relation to their referents
The ability to learn and use symbols whose meanings are defined in terms of other learned symbols, including even recursive symbols such as the set of all sets
The ability to invent and learn terms for abstractions as well as for concrete entities
The ability to invent and learn terms for relations as well as (concrete) things.

### The Next Frontier: Higher-Order Cognition

### Early Induction and Categorization is Similarity-Based

Early in development, humans exhibit the ability to form categories and overlook differences for the sake of generality. Thus, the ability to generalize from the known to the unknown is crucial for learning new information. In recent years, new findings pose a challenge to the classical and naïve-theory of conceptual knowledge that holds that early in development induction is category based. Nevertheless, new findings suggest that it is unnecessary to posit conceptual assumptions to account for inductive generalizations in young children, thus supporting the recently proposed similarity, induction, and categorization (SINC) model. Briefly, the SINC model argues that for young children, both induction and categorization are similarity-based processes (the SINC model also argues for induction with both familiar and novel categories to be a similarity-based process) (Sloutsky. V. M., & Fisher, A. V. (2004a). Induction and categorization in young children: A similarity-based model. Journal of Experimental Psychology: General, 133, 166-188).

Sloutsky suggested that mature categorization is accomplished through inductive generalization that is grounded in perceptual and attentional mechanism capable of detecting multiple correspondences or similarities (Sloutsky. V. M (2003). The role of similarity in the development of categorization. Trends in Cognitive Sciences, 7, 246-251; (Murphy, G. L. (2002) The Big Book of Concepts, MIT Press; McClelland, J. L. and Rogers, T. T. (2003) The parallel distributed processing approach to semantic recognition. Nat. Rev. Neurosci. 4:310-322; Goldstone, R. L. (1994) The role of similarity in categorization: providing a groundwork. Cognition 52, 125-157; Hahn, U. and Ramscar, M. (2001) Similarity and Categorization, Oxford University Press; Sloman, S. A. and Rips, L. J. (1998) Similarity and Symbols in Human Thinking, MIT Press). Sloutsky's new approach became known as the ‘similarity-based approach’ (Sloutsky. V. M (2003). The role of similarity in the development of categorization. Trends in Cognitive Sciences, 7, 246-251) 2003). The central tenant of the similarity-based approach is that there are multiple correlations (correspondences among relations) in the environment and that humans have perceptual and attentional mechanisms capable of extracting these regularities and establishing correspondences among correlated structures (McClelland, J. L. and Rogers, T. T. (2003) The parallel distributed processing approach to semantic recognition. Nat. Rev. Neurosci. 4:310-322).

In particular, there is evidence that reliance on linguistic labels is not central and therefore fixed, and that it can vary as a function of perceptual information. For example, children's reliance on linguistic labels in categorization and induction tasks differs for real 3-dimensional (3-D) objects and for line-drawing pictures (2-D). The effects of labels are more pronounced for line-drawing pictures (2-D) than for real 3-D objects (Deak, G. O. and Bauer, P. J. (1996) The dynamics of preschoolers' categorization choices. Child Dev. 67, 740-767). Still, if two entities share a label, young children are more likely to say that these entities look alike (Sloutsky, V. M. and Lo, Y-F (1999) How much does a shared name make things similar? Part 1: Linguistic labels and the development of similarity judgment. Dev. Psychol. 35, 1478-1492). Furthermore, this overall similarity—rather than the centrality of linguistic labels alone, drives inductive generalization (Sloutsky, V. M. et al. (2001) How much does a shared name make things similar? Linguistic labels and the development of inductive inference. Child Dev. 72, 1695-1709).

It seems that an attention-based mechanism of similarity computation can account for inductive generalization in young children. Still, Sloutsky's approach further assumes that children do not have to know the importance of features' correspondences a priori, rather this knowledge can be the outcome of powerful learning mechanisms that are grounded in the ability to attend to and detect statistical regularities in the environment (McClelland, J. L. and Rogers, T. T. (2003) The parallel distributed processing approach to semantic recognition. Nat. Rev. Neurosci. 4:310-322). Hence, the importance of distinctive features correspondences does not have to be known in advance by children—it can be ‘created’ on the fly by presenting and contrasting examples. Because many ‘basic categories’ have correlated structures, the ability to detect specific and more abstract regularities might be an important learning mechanism supporting the development of categories. Still, in a later study, Fisher & Sloutsky proposed that category and similarity-based induction should result in different memory traces and thus in different memory accuracy.

Fisher & Sloutsky summarized their study results (consisting in four experiments) to indicate that (a) young children spontaneously perform similarity-based induction, (b) there is a gradual transition from similarity-based to category-based induction, and, c) category-based induction is likely to be a product of learning (Fisher, A. V. & Sloutsky, V. M. (2005b). When induction meets memory: Evidence for gradual transition from similarity-based to category-based induction. Child Development, 76, 583-597).

### The Role of Function in Categories

Most generally, an object's function, the use that people have assigned to it, is a central aspect of the object's conceptualization. Typically, the function of an object is treated as a simple unanalyzed amodal unitary property that can be abstractly predicated as existing independently of its other properties, such as physical structure and context of use. Most commonly, when functional properties are viewed modally, they are often assigned to a single modality, namely, the motor system.

Barsalou et al., and Chaigneau et al., have proposed function to be a more elaborate construct, firstly, a complex relational structure, not a single abstract unanalyzed property, and secondly, that it is distributed across many modalities, not just one (Barsalou, L. W., Sloman, S. A, & Chaigneau, S. E. (2005). The HIPE theory of function. In Carlson, L. & van der Zee, E. (Eds.) Representing functional features for language and space: Insights from perception, categorization and development (pp. 131-47). Oxford: Oxford University Press; Chaigneau, S. E., Barsalou, L. W. (2008). The role of function in categories. Theoria et Historia Scientiarum, 8, 33-51). Third, they proposed that there is not just one sense of an entity's function but many. When subjects are aware of the relational systems that underlie function, they use it to categorize, to name, to guide inferences, and to fill gaps in knowledge. For instance, assigning an entity to a category is one way to sustain inductive inference (Markman, E. M. (1989) Categorization and naming in children. Cambridge, Mass.: The MIT Press; Yamauchi, T. & Markman, A. B. (2000). Inference using categories. Journal of Experimental Psychology: Learning, Memory, & Cognition, 26(3), 776-795). For example, when two objects belong to the same category, people expect these two objects to share important properties. Thus, if a novel entity is classified as a bird, people infer that it can fly (even though they may not know this for a fact).

Still, in line with the above mentioned proposal that posits function as an elaborate complex relational system, some researchers have argued that understanding the intention of an object's designer (design history) is crucial for understanding the object's function and that people use these meta-beliefs in categorization (Bloom, P. (1996). Intension, history, and artifact concepts. Cognition, 60, 1-29 and, (1998). Theories of artifact categorization. Cognition, 66, 87-93; Gelman, S. A., & Bloom, P. (2000). Young children are sensitive to how an object was created when deciding what to name it. Cognition, 76, 91-103; Matan, A., & Carey, S. (2001). Developmental changes within the core of artifact concepts. Cognition, 78, 1-26).

Bloom assumes that the designer's intention constitutes an artifact's essence, where the term “essence” herein refers to a theory of naming which holds that names are not grounded in mental representations (Bloom, P. (1996). Intension, history, and artifact concepts. Cognition, 60, 1-29 and, (1998). Theories of artifact categorization. Cognition, 66, 87-93). Instead, names are grounded in causal relations to their referents. When structure and function are treated as independent properties, or when causal relations are ambiguous, function's role is minimized. Function only shows its effect on reasoning and language naming ability when meaningful (causal chain) structure-function relations take place and when subjects understand them. Therefore, the better children and adults understand the underlying system of (complex) relations, the more function guides the naming of objects, inductive reasoning about objects' properties, and their categorization. In short, the elaborated view of Barslalou et al. contemplates the role of function as being a core conceptual property that represents categories, where function emerges from a complex relational system that links together physical structure, background settings, action/use, and design history.

### Abstract Relational Thought

Gentner and collaborators have proposed a new insight based on cognitive theories of learning which still claims the richness of the constructivist's theoretical frames. Their new proposal aims to capture the development of abstract relational thought—the sine qua non of human cognition. They propose that children's learning competence stems from carrying out comparisons that yield abstractions. These early comparisons are typically based on close concrete similarities. Later, comparisons among less obviously similar exemplars promote further inferences and abstractions. Their proposal sheds new light on the learning process of new knowledge by comparison mechanisms. Specifically, they suggest that comparison is not a low-level feature generalization mechanism, but a process of structural alignment and mapping (e.g., learning by comparing two situations and abstracting their commonalities) that is powerful enough to acquire structured knowledge and rules (Gentner, D., & Medina, J. (1998). Similarity and the development of rules. Cognition, 65, 263-297; Gentner, D., & Wolff, P. (2000). Metaphor and knowledge change. In E. Dietrich & A. Markman (Eds.), Cognitive dynamics: Conceptual change in humans and machines (pp. 295-342). Mahwah, N.J.: Lawrence Erlbaum Associates).

### Comparison Can Promote Learning

According to this account, there are at least four ways by which the process of comparison can further the acquisition of knowledge:
a. Highlighting and schema abstraction-extracting common systems from representations, thereby promoting the dis-embedding of subtle and possibly important commonalities (including common relational systems);
b. Projection of candidate inferences inviting inferences from one item to the other;
c. Re-representation-alteration of one or both representations to improve the match (and thereby, as an important side effect, promoting representational uniformity); and
d. Restructuring-altering the domain structure of one domain in terms of the other (Gentner, D., & Wolff, P. (2000). Metaphor and knowledge change. In E. Dietrich & A. Markman (Eds.), Cognitive dynamics: Conceptual change in humans and machines (pp. 295-342). Mahwah, N.J.: Lawrence Erlbaum Associates; Gentner, D., Brem, S., Ferguson, R., Markman, A., Levidow, B. B., Wolff, P., & Forbus, K. D. (1997). Analogical reasoning and conceptual change: A case study of Johannes Kepler. The Journal of Learning Sciences, 6(1), 3-40).

These processes enable the child to learn abstract commonalities and to make relational inferences.

### The Strength of Comparison in Promoting Inductive Inference

Children also learn by mapping from well-understood systems to less understood systems, as shown, for example, in studies on children's understanding of biological properties. When young children are asked to make predictions about the behavior of animals and plants, they often invoke analogies with people (Carey, S. (1985b). Are children fundamentally different kinds of thinkers and learners than adults? In S. F. Chipman, J. W. Segal, & R. Glaser (Eds.), Thinking and learning skills: Current research and open questions (Vol. 2, pp. 485-517). Hillsdale, N.J.: Lawrence Erlbaum Associates; Inagaki, K. (1989). Developmental shift in biological inference processes: From similarity-based to category-based attribution. Human Development, 32, 79-87 and Inagaki, K. (1990). The effects of raising on children's biological knowledge. British Journal of Developmental Psychology, 8, 119-129; Inagaki, K., & Hatano, G. (1987). Young children's spontaneous personification as analogy. Child Development, 58, 1013-1020 and, Inagaki, K., & Hatano, G. (1991). Constrained person analogy in young children's biological inference. Cognitive Development, 6, 219-231; Inagaki, K., & Sugiyama, K. (1988) Attributing human characteristics: Development changes in over- and underattribution. Cognitive Development, 3, 55-70; also see for findings with adults—Rips, L. J. (1975). Inductive judgments about natural categories. Journal of Verbal Learning and Verbal Behavior, 14, 665-681).

For example, when asked if they could keep a baby rabbit small and cute forever, 5 to 6 year-olds often made explicit analogies to humans. For example, “We can't keep it [the rabbit] forever in the same size. Because, like me, if I were a rabbit, I would be 5 years old and become bigger and bigger”. Inagaki and Hatano noted that this use of the human analogy was not mere “childhood animism”, but rather a selective way of mapping from the known to the unknown (Inagaki, K., & Hatano, G. (1987). Young children's spontaneous personification as analogy. Child Development, 58, 1013-1020). That children reason from the species they know best as humans to other animals follows from the general phenomenology of analogy. A familiar base domain, whose causal structure is well understood, is used to make predictions about a less-well understood target (Bowdle, B., & Gentner, D. (1997). Informativity and asymmetry in comparisons. Cognitive Psychology, 34(3), 244-286; Gentner, D. (1983). Structure-mapping: A theoretical framework for analogy. Cognitive science, 7, 155-170; Holyoak, K. J., & Thagard, P. (1995). Mental leaps: Analogy in creative thought. Cambridge, Mass.: MIT Press). For example, knowledge about the solar system was used to make predictions about the atom in Rutherford's (1906) analogy (Gentner, D. (1983). Structure-mapping: A theoretical framework for analogy. Cognitive science, 7, 155-170). Inagaki and Hatano's findings suggest that these analogies are not a sign of faulty logic, but rather are a means “to generate an educated guess about less familiar, nonhuman objects”, and they stem from a highly sensible reasoning strategy, the same strategy used by adults in cases of incomplete knowledge (Inagaki, K., & Hatano, G. (1987). Young children's spontaneous personification as analogy. Child Development, 58, 1013-1020, [see page. 1020] and, Inagaki, K., & Hatano, G. (1991). Constrained person analogy in young children's biological inference. Cognitive Development, 6, 219-231).

Inagaki argued that analogical reasoning is not restricted to special cases of inference concerning unfamiliar properties and situations, but rather it is an integral part of the process of knowledge acquisition. As the findings of Inagaki and Hatano suggest, the process of analogical comparison and abstraction may itself drive the acquisition of abstract knowledge (Gentner, D., & Medina, J. (1997). Comparison and the development of cognition and language. Cognitive Studies: Bulletin of the Japanese Cognitive Science Society. 4(1), 112-149 and, Gentner, D., & Medina, J. (1998). Similarity and the development of rules. Cognition, 65, 263-297). Analogy plays a formative role in acquisition of knowledge when a well-structured domain provides the scaffolding for the acquisition of a new domain.

### The Career of Similarity Thesis

Gentner and collaborators have argued that analogy and comparison in general, are pivotal in children's learning. How does analogy develop? The early stages in analogy development appear to be governed by “global” or “holistic” similarities where infants can reliably make overall matches before they can reliably make partial matches (Smith, L. B. (1989). From global similarities to kinds of similarities: The construction of dimensions in development. In S. Vosniadou & A. Ortony (Eds.) Similarity and analogical reasoning (pp. 146-178). New York: Cambridge University Press and, Smith, L. B. (1993). The concept of same. In H. W. Reese (Ed.), Advances in child development and behavior (Vol. 24, pp. 215-252). San Diego, Calif.: Academic Press; Foard, C. F., & Kemler-Nelson, D. G. (1984). Holistic and analytic modes of processing: The multiple determinants of perceptual analysis. Journal of Experimental Psychology, 113(1), 94-111). The earliest reliable partial matches are based on direct resemblances between objects, such as the similarity between a round red ball and a round red apple. With increasing knowledge, children come to make pure attribute matches (e.g., a red ball and a red barn) and relational similarity matches (e.g., a ball rolling on a table and a toy car rolling on the floor.) As an example of this developmental progression, when asked to interpret the metaphor A tape recorder is like a camera, 6-year-olds produced object-based interpretations (e.g., Both are black), whereas 9-year-olds and adults produced chiefly relational interpretations (e.g., Both can record something for later) (Gentner, D. (1988). Metaphor as structure-mapping: The relational shift. Child Development, 59, 47-59).

Similarly, Billow reported that metaphors based on object similarity could be correctly interpreted by children of about 5 or 6 years of age, but that relational metaphors were not correctly interpreted until around 10 to 13 years of age (Billow, R. M. (1975). A cognitive developmental study of metaphor comprehension. Developmental Psychology, 11, 415-423). Still, young children's success in analogical transfer tasks increases when the domains are familiar to them and they are given training in the relevant relations. With increasing expertise, learners shift from reliance on surface similarities to greater use of structural commonalities in problem solving and analogy transfer (Chi, M. T. H., Feltovich, P. J., & Glaser, R. (1981). Categorization and representation of physics problems by experts and novices. Cognitive science, 5, 121-152). Novick showed that more advanced mathematics students were more likely to be reminded of structurally similar problems than were novices (Novick, L. R. (1988). Analogical transfer, problem similarity, and expertise. Journal of Experimental Psychology: Learning, Memory, and Cognition, 14, 510-520).

Further, when the experts were initially reminded of a surface-similar problem, they were able to reject it quickly. In brief, novices appear to encode domains largely in terms of surface properties, whereas experts possess relationally rich knowledge representations. Researchers speculated that experts tend to develop uniform relational representations (Forbus, K. D., Gentner, D., & Law, K. (1995). MAC/FAC: A model of similarity-based retrieval. Cognitive Science, 19, 141-205; Gentner, D., & Rattermann, M. J. (1991). Language and the career of similarity. In S. A. Gelman & J. P. Byrnes (Eds.), Perspective on language and thought: Interrelations in development (pp. 225-277). London: Cambridge University Press). In this regard, expertise leads to a greater probability that two situations embodying the same principle will be encoded in like terms and therefore will participate in mutual reminding. In summary, it is suggested that one way by which children and other novices improve their ability to detect powerful analogical matches is through comparison itself.

### Making Analogical Comparisons

One simple way to engage in comparison is via physical juxtaposition of similar items. Kotovsky and Gentner showed that experience with concrete similarity comparisons can improve children's ability to detect more abstract similarity (Kotovsky, L., & Gentner, D. (1996). Comparison and categorization in the development of relational similarity. Child Development, 67, 2797-2822). The results from this study were somehow puzzling since it was expected that matching via comparing highly similar examples (e.g., oOo with xXx or xxX), would lead to the formulation of a narrow understanding. Instead, comparisons have led to noticing relational commonalities that could be used in a more abstract mapping (within-dimension matching of pairs acts to make the higher order relation of symmetry or monotonicity more salient). In other words, making concrete comparisons improved children's ability to reveal relational similarities.

Still, Gentner & Clement showed that relational information tends to be implicit and difficult to call forth within individual items (Gentner, D., & Clement, C. (1998). Evidence for relational selectivity in the interpretation of analogy and metaphor. In G. H. Bower (Ed.), The psychology of learning and motivation, advances in research and theory (Vol. 22, pp. 307-358). New York: Academic Press). In brief, it seems that engaging in comparison processing tends to be a naturalistic way by which children and adults (e.g., when dealing with familiar topics) come to reveal and thus appreciate relational commonalities. In another study, Gentner and Medina demonstrated a second way to encourage comparison—giving two things the same name (label)—what they referred to as symbolic juxtaposition (Gentner, D., & Medina, J. (1998). Similarity and the development of rules. Cognition, 65, 263-297).

Gentner and Medina suggested that comparison can be promoted via symbolic juxtaposition through common language. Initial hints to symbolic juxtaposition effects were obtained in a previous study by Kotovsky and Gentner, where 4-year-olds were given name labels for higher order relations among the picture objects (e.g., “even” for symmetry) (Kotovsky, L., & Gentner, D. (1996). Comparison and categorization in the development of relational similarity. Child Development, 67, 2797-2822). Children in the study received a categorization task (with feedback) where they had to give only cards that showed the name label “even”. After the training in the categorization task, children who succeeded in the name labeling task scored well above chance in the cross-dimensional trials (72% relational responding), as opposed to chance performance (about 50%) that children showed with no such name label training. As with the physical juxtaposition studies, the use and training with relational name labels increased children's attention to discover common relational structure. They concluded that the acquisition of relational language influences the development of relational thought.

### Relational Reasoning in Human Evolution

Reasoning depends on the skill to form and manipulate mental representations of relations between objects, events and symbols. Thus, the integration of multiple relations between mental representations is critical for higher order cognition. Transitive inferences, drawing analogies (a type of induction), and a problem of the type “person is to house as bear is to what?” are such examples. The correct problem solving and planning depend on successfully reasoning the integration of at least two sources of relational information namely, the share roles, dweller and dwelling, constraining the inferred answer, “cave” for the above-referenced question. In fact, reasoning to understand and integrate more than one relation requires more than perceptual (given a visual scene) or linguistic (given a sentence) processing alone (e.g., transitive inference). In evolutionary terms, humans display far greater sophistication in relational reasoning across a wide range of content domains (Halford, G. S. (1984). Can young children integrate premises in transitivity and serial order tasks? Cognitive Psychology, 16, 65-93).

### Relational Knowledge: The Foundation of Higher-Order Cognition

Relational knowledge provides an integrative multidisciplinary framework for a broad number of fields, including inference, categorization, quantification, planning, language, working memory, and knowledge acquisition. Relational representations have a number of core properties that are vital to relational knowledge and which are different from other forms of cognition such as association, or automatic and modular processes. For example, structure-consistent mappings, a crucial property of relations and key to analogies, determine structural correspondence that is defined as a consistent mapping of elements and relations, have been postulated to be the process that best distinguishes humans' cognition from that of other animals (Holland, J. H. et al. (1989) Induction: Processes of inference, learning and discovery, MIT Press) and (Penn, D. C. et al. (2008) Darwin's mistake: Explaining the discontinuity between human and nonhuman minds. Behav. Brain Sci. 31, 109-130). Structure-consistent mappings enable analytic cognition that is relatively independent from similarity of content and that promotes selection of relations that are common to several relational instances (e.g., ‘Tom is TALLER than Peter’ and ‘Bob is TALLER than Tom’), which is a major step towards abstraction and representations of variables. This core property may offer new insight to explain a number of phenomena: 1) the nature and limitations of working memory, 2) the high correlation with fluid intelligence, 3) why higher order cognitive processes are by nature serial processes, 4) semantic tasks that evolve earlier and are implicitly acquired (mastered) at an earlier age, and 5) the flexibility and versatility of higher order cognition.

### Humans Prefrontal Cortex as the Locus Site of Relational Reasoning

It has been hypothesized that given the large increases in the size of prefrontal cortex in humans, the prefrontal cortex may be the locus of a system for relational reasoning in humans (Benson, D. F. (1993). Prefrontal abilities. Behavioral Neurology, 6, 75-81) and (Holyoak K. J., & Kroger, J. K. (1995) Forms of reasoning: Insight into prefrontal functions? In J. Grafman, K. J. Holyoak, & F. Boller (Eds), Structure and functions of the human prefrontal cortex (pp. 253-263). New York: New York Academy of Sciences; Robin, N., & Holyoak, K. J. (1995). Relational complexity and the functions of prefrontal cortex. In M. S. Gazzaniga (Ed.), The cognitive neurosciences (pp. 987-997). Cambridge, Mass.: MIT Press). The existing literature implicates the prefrontal cortex in the performance of a large number of higher order cognitive tasks, such as memory monitoring, management of dual tasks, rule application, and planning sequences of moves in problem solving (D'Esposito, M., Detre, J. A., Alsop, D. C., Shin, R. K., Atlas, S., & Grossman, M. (1996), The neural basis of the central executive system of working memory. Nature, 378, 279-281); Duncan, J., Burgess, P., & Emslie, H. (1995). Fluid intelligence after frontal lobe lesions. Neuropsychologia, 33, 261-268; Smith, E. E., Patalano, A., & Jonides, J. (1998). Alternative strategies of categorization. Cognition, 65, 167-196). This hypothesis is consistent with evidence that prefrontal cortex dysfunction leads to selective decrements in performance on tasks involving hypothesis testing, categorization, planning, and problem solving, all of which involve relational reasoning (Delis, D. C., Squire, L. R., Bihrle, A., & Massman, P. J. (1992). Componential analysis of problem-solving ability: Performance of patients with frontal lobe damage and amnesic patients on a new sorting test. Neuropsychologia, 30, 683-697; Shallice, T., & Burgess, P. (1991), Higher-order cognitive impairments and frontal lobe lesions in man. In H. S. Levin, H. M. Eisenberg, & A. L. Benton (Eds.), Frontal lobe function and dysfunction (pp. 125-138). New York: Oxford University Press). Still, it is further speculated that relational reasoning appears critical for all tasks identified with executive processing and fluid intelligence. Neuropsychological and functional imagining studies indicate that different regions in prefrontal cortex subserve distinct functions. Particularly, the dorsolateral prefrontal cortex (DLPFC) has been implicated in working memory and executive functions (Baddeley, A. D. (1992). Working memory. Science, 255, 556-559). Relational reasoning requires a capacity to bind elements dynamically into roles and to maintain these bindings as inferences are made.

### The Role of Working Memory in Constructing Relational Representations

Working memory is recognized as the workspace where relational representations are constructed (Halford, G. S., Wilson, W. H., & Phillips, S. (1998). Processing capacity defined by relational complexity: Implications for comparative, developmental, and cognitive psychology. Brain and Behavioral Sciences, 21, 803; Halford, G. S. and Busby, J. (2007) Acquisition of structured knowledge without instruction: The relational schema induction paradigm. J. Exp. Psychol. Learn. Mem. Cogn. 33, 586-603); Doumas, L. A. (2008) A theory of the discovery and predication of relational concepts. Psychol. Rev. 115, 1-43), and Oberauer, K. (2009) Design for a working memory. In The psychology of learning and motivation: Advances in research and theory (Ross, B. H., ed.), pp. 45-100, Elsevier Academic Press). It plays a role in the determination of structural correspondence that defines a consistent mapping of elements and relations. More so, these operations underlying relational integration may distinguish the mechanisms involved in working memory from a passive buffer role assigned to short-term memory. Still, the operations that support relational reasoning may form the core of an executive component of working memory, which implies both the active maintenance (also manipulation) of information and its processing (Halford, G. S., Wilson, W. H., & Phillips, S. (1998). Processing capacity defined by relational complexity: Implications for comparative, developmental, and cognitive psychology. Brain and Behavioral Sciences, 21, 803-864).

Working memory stands for approximately 50% of variance in fluid intelligence and its shares substantial variance in reasoning that is not accounted for computational demands (e.g., processing, storage, or by processing speed) (Kane, M. J. et al. (2004) The Generality of Working Memory Capacity: A Latent-Variable Approach to Verbal and Visuospatial Memory Span and Reasoning. J. Exp. Psychol. Gen. 133, 189-217), Kane, M. J. et al. (2005) Working Memory Capacity and Fluid Intelligence Are Strongly Related Constructs: Comment on Ackerman, Beier, and Boyle (2005). Psychol. Bull. 131, 66-71) and (Oberauer, K. et al. (2008) Which working memory functions predict intelligence? Intelligence 36, 641-652). This indicates that the shared variance at least somewhat reflects the ability to form structure representations. In other words, relational integration may be the “work” done by working memory that is the workspace where relational representations are constructed and it is influenced by knowledge stored in semantic memory. Therefore, it plays an important role in the interaction of analytic and nonanalytic processes in higher cognition.

### Relational Language and Relational Though

A view that contemplates language as influencing cognition is still considered to be a contentious claim. A recent progression of studies has uncovered a new understanding in support of how language might influence conceptual life. Particularly, the hypothesis is that learning specific relational terms and systems is important in the development of abstract thought (Gentner, D., & Rattermann, M. J. (1991). Language and the career of similarity. In S. A. Gelman & J. P. Byrnes (Eds.), Perspective on language and thought: Interrelations in development (pp. 225-277). London: Cambridge University Press; Gentner, D., Rattermann, M. J., Markman, A. B., & Kotovsky, L. (1995). Two forces in the development of relational similarity. In T. J. Simon & G. S. Halford (Eds.), Developing cognitive competence: New approaches to process modeling (pp. 263-313). Hillsdale, N.J.: Lawrence Erlbaum Associates; Kotovsky, L., & Gentner, D. (1996). Comparison and categorization in the development of relational similarity. Child Development, 67, 2797-2822). This hypothesis further suggests that relational language provides tools for extracting and formulating abstractions. In particular, it focuses on the role of relational name labels in promoting the ability to perceive relations, to transfer relational patterns, and to reason about relations. Even within a single language, the acquisition of relational terms provides both an invitation and a means for the learner to modify his/her thought. When applied across a set of cases, relational name labels prompt children to make comparisons and to store the relational meanings that result (Gentner, D. (1982). Why nouns are learned before verbs: Relativity vs. natural partitioning. In S. A. Kuczaj (Ed.), Language development: Syntax and semantics (pp. 301-304). Hillsdale, N.J.: Lawrence Erlbaum Associates; Gentner, D., & Medina, J. (1997). Comparison and the development of cognition and language. Cognitive Studies: Bulletin of the Japanese Cognitive Science Society. 4(1), 112-149 and, Gentner, D., & Medina, J. (1998). Similarity and the development of rules. Cognition, 65, 263-297).

Relational name labels invite the child to notice, represent, and, retain structural patterns of elements. Learning by analogy and similarity, even mundane within-dimension similarity, can act as a positive driving force playing a fundamental role in learning and in the development of structured representations. Children originally acquire knowledge at a highly specific conservative level. Later in development children engage in exemplars' matching to foster comparisons, which are initially concrete but progressively more abstract and complex. In the phase of exemplars, language learning by analogy and similarity promotes thought abstraction and rule learning.

### Why Relational Language Matters

Relational terms invite and preserve relational patterns that might otherwise be short-lived. Relational language includes verbs, prepositions, and a large number of relational nouns (e.g., weapon, barrier) members of classes that are exclusively dedicated to conveying relational knowledge and that contrast with object reference terms on a number of grammatical and informational dimensions (Gentner, D. (1981). Some interesting differences between nouns and verbs. Cognition and Brain Theory, 4. 161-178). Although pivotal in acquiring abstract concept development, relational concepts are not obvious, and therefore not automatically learned. Relational concepts are not simply given in the natural world. They are culturally and linguistically shaped (Bowerman, M. (1996). Learning how to structure space for language: A cross-linguistic perspective. In P. Bloom, M. A. Peterson, L. Nadel, and M. F. Garrett (Eds.), Language and space (pp. 385-436). Cambridge, Mass.: MIT Press; Talmy, L. (1975). Semantics and syntax of motion. In J. Kimball (Ed.), Syntax and semantics (Vol. 4, pp. 181-238). New York: Academic Press).

Although relational language is hard to learn, the benefits outweigh the difficulty. To that effect, Gentner and Loewenstein have put forward several specific ways in which relational language can foster the learning and retention of relational language patterns (Gentner, D., and Loewenstein, J. (2002). Relational language and relational thought. In J. Byrnes and E. Amsel (Eds.), Language, literacy, and cognitive development (pp. 87-120). Mahwah, N.J.: Erlbaum).
1. Abstraction. Naming a relational pattern helps to abstract it, to relocate it from its initial context. Abstraction helps to preserve it as a pattern (holistic structure entailing a set of relations), increasing the likelihood that the learner will perceive (automatically and/or with less attentional demanding) the (same or most related) relational pattern again across different circumstances.
2. Initial registration. Hearing (also visually via reading) a relational term used invites (particularly children) the storage of the situation and its name label in order to seek a relational meaning even when none is initially obvious.
3. Selectivity. Once learned, relational terms afford not only abstraction, but also selectivity. For example, when we select to label a cat a pet and not a carnivore, or a good mouser, or a lap warmer, we concentrate on a different set of aspect and relations. Selective linguistic labeling can influence the understanding of a situation.
4. Reification. Using a relational term helps to reify an entire pattern, so that new (novel) assertions can be stated about it. A named relations schema can serve as an argument to a higher order proposition (e.g., terms like: betrayal, loss, revenge, etc.)
5. Uniform relational encoding. Habitual use of a given set of relational terms promotes uniform relational encoding, thereby increasing the probability of transfer between like relational situations. The growth of technical vocabulary in experts reflects the utility of possessing a uniform relational vocabulary.

### Benefits of Language on Thought

Along with the Sapir-Whorf hypothesis and Vygotsky's theory of language and thought, Gentner and Loewenstein have claimed that learning specific relational terms and relational systems in a language fosters the human ability to notice and reason about related abstractions. Specifically, they claim that the set of currently lexicalized existing relations (e.g., verbs, propositions, and relational nouns) frames the set of new ideas that can be readily noticed and articulated. Their proposal goes beyond Slobin's “thinking for speaking” view, which states that language may determine the construal of reality during language use without necessarily pervading our entire world view, by arguing for lasting benefits of language on thought (Slobin, D. I. (1996). From “thought and language” to “thinking for speaking.” In J. J. Gumperz & S. C. Levinson (Eds.), Rethinking linguistic relativity (pp. 70-96). Cambridge, England: Cambridge University Press).

Since language influences categorization and memory (encoding and retrieval of lexical labels) and is instrumental in providing us with most of our concepts, its centrality in cognition and cognitive development is beyond dispute. Symbolic comparison operates in tandem with experiential comparison to foster the development of higher order cognition, namely abstract thought. The spirit of the present understanding can best be captured in a memorable comment from Piaget: “ . . . after speech has been acquired, the socialization of thought is revealed by the elaboration of concepts, of relations, and by the formation of rules, that is, there is a structural evolution” (Piaget, J. (1954). The construction of reality in the child. New York: Basic Books—see page. 360).

### Higher-Order Cognition in Alzheimer's Disease (AD)

### Linking Categorization Processes to Semantic Memory

Recognition of an object entails placing it in a category. Accordingly, categorization processes are paramount to semantic memory, the long-term knowledge grasping of things and events. Besides the number and well established investigations of semantic memory in the context of stored semantic knowledge, sematic memory processing as well as its content plays a role. For instance, limited ability to assign a particular categorization process to intact knowledge could also impair semantic memory (Grossman, M., Smith, E. E., Koenig, P., Glosser, G., Rhee, J., & Dennis, K. (2003). Categorization of object descriptions in Alzheimer's disease and frontotemporal dementia: Limitation in rule-base processing. Cognitive, Affective, and Behavioral Neuroscience, 3, 120-132; Koenig, P., Smith, E. E., & Grossman, G. (2006). Semantic categorization of novel objects in frontotemporal dementia. Cognitive Neuropsychology, 23, 541-562).

A study by Koenig et al., was designed to assess the link of categorization processes with semantic memory by assessing similarity and rule-based learning of a semantically meaningful novel category (biologically plausible novel animals) in patients with mild to moderate AD and correlating performance with semantic classification of familiar objects (Koenig, P., Smith, E. E., Grossman, M., Glosser G., Moore, P. (2007). Categorization of novel animals by patients with Alzheimer's disease and corticobasal degeneration. Neuropsychology, 21, 193-206). The study showed that AD patients had significant rule-based categorization impairment. The AD group required more training trials and had longer response times relative to their own performance in the similarity-based categorization condition as well as to the rule-based categorization performance of healthy participants. Their rule-based categorization performance at test was significantly impaired, showing a graded performance pattern rather than the sharp distinction between members and non-members seen in matched healthy participants. However, the similarity-based categorization performance of AD patients was comparable to the healthy matched subjects.

The correlation between the rule-based categorization impairment of AD patients and their performance on tests of executive function supports the view that a limitation of executive resources such as working memory, inhibitory control, and selective attention, contributes to the deficit with rule-based categorization processing and semantic memory impairment. Most importantly, episodic memory impairment, the hallmark symptom of AD, showed no correlation with performance in either categorization condition, suggesting that semantic memory impairment in mild to moderate AD is relatively independent of episodic memory deficits. The results of the study propose a link between categorization processes and semantic memory impairment in mild to moderate AD. Mainly, intact similarity-based categorization processing will support much of semantic memory performance while deficits in rule-based categorization processes will particularly impair categorization of items, which classification requires specific (e.g., novel) features assessments. Koening et al. concluded that qualitatively distinct categorization processes, supported by distinct cortical networks, contribute to semantic memory (Koenig, P., Smith, E. E., Grossman, M., Glosser G., Moore, P. (2007). Categorization of novel animals by patients with Alzheimer's disease and corticobasal degeneration. Neuropsychology, 21, 193-206).

### Relational Integration and Executive Function in AD

The neurophathological heterogeneity of patients with AD raises the possibility that executive deficits may be present in only a subset of patients with mild or moderate AD (Waltz, J. A., Knowlton, B J., Holyoak, K. J., Boone, K. B., Mishkin, F. S., de Menezes Santos, M., (1999). A system for relational reasoning in human prefrontal cortex. Psychological Science, 10, 119-125; Waltz, J. A., Knowlton, B J., Holyoak, K. J., Boone, K. B., Madruga, C. B., McPherson, S., (2004). Relational integration and executive function in Alzheimer's disease. Neurophysiology, 18, 296-305). In general, executive functions depend on the ability to reason (deductively and inductively) to represent abstract problems characterizing simple or complex relations between objects, events, and symbols (e.g., language and numbers). The prefrontal cortex provides the neural substrate for this capacity. Based on analyses of the working memory impairment in AD, several researchers proposed the manifestation of multiple, distinct patterns of cognitive impairment within AD. One centered on compromised declarative memory systems, and one related to deficits in working memory (WM) and/or executive function (EF). More so, there is a wealth of evidence linking cognitive EF to frontal cortical pathology in AD, and it appears that this pathology may occur relatively early in the course of the disease in a subset of AD patients. Based on consistent research observations that stages in human cognitive development may be delineated by the ability to process relational representations of different complexities, Halford & Wilson have proposed a hypothesis claiming that relational information is a predictor of the reliance of problems on cognitive executive functions, as well as a predictor of the degree of prefrontal cortex involvement in a cognitive task (Halford, G. S., & Wilson, W. H. (1980). A category theory approach to cognitive development. Cognitive Psychology, 12, 356-411; Halford, G. S. (1984). Can young children integrate premises in transitivity and serial order tasks? Cognitive Psychology, 16, 65-93) and (Halford, G. S., Wilson, W. H., & Phillips, S. (1998). Processing capacity defined by relational complexity: Implications for comparative, developmental, and cognitive psychology. Behavioral & Brain Sciences, 21, 803-864; Robin, N., & Holyoak, K. J. (1995). Relational complexity and the functions of prefrontal cortex. In M. S. Gazzaniga (Ed.), The cognitive neurosciences (pp. 987-997). Cambridge, Mass.: MIT Press).

A subgroup of AD patients in Halford and Wilson's study showed significant impairment on reasoning measures that required online integration of multiple (complex) relations and a neuropsychological profile consistent with prefrontal cortical dysfunction. In addition, because abstract thought is known to depend on the ability to integrate multiple relations, as propositional elements need to be mapped across domains, a number of studies showing impairments in abstract reasoning in mild-to-moderate AD are consistent with the integration of relational information deficits (Halford, G. S., Wilson, W. H., & Phillips, S. (1998). Processing capacity defined by relational complexity: Implications for comparative, developmental, and cognitive psychology. Behavioral & Brain Sciences, 21, 803-864).

For example, studies have demonstrated difficulties in patients with AD in identifying similarities between objects or concepts (Huber, S. J., Shuttleworth, E. C., & Freidenberg, D. L. (1989). Neuropsychological differences between the dementias of Alzheimer's and Parkinson's diseases. Archives of Neurology, 46, 1287-1291; Martin, A., & Fedio, P. (1983). Word production and comprehension in Alzheimer's disease: The breakdown of semantic knowledge. Brain and Language, 19, 124-141; Pillon, B., Dubois, B., Lhermitte, F., & Agid, Y. (1986). Heterogeneity of cognitive impairment in progressive supranuclear palsy, Parkinson's disease, and Alzheimer's disease. Neurology, 36, 1179-1185), in the comprehension of proverbs (Kempler, D., van Lancker, D., & Read, S. (1988). Proverb and idiom comprehension in Alzheimer's disease. Alzheimer's Disease and Associated Disorders, 2, 38-49), and in general abilities related to the capacity to perform inductive inference (Cronin-Golomb, A., Rho, W. A., Corkin, S., & Growdon, J. H. (1987). Abstract reasoning in age-related neurological disease. Journal of Neural Transmission, 24, 79-83).

Still, additional studies on AD individuals suggest that they experience particular difficulty in the performance of tasks of cognitive estimation, another form of inference (Goldstein, F. C., Green, J., Presley, R., & Green, R. C. (1992). Dysnomia in Alzheimer's disease: An evaluation of neurobehavioral subtypes. Brain and Language, 43, 308-322; Shallice, T., & Evans, M. E. (1978). The involvement of the frontal lobes in cognitive estimation. Cortex, 14, 294-303; Smith, M. L., & Milner, B. (1984). Differential effects of frontal-lobe lesions on cognitive estimation and spatial memory. Neuropsychologia, 22, 697-705).

### Relational Words Enacting a Flexible Orthographic Coding in Alphabetical Languages

### Some Open Bigrams are Also Relational Open Proto-Bigram Function Words

A number of computational models have postulated open bigrams as the best means to substantiate a flexible orthographic encoding. In these models, a flexible orthographic coding is achieved by coding ordered combinations of contiguous and non-contiguous letter pairs, namely open bigrams. Still, these open bigrams represent an abstract intermediary layer between letters and word units. For example, in the English language there are 676 pairs of letters combinations or open bigrams (see Table 1 below). We introduce herein an open bigram novel language property that plays an early pivotal brain developmental role in shaping higher order cognitive conceptual skills to rapidly adapt and be able to efficiently handle, implicitly and/or explicitly, alphanumeric computations (serial, combinatorial, or statistical kind) and their resulting associative/analogical inductive thought processes through input-output learning mechanisms.

The teachings of the present invention identify and categorize monosyllabic word members that belong to one of five novel classes of open bigram words, herein dubbed “relational open proto-bigram words” (see below). There are 24 relational open proto-bigrams that convey a linguistic semantic meaning, and therefore are considered words. These 24 relational open proto-bigrams words represent 3.55% out of 676 monosyllabic open bigrams possible to obtain in the English Language alphabet (see Table 1 below).

TABLE 1
Open-Bigrams of the English Language

| | | | | | | | | | | | | | | | | | | | | | | | | | |
|---|---|---|---|---|---|---|---|---|---|---|---|---|---|---|---|---|---|---|---|---|---|---|---|---|---|
| aa | ab | ac | ad | ae | af | ag | ah | ai | aj | ak | al | am | an | ao | ap | aq | ar | as | at | au | av | aw | ax | ay | az |
| ba | bb | bc | bd | be | bf | bg | bh | bi | bj | bk | bl | bm | bn | bo | bp | bq | br | bs | bt | bu | bv | bw | bx | by | bz |
| ca | cb | cc | cd | ce | cf | cg | ch | ci | cj | ck | cl | cm | cn | co | cp | cq | cr | cs | ct | cu | cv | cw | cx | cy | cz |
| da | db | dc | dd | de | df | dg | dh | di | dj | dk | dl | dm | dn | do | dp | dq | dr | ds | dt | du | dv | dw | dx | dy | dz |
| ea | eb | ec | ed | ee | ef | eg | eh | ei | ej | ek | el | em | en | eo | ep | eq | er | es | et | eu | ev | ew | ex | ey | ez |
| fa | fb | fc | fd | fe | ff | fg | fh | fi | fj | fk | fl | fm | fn | fo | fp | fq | fr | fs | ft | fu | fv | fw | fx | fy | fz |
| ga | gb | gc | gd | ge | gf | gg | gh | gi | gj | gk | gl | gm | gn | go | gp | gq | gr | gs | gt | gu | gv | gw | gx | gy | gz |
| ha | hb | hc | hd | he | hf | hg | hh | hi | hj | hk | hl | hm | hn | ho | hp | hq | hr | hs | ht | hu | hv | hw | hx | hy | hz |
| ia | ib | ic | id | ie | if | ig | ih | ii | ij | ik | il | im | in | io | ip | iq | ir | is | it | iu | iv | iw | ix | iy | iz |
| ja | jb | jc | jd | je | jf | jg | jh | ji | jj | jk | jl | jm | jn | jo | jp | jq | jr | js | jt | ju | jv | jw | jx | jy | jz |
| ka | kb | kc | kd | ke | kf | kg | kh | ki | kj | kk | kl | km | kn | ko | kp | kq | kr | ks | kt | ku | kv | kw | kx | ky | kz |
| la | lb | lc | ld | le | lf | lg | lh | li | lj | lk | ll | lm | ln | lo | lp | lq | lr | ls | lt | lu | lv | lw | lx | ly | lz |
| ma | mb | mc | md | me | mf | mg | mh | mi | mj | mk | ml | mm | mn | mo | mp | mq | mr | ms | mt | mu | mv | mw | mx | my | mz |
| na | nb | nc | nd | ne | nf | ng | nh | ni | nj | nk | nl | nm | nn | no | np | nq | nr | ns | nt | nu | nv | nw | nx | ny | nz |
| oa | ob | oc | od | oe | of | og | oh | oi | oj | ok | ol | om | on | oo | op | oq | or | os | ot | ou | ov | ow | ox | oy | oz |
| pa | pb | pc | pd | pe | pf | pg | ph | pi | pj | pk | pl | pm | pn | po | pp | pq | pr | ps | pt | pu | pv | pw | px | py | pz |
| qa | qb | qc | qd | qe | qf | qg | qh | qi | qj | qk | ql | qm | qn | qo | qp | qq | qr | qs | qt | qu | qv | qw | qx | qy | qz |
| ra | rb | rc | rd | re | rf | rg | rh | ri | rj | rk | rl | rm | rn | ro | rp | rq | rr | rs | rt | ru | rv | rw | rx | ry | rz |
| sa | sb | sc | sd | se | sf | sg | sh | si | sj | sk | sl | sm | sn | so | sp | sq | sr | ss | st | su | sv | sw | sx | sy | sz |
| ta | tb | tc | td | te | tf | tg | th | ti | tj | tk | tl | tm | tn | to | tp | tq | tr | ts | tt | tu | tv | tw | tx | ty | tz |
| ua | ub | uc | ud | ue | uf | ug | uh | ui | uj | uk | ul | um | un | uo | up | uq | ur | us | ut | uu | uv | uw | ux | uy | uz |
| va | vb | vc | vd | ve | vf | vg | vh | vi | vj | vk | vl | vm | vn | vo | vp | vq | vr | vs | vt | vu | vv | vw | vx | vy | vz |
| wa | wb | wc | wd | we | wf | wg | wh | wi | wj | wk | wl | wm | wn | wo | wp | wq | wr | ws | wt | wu | wv | ww | wx | wy | wz |
| xa | xb | xc | xd | xe | xf | xg | xh | xi | xj | xk | xl | xm | xn | xo | xp | xq | xr | xs | xt | xu | xv | xw | xx | xy | xz |
| ya | yb | yc | yd | ye | yf | yg | yh | yi | yj | yk | yl | ym | yn | yo | yp | yq | yr | ys | yt | yu | yv | yw | yx | yy | yz |
| za | zb | zc | zd | ze | zf | zg | zh | zi | zj | zk | zl | zm | zn | zo | zp | zq | zr | zs | zt | zu | zv | zw | zx | zy | zz |

Some Relational Open Proto-Bigrams Words are Function Words Depicting: 1) Prepositions, 2) Actions, 3) Conjunctions and 4) Linguistic Structures that (Tacitly) Refer to: a) the Speaker or b) Others in Alphabetic Languages

There are five classes of open bigrams that are also considered to be words in the English language which play a central enactive role in the developmental maturation of abstract relational thinking. These five classes of open bigrams function to relate/link into the same category (within the permissible grammatical structure of the English language) meanings of distant lexical items into a novel category domain and/or relate/link meanings of close lexical items into a natural/conventional category domain. This relational alignment among lexical items is gradually attained via thought processes involved in the conceptual enactment of a coherent spatial-temporal relational mapping. At first, these thought processes implicitly depict abstract shallow relational links among lexical items, but later on they turn into complex, ruled-based, relational mapping (web) involving deep causal relationships among lexical items. Thus analogies (e.g., comparisons, similarities, exemplar prototyping), interpretations concerning different kinds of figurative meanings (e.g., metaphors, ironies, proverbs), and metacognitive mentation states emerge as relational knowhow.

One class of open bigrams of the form vowel-consonant (VC) or consonant-vowel (CV) are considered to be words that carry semantic relational meaning; This class is herein named “relational open proto-bigrams”. AN, AS, AT, BY, IN, OF, ON, TO, UP, are highly frequent ‘function’ words that belong to a linguistic class named ‘preposition words’. A preposition word is a word governing, and usually preceding, a noun or pronoun, and expressing a relation to another word or element in the clause, such as ‘the book is on the table’, ‘she looked at the cat’, ‘what did you do it for? We commonly use prepositions to show a relationship in space or time or a logical relationship between two or more people, places, or things. In English, some propositions are short, mostly containing six letters or fewer.

A second class of open bigrams of the form VC or CV that are also considered to be words that carry semantic relational action meaning. This class is herein also named “relational open proto-bigrams”. These relational open proto-bigrams words are highly frequent ‘function’ words that belong to a linguistic class named ‘verb words’. Verb words are any member of a class of words that function as the main elements of predicates, typically express an action, a state, or a relation between two things, and may be inflected for tense, aspect, voice, mood, and to show agreement with the subject or object. These relational open proto-bigram words are the following function words: AM, BE, DO, GO, IS, NO.

A third class of open bigram of the form VC or CV that are also considered to be words that carry semantic relational meaning. This class is herein also named “relational open proto-bigrams”. These relational open proto-bigram words entail highly frequent ‘functional’ words that belong to a linguistic class named ‘conjunction words’. Conjunction words are very important for constructing sentences. Conjunction words link/relate different parts of a sentence. Basically, conjunctions join/relate words, phrases, and clauses together. These relational open proto-bigrams are the following conjunction words: AS, IF, OR, SO.

A fourth class of open bigrams of the form VC or CV that are also considered to be words that carry semantic relational meaning. This class is herein also named “relational open proto-bigram”. These relational open proto-bigram words entail highly frequent ‘functional’ words that their meaning tacitly represents or implies the “speaker” or “others”, referring to 1) belonging to or associated with the speaker; 2) used by a speaker to refer to himself/herself and one or more other people considered together; 3) used as the object of a verb or preposition; 4) referring to the male person or animal being discussed or last mentioned; or 5) to anyone (without reference to sex) or tacitly to “that person”. These relational open proto-bigrams are the following functional words: HE, ME, MY, US, WE.

A fifth open bigrams class of the form VC or CV that are also considered to be words that carry semantic relational meaning. This class is herein named “relational open proto-bigrams”. These relational open proto-bigram words convey a semantic meaning that is interpreted by the listener to imply potentially ‘figurative’ meaning referring to: 1) a concept or abstract idea: ‘IT’; or 2) a negation as a metaphor inducing operator: ‘NO’ (Giora, R., Balaban, N., Fein, O., & Alkabets, I. (2005). Negation as positivity in disguise. In: Colston, H. L., and Katz, A. (eds.), Figurative Language comprehension: Social and cultural influences (pp. 233-258). Hillsdale, N.J.: Erlbaum; Giora, R., Fein, O., Metuki, N., & Stern, P. (2010). Negation as a metaphor-inducing operator. In L. Horn (Ed.), The expression of negation (pp. 225-256). Berlin: Mouton). Negation is a device that often functions to enhance metaphoric meaning in discourse such as “I am not your maid”. Yet, affirmative counterparts are judged as conveying literal interpretations containing the modifier “almost”, such as “I am almost your maid”, to convey literal meaning.

In general, functional relational open proto-bigram words either have reduced lexical meaning or ambiguous meaning. They signal the structural grammatical relationship that words have to one another and are the relational lexical glue that holds sentences together. Relational open proto-bigram words (function) also specify the attitude or mood of the speaker. They are resistant to change and are always relatively few (in comparison to ‘content words’). Relational open proto-bigrams (and other n-grams e.g. “THE”) words may belong to one or more of the following function words classes: articles, pronouns, adpositions, conjunctions, (auxiliary) verbs, interjections, particles, expletives, and pro-sentences. Further, relational open proto-bigrams that are function words are traditionally categorized across alphabetic languages as also belonging to a class named ‘common words’.

In the English language, there are about 350 common words which represent about 65-75% of the words most used when speaking, reading, or writing. These 350 most common words satisfy the following criteria: 1) the most frequent/basic words of an alphabetic language; 2) the shortest words (on average)—up to 6 or 7 letters per word; and 3) are not perceptually discriminated (access to their semantic meaning) by the way they sound; they must be orthographically recognized (by the way they are written).

Frequency Effects in Alphabetical Languages for: 1) Relational Open Proto-Bigrams Function Words as: a) Stand-Alone Function Words in Between Words and as b) Subset Function Words Embedded within Words

Fifty to 75% of written words or words articulated in a conversation belong to the group of most common words. Just 100 different most common words in the English language (see Table 2 below) account for a remarkable 50% of any written or spoken text. Furthermore, it is noteworthy that 22 of the above-mentioned relational open proto-bigrams function words (BE, TO, OF, IN, IT, ON, HE, AS, DO, AT, BY, WE, OR, AN, MY, SO, UP, IF, GO, ME, NO, US) (see table 2 below) are also part of the 100 most common words. On average, one in any two spoken or written words is one of the 100 most common words. Similarly, 90% of any average written text or conversation is comprised of a vocabulary consisting of about 7,000 common words from the existing 1,000,000 words in the English language.

TABLE 2
Most Frequently Used Words Oxford Dictionary 11^{Th} Edition

| | |
|---|---|
| 1. | the |
| 2. | be |
| 3. | to |
| 4. | of |
| 5 | and |
| 6. | a |
| 7. | in |
| 8. | that |
| 9. | have |
| 10. | I |
| 11. | it |
| 12. | for |
| 13. | not |
| 14. | on |
| 15. | with |
| 16. | he |
| 17. | as |
| 18. | you |
| 19. | do |
| 20. | at |
| 21. | this |
| 22. | but |
| 23. | his |
| 24. | by |
| 25. | from |
| 26. | they |
| 27. | we |
| 28. | say |
| 29. | her |
| 30. | she |
| 31. | or |
| 32. | an |
| 33. | will |
| 34. | my |
| 35. | one |
| 36. | all |
| 37. | would |
| 38. | there |
| 39. | their |
| 40. | what |
| 41. | so |
| 42. | up |
| 43. | out |
| 44. | if |
| 45. | about |
| 46. | who |
| 47. | get |
| 48. | which |
| 49. | go |
| 50. | me |
| 51. | when |
| 52. | make |
| 53. | can |
| 54. | like |
| 55. | time |
| 56. | no |
| 57. | just |
| 58. | him |
| 59. | know |
| 60. | take |
| 61. | person |
| 62. | into |
| 63. | year |
| 64. | your |
| 65. | good |
| 66. | some |
| 67. | could |
| 68. | them |
| 69. | see |
| 70. | other |
| 71. | than |
| 72. | then |
| 73. | now |
| 74. | look |
| 75. | only |
| 76. | come |
| 77. | its |
| 78. | over |
| 79. | think |
| 80. | also |
| 81. | back |
| 82. | after |
| 83. | use |
| 84. | two |
| 85. | how |
| 86. | our |
| 87. | work |
| 88. | first |
| 89. | well |
| 90. | way |
| 91. | even |
| 92. | new |
| 93. | want |
| 94. | because |
| 95. | any |
| 96. | these |
| 97. | give |
| 98. | day |
| 99. | most |
| 100. | us |

Most Frequently Used Words Oxford Dictionary 11^{th} Edition

Higher Lexical Relational Complexity Provided by Relational Open Proto-Bigram Function Words Embedded within Relational and Non-Relational Words

Relational open proto-bigram words represent a layer of relational knowledge. Therefore, the fast and direct implicit recognition of the same when orthographically embedded within carrier words provides an additional stratum of relational lexical information, on top of the phenomena triggering lexical meaning effects related to subwords embedded within carrier words. This additional stratum of relational lexical knowledge enables the cognitive enacting of a novel (non-causal), lexical relational mapping that sets in motion abstract computations depicted herein as interrelations, correlations, and cross-correlations among close (e.g., neighbors) and distant related lexical item meanings (e.g. lexical meanings belonging to different semantic categories).

The attained cognitive higher order lexical relational mapping rests upon novel mentation computational processes depicting complex abstract symbolic conceptualizations that simultaneously mesh several layers of lexical relational meanings together, thereby strongly activating inductive reasoning and multi-layer inference processes. For example, a relational open proto-bigram word that is a subset word (e.g., “BE” embedded in a carrier word “BELOW” or a subset word “HE” embedded in a carrier word “SHE” or “THE”) would not only indicate that the orthographic form and semantic meaning of the subset relational open proto-bigram word (“HE” in the carrier word “SHE” or “THE” or “BE” in the carrier word “BELOW”) are activated in parallel. The relational open proto-bigram word that is a subset word would also indicate that these co-activated word forms automatically and directly trigger their corresponding semantic literal meanings (name representations) during the course of identifying (visually) the orthographic form of the target carrier word.

One of the goals of the teachings of the present subject matter is to portray a new theory concerning access to lexical relational knowledge. Accordingly, a novel methodology is presented where lexical relational knowledge is directly accessed in alphabetic languages that possess a flexible orthographic code, consequently fluent reasoning allowing the immediate implicit extraction of at least three layers of lexical relational information, such as: 1) relational carrier word [that]—embedded subword [hat]—embedded relational open-proto-bigram word [h]+[at], 2) relational carrier word [seat]—embedded relational subword [eat]—embedded relational open-proto-bigram word [e]+[at] and, 3) relational carrier word [stop]—embedded relational subword [top]—embedded relational open-proto-bigram word [to]+[p].

Basically, the present subject matter corroborates a dynamic system approach to cognitive linguistics. This dynamic system approach sets in motion cognitive higher order abstract conceptual processes in the prefrontal cortex brain architecture. Although, the prefrontal cortex develops slowly in the evolutionary sense, it is nonetheless highly sophisticated and capable of triggering neural plasticity by simultaneously activating multiple interrelated layers of lexical relational meanings. At the outset, symbolic alphabetical data is conceptualized as abstract and ambiguous, namely portraying a non-causal, non-stochastic nature manifesting as a set of symbols that express novel relationships that (in the beginning) resist the intrusive attempts of human cognitive reasoning to trap information and to reveal and encode lexical meaning via recursive linguistic mechanisms. However, with continuous language exposure (language production and reception) and ongoing brain neural maturation, a developmental shift in the abstract and ambiguous conceptualization mapping that represents lexical relational knowledge occurs in a way that the acquired lexical relational knowledge becomes progressively conventionalized. Accordingly, fluid inductive reasoning/thinking and to an extent fluid deductive reasoning/thinking competently tap into recursive lexical interactions and successfully structure conceptualized alphabetical data to better fit causality and/or extract a statistical pattern (e.g., rule based) from alphabetical data chunks that corroborates meaningful relationships.

The shift in conceptual knowledge that enables higher order cognitive inductive-deductive reasoning access to abstractly map several interacting layers of lexical relational meanings is constantly being constrained by age dependent brain processing speed and memory capacity limitations. Due to a continuous exposure to language along unfolding age dependent brain maturational processes, cognitive higher order relational conceptual faculties can usefully tap into complex chaotic strings of alphabetical data. This abstract conceptual tapping into alphabetical data comes into effect (mostly) via recursive mechanisms that directly extract meaningful lexical alphabetical structures from alphabetical non-meaningful chaos. Still, this conceptual abstract extraction of meaningful alphabetical lexical knowledge suddenly emerges in direct correlation with cognitive problem solving and reasoning intrusion. This particular cognitive problem solving and implicit-explicit reasoning succeeds in establishing one or more surface similarities comparisons among symbolic members of these alphabetical arrangements aided by flexible alphabetical orthographic coding and phonemic coding to some degree.

On one hand, the present teachings suggest that the brain's mechanisms and processes involved in the gradual developmental maturation of higher order cognitive functions through language may be the main reason for the strong embodiment of language experience (action-acting and naming). On the other hand, it is understood that the continuous exposure to and immersion in an alphabetical flexible orthographic (and to some degree phonemic) code is instrumental in triggering the non-linear emergence of conceptual metacognitive faculties (think about thinking), which in part shape what is implicitly and/or explicitly sensed/perceived/attended and abstractly thought/conceptualized (through the use and exposure to language) in the physical and social worlds at large.

Direct Access to Higher-Order Cognitive Relational Knowledge in Words within Words

Relational language knowledge and/or skills can be accessed directly from print when identifying/recognizing a subset word embedded within a carrier word. Specifically, relational language knowledge is available via identification/recognition of the unique serial ordinal positions of letters in a letter string, the orthographic form of letters, phonemic production-reception, and the degree of activation of the correlated semantics of letters.

Most generally, this relational language knowledge realization is accessed effortlessly when the speaker or listener instantaneously implicitly infers and enacts relationships of words based on various degrees of stimuli similarities. Examples of stimuli similarities include: 1) same letters in letters strings that share the same contiguous or non-contiguous serial ordinal positions; 2) orthographic form similarities between letters; 3) similarities of phonemes via phonetic reception; 4) extraction of congruent or non-congruent meaning among different lexical items, e.g., ship-hip, where the embedded subword hip belongs semantically to a body part category; 5) orthographic similarities arising from alterations of one or more letters entailed in a letter string; for example, after the addition, deletion, substitution, or transposition of at least one letter e.g., statue—state or comet-come or calm-clam or war-bar; 6) the effects of orthographic neighbors arising from automatic activation of orthographically similar words; and 7) structure recognition of morphologically complex words, e.g., direct-director.

Direct Access to Semantic Meaning from Print: Orthographic and Semantic Parallel Activation of Embedded Words

All alphabetical languages are characterized by extensive lexical embedding, which refers to the existence of shorter words embedded within longer words (e.g., “seat” in the spoken word “conceit”, or “crow” in the written word “crown”). Lexical embedding in English is extensive. Based on a 20,000 word on-line lexicon, Luce found that when bisyllabic words, which are the most frequent multisyllabic words (having 2-7 syllables), are controlled for frequency, they represent almost 62% of the lexicon. Luce also found that monosyllabic words were embedded in the beginnings of these longer frequent multisyllabic carrier words (e.g., car in carpet) (Luce, P. (1986). A computational analysis of uniqueness points in auditory word recognition. Perception & Psychophysics, 39, 409-420).

In an analysis made of about 25,000 transcription words of British English, McQueen and Cutler found that about 94% of polysyllabic words begin with monosyllabic words (McQueen, J. M., & Cutler, A. (1992). Words within words: Lexical statistics and lexical access. In J. Ohala, T. Neary, & B. Derwing (Eds.), Proceedings of the Second International Conference on Spoken Language Processing: Vol. 1 (pp. 221-224). Alberta: University of Alberta). In yet another estimate by McQueen, about 83% of spoken polysyllabic words were found to contain at least one embedded word, in the initial, final, and medial positions (McQueen, J. M., Cutler, A., Briscoe, T., & Norris, D. (1995) Models of continuous speech recognition and the contents of the vocabulary. Language and Cognitive Processes, 10, 309-331).

Taft and Forster have conducted research in visual modality in order to examine the processing of carrier words containing embedded subword items (Taft, M., & Foster, K. (1976). Lexical storage and lexical retrieval of polymorphemic and polysyllabic words. Journal of Verbal Learning and Behavior, 15, 607-620). In one of the experiments, they presented participants with real bisyllabic word carriers, half of which contained first syllables that were embedded with high-frequency words. The other half contained initial syllables that were embedded with either low-frequency words or non-words. Word responses were faster to the stimuli that began with high-frequency embedded words. These findings demonstrate that when the first syllable of a bisyllabic word carrier item is an embedded word (subword), visual recognition of the word carrier item itself is affected, regardless of the lexicality of the carrier word.

Using the cross-modal priming technique, Luce and Cluff examined activation of component items in spoken bisyllabic carrier words such as hemlock, which consist of two syllables that are each independent words (Luce, P. A., & Cluff, M. S. (1998). Delayed commitment in spoken word recognition: Evidence from cross-modal priming. Perception & Psychophysics, 60, 484-490). They obtained priming of related visual targets by second-syllable embedded items. For example, hemlock primed key as much as lock primed key, which suggests that lock is activated when hemlock is heard (see also Vroomen, J., & de Gelder, B. (1997) Activation of embedded words in spoken word recognition. Journal of Experimental Psychology: Human Perception and Performance, 23, 710-720).

Still, one of the main questions of concern is how speech perception correctly identifies the embedding word (the superset) rather than the many embedded words (the subsets) that are also present in the input. In this regard, it is agreed that listeners exploit a variety of sublexical clues that are associated in a probabilistic manner with word boundaries alongside lexical knowledge. Thus, when a string of phonemes is consistent with multiple overlapping lexical forms, multiple lexical entries are coactivated and compete for recognition. For example, the word “seat” coactivates the word forms “sea”, “seat”, and “eat” (see Shillcock, R. (1990) Lexical hypothesis in continuous speech. In G. T. M. Altman (Ed.), Cognitive models of speech processing: Psycholinguistic and computational perspectives. Acl mit press series in natural language processing (pp. 24-49). Cambridge, Mass.: The MIT Press).

An investigation by Bowers revealed the key results that the semantic categorization of target words is slower and less accurate when higher-frequency subset words or superset words are associated with a conflicting response (e.g., Does hatch refer to a piece of clothing?) compared to a congruent response (e.g., Does hatch refer to a body part?) (Bowers, J. S., Davis, C, J., & Hanley, D. A. 2005b Automatic semantic activation of embedded words: is there a ‘hat in ‘that’? J. Mem. Lang. 52, 131-143). The results of this investigation led to a number of important conclusions. First, the obtained result strongly suggests that the subset words and superset words of target words are activated to the level of form and meaning. Second, the obtained congruence effects extend to superset words containing the initial, middle and/or final subset words showing that all of these subset-superset words' relations are orthographically similar. Third, measurements of orthographic similarity need to be extended to words of different lengths. In sum, there is strong evidence that subset and superset of target words are activated to the level of form and semantic meaning. This emphasizes the orthographic similarity between words of different lengths and strongly suggests a direct semantic access from print which is characterized by cascaded processing.

In fact, recognition of embedded subwords within carrier words starts at a very young age. In a study carried by Nation & Cocksey, children as young as 7-years-of age, were able to activate semantic information from embedded orthographic representations (subset words), in spite of their relatively early stages of learning to read (Nation, K. & Cocksey, J. 2009b Beginning readers activate semantics from sub-word orthography. Cognition 110, 273-278). Carrier words contain embedded words. For example, the subword hip is embedded in the carrier word ship. In the congruent condition, neither the carrier word nor the embedded subword were related to the category judgment (e.g., is ship an animal?). In the incongruent condition, embedded subwords were related in meaning to the category (e.g., is ship a body part? although ship is not a body part, the embedded subword hip is a body part). Children were found to be significantly slower and less accurate at making category judgments in the incongruent condition indicating that semantic information is activated very rapidly from subword orthography. Nation & Cocksey observed semantic interference regardless of whether the embedded word shared its pronunciation with the word carrier (e.g., the hip in ship) or not (e.g., the crow in crown). They also observed semantic interference regardless of whether the embedded word shared its position within the word carrier suggesting that, just as in adults, the semantic interference was not dependent on phonological mediation (revealed by processing costs in the reaction time analyses and differences in accuracy).

From their results, Nation & Cocksey interpreted that children who are 7-years-of age have begun to establish an orthographic system that is capable of activating embedded lexical items that is strong enough to directly connect with semantic meaning when reading words silently. Two notable conclusions can be made about visual word recognition (in young children and adults) from the above study. First, the fact that semantic interference functioned at a subword level (embedded word) demonstrates that semantic activation from orthography is not dependent on the visual identification of the whole word. Second, the finding that semantic interference was equivalent regardless of whether or not the embedded words shared their pronunciation with the carrier word demonstrates that semantic activation is not dependent on phonological mediation. Instead, this shows that access to semantic meaning from orthography can be direct and fast and that these direct links between orthography and semantics start very early during the course of reading development.

Similarly, the role of morphology in word reading in adults, provides evidence that sensitivity to morphological structure influences the early stages of visual word recognition (e.g. Rastle, K., Davis, M. H. & New, B. 2004 The broth in my brother's brothel: morpho-ortho segmentation in visual word recognition. Psychon. Bull. Rev. 11, 1090-1098; McCormick, S. F., Rastle, K. & Davis, M. H. 2008 Is there a ‘fete’ in fetish? Effects of orthographic opacity on morpho-orthographic segmentation in visual word recognition. J. Mem. Lang. 58, 307-326). Burani et al. found that children read pseudowords that were made up of stem and suffix morphemes (e.g., womanist is a pseudoword but is made from two morphemes, namely [woman]+[ist]) faster than pseudowords that did not contain embedded morphemes (Burani, C., Marcolini, S., De Luca, M. & Zoccolotti, P. 2008 Morpheme-based reading aloud: evidence from dyslexic and skilled Italian readers. Cognition 208, 243-262). Most remarkably, younger children (and poor readers) also showed a processing advantage for words that contained morphological embedded structure suggesting that they were relying on morphological parsing (visual orthographic recognition) to a greater extent than more skilled readers (Reichle, E. D. & Perfetii, C. A. 2003 Morphology in word identification: a word-experience model that accounts for morpheme frequency effects. Sci. Stud. Reading 7, 219-237; Verhoeven, L., & Perfetti, C. 2003 Introduction to this special issue: the role of morphology in learning to read. Sci. Stud. Reading 7, 209-217).

### Orthographic Neighborhood Effects

The processing of a written word results in the automatic activation of orthographically similar words. This phenomenon is named ‘the word's orthographic neighbors” and its automatic activation can affect the speed of lexical access. The pattern of lexical similarity is important to the research of visual word recognition and reading since it provides insight into the organization of lexical and orthographic knowledge. Neighborhood effects provide important evidence about lexical retrieval, selection processes, and orthographic input coding. In a classic study in the field of visual word identification, Coltheart et al. manipulated an orthographic similarity metric that they labeled “N” (Coltheart, M., Davelaar, E., Jonasson, J. T., & Besner, D. (1977). Access to the internal lexicon. In S. Dormic (Ed.), Attention and performance VI (pp. 535-555). New York: Academic Press). This N metric was previously suggested by Landauer and Streeter as a measure of the number of close “neighbors” of a stimulus (Landauer, T., & Streeter, L. A. (1973). Structural differences between common and rare words: Failure of equivalence assumptions for theories of word recognition. Journal of Verbal Learning and Verbal Behavior, 12, 119-131). The conventional definition of a neighbor considers only words formed by the substitution of a single letter. Accordingly, N was postulated as a metric that counts the number of substitution neighbors (SNs) of a letter string where N is computed by counting the number of words that can be created by changing a single letter of the stimulus. Substitution neighbors are the number of words sharing the same letter in all but one position (e.g., the word river has an orthographic neighborhood including diver, liver, rover, rider, and rivet).

Interestingly, Coltheart found that N had no effects on the latency of yes lexical decision responses, but that no lexical decision responses to large-N non-words were slower than those lexical decisions to small-N non-words. It was argued that fixating a letter string leads to the automatic activation of its neighbors, and that this lexical activation made it harder to reject large-N nonwords compared to small-N nonwords. In the same regard, a straight forward prediction of this approach is that orthographic similarity impedes word identification. For example, the identification of the word BANISH should be slow relative to the word BANANA, all else being equal, given that the activation of the word BANISH is partially inhibited by the orthographic-similar word VANISH, whereas the word BANANA has no orthographic-similar word competitors. However, more recently it became clear that the N metric is probably only an approximate measure of the size of the similarity neighborhood of a word or non-word. Accordingly, an additional form of orthographic relationship was suggested, that is not captured by the N metric system, namely the similarity between transposition neighbors (TNs), where pairs of letter strings are identical except for the transposition of two adjacent letters. For example, the word calm is a transposition neighbor of the word clam. Additionally, it is noted that studies using unprimed lexical decision and naming tasks have shown an inhibitory effect due to TN similarity.

Orthographic form priming studies have shown that TN non-word primes produce greater facilitation than substitution neighbor primes (Foster, K. L., Davis, C., Schoknecht, C., & Carter, R. (1987) Masked priming with graphemically related forms: Repetition or partial activation? Quarterly Journal of Experimental Psychology: Human Experimental Psychology, 39A, 211-251; Perea, M., & Lupker, S. J. (2003). Transposed-letter confusability effects in masked form priming. In S. Kinoshita & S. J. Lupker (Eds.), Masked priming: State of the art (pp. 97-120). Hove, UK: Psychology Press; Schoonbaert, S., & Grainger, J. (2004). Letter position coding in printed word perception: Effects of repeated and transposed letters. Language and Cognitive Processes, 19, 333-367), and that TN non-word primes are effective even when the transposed letters are not adjacent (Perea, M., & Lupker, S. J. (2004). Can CANISO activate CASINO? Transposed-letter similarity effects with nonadjacent letter positions. Journal of Memory and Language, 51, 231-246; Perea, M., & Duñabeitia, J. A., & Carreiras, M. (2008). Transposed-letter priming effects for close versus distant transpositions. Experimental Psychology, 55, 397-406; Perea, M., & Carreiras, M. (2006a). Do transposed-letter similarity effects occur at a prelexical phonological level? Quarterly Journal of Experimental Psychology, 59, 1600-1613; Perea, M., & Carreiras, M. (2006b). Do transposed-letter effects occur across lexeme boundaries? Psychonomic Bulletin and Review, 13, 418-422; Perea, M., & Carreiras, M. (2006c). Do transposed-letter similarity effects occur at a syllable level? Experimental Psychology, 53, 308-315).

Another type of similarity that combines letter transpositions and substitutions, named “neighbors once-removed” (NlR), must also be accounted by the N metric (Davis, C. J., & Bowers, J. S. (2004). What do letter migration errors reveal about letter position coding in visual word recognition? Journal of Experimental Psychology: Human Perception and Performance, 30, 923-941 and, Davis, C. J., & Bowers, J. S. (2006). Contrasting five theories of letter position coding. Journal of Experimental Psychology: Human perception and Performance, 32, 535-557). For example, pairs of words like trawl and trial consist of a letter transposition followed by a letter substitution of one of the transposed letters. Evidence obtained from the illusory word paradigm, shows that NlR pairs are found to be more similar than pairs of words involving two letter substitutions. So far, evidence concerning the similarity relationships of letters defining orthographic density has concentrated in letter strings of equal length, but what about the similarity of letter strings that entail many common letters, but differ in length (e.g., statue-state or stable-table or comet-come)?

Davis et al. proposed the following definitions: 1) an addition neighbor (AN) of a word is a letter string that involves the addition of a single letter (in any position) to that word (e.g., [tables]−[table]+[s]) and 2) a deletion neighbor (DN) of a word is a letter string that differs from that word by the deletion of a single letter (e.g., [stat·[u]e]−[state]) (Davis, C. J., Perea, M., & Acha, J. (2009). Re(de)fining the Orthographic Neighborhood: The Role of Addition and Deletion Neighbors in Lexical Decision and Reading. Journal of Experimental Psychology: Human Perception and Performance, 35, 1550-1570). The definitions are also relevant to word neighbors in auditory word recognition where the auditory neighborhood is defined via the “substitution” rule (i.e., a replaced phoneme) and/or via the “add or delete” rule (Goldinger, S. D., Luce, P. A., & Pisoni, D. B. (1989). Priming lexical neighbors of spoken words: Effects of competition and inhibition. Journal of Memory and Language, 28, 501-518). A lexical entry is considered similar to another (“phonological neighbor”) if it can be changed by adding, subtracting, or changing one phoneme (e.g., that, at, bat, cot, and cap would be phonologic neighbors of cat). Indeed, there is evidence supporting the perceptual similarity of letter strings to their DNs and ANs in coding schemes of the type, as for example: the SOLAR model (Davis, C. J. (1999). The Self-Organising Lexical Acquisition and Recognition (SOLAR) model of visual word recognition. Unpublished Doctoral dissertation, University of New South Wales. Available in electronic form at www.maccs.mq.edu.au/colin), the SERIOL model (Whitney, C. (2001). How the brain encodes the order of letters in a printed word: The SERIOL model and selective literature review. Psychonomic Bulletin and Review, 8, 221-243) and the Overlap model, (Gomez, P., Ratcliff, R., & Perea, M. (2008). The overlap model: A model of letter position coding. Psychological Review, 115, 577-601).

Finally, it is possible to distinguish between three different letter positions overlapping among addition and deletion neighbors, specifically initial overlap (e.g., comet-come), final overlap (e.g., that-hat), and outer overlap (e.g., width-with). This distinction is theoretically important for comparing orthographic input coding schemes and for evaluating the importance of exterior letters.

### Highly Flexible Orthographic Coding Schemes: Recognizing the Structure of Morphological Complex Words

Morphological structure reflects a correlation between the form of the word and its meaning. Currently, there seems to be a fairly broad consensus that morphologically-complex words are somehow ‘decomposed’ in early visual word recognition and analyzed in terms of their constituents (e.g., great-ness−[great]+[-ness]). For example, the fast visual recognition of a morphologically complex word is determined in part by the frequency of the stem (New, B., Brysbaert, M., Segui, J., Ferrand, L., & Rastle, K. (2004). The processing of singular and plural nouns in French and English. Journal of Memory and Language, 51, 568-585). Visual recognition of the stem target is facilitated by the prior presentation of a morphologically related prime in a manner that cannot be explained by simple summed effects of the semantic meaning and orthographic letter overlap characteristics of most morphological relatives (Rastle, K., Davis, M. H., Marslen-Wilson, W. D., & Tyler, L. K. (2000). Morphological and semantic effects in visual word recognition: A time-course study. Language and Cognitive Processes, 15, 507-537). Two main contending perspectives have been explored in the field of morphological complex word decomposition.

Perspective I claims that morphological complex word decomposition is a high-level phenomenon constrained by semantic knowledge (Marslen-Wilson, W., Tyler, L. K., Waksler, R., & Older, L. (1994). Morphology and meaning in the English mental lexicon. Psychological Review, 101, 3-33; Plaut, D. C., & Gonnerman, L. M. (2000). Are non-semantic morphological effects incompatible with a distributed connectionist approach to lexical processing? Language and Cognitive Processes, 15, 445-485). Evidence for this morpho-semantic segmentation perspective comes from a series of cross-modal priming experiments in which Marslen-Wilson demonstrated that the recognition of a stem target word (e.g., ‘depart’) is facilitated by the prior presentation of a morphological related prime, but only if that prime is also semantically related to the target word (e.g., ‘departure’ not ‘department’ primes ‘depart’) (Marslen-Wilson, W., Tyler, L. K., Waksler, R., & Older, L. (1994). Morphology and meaning in the English mental lexicon. Psychological Review, 101, 3-33). Marslen-Wilson interpreted these results to mean that words comprising more than one morpheme are decomposed only in cases where the meaning of the complex word can be derived from the meanings of its constituents (e.g., ‘department’ would not be decomposed since its meaning cannot be derived from the meanings of its constituents: [depart]+[-ment]).

Perspective II claims that morphological complex word decomposition is based solely on the existence of a morphological surface structure (e.g., any legal stem plus any legal suffix) (Gold, B. T., & Rastle, K. (2007). Neural correlates of morphological decomposition during visual word recognition. Journal of Cognitive Neuroscience, 19, 1983-1993; Lavric, A., Clapp, A., & Rastle, K. (2007). ERP evidence of morphological analysis from orthography: A masked priming study. Journal of Cognitive Neuroscience, 19, 866-877; Rastle, K., Davis, M. H., Marslen-Wilson, W. D., & Tyler, L. K. (2000). Morphological and semantic effects in visual word recognition: A time-course study. Language and Cognitive Processes, 15, 507-537; Rastle, K., Davis, M. H., & New, B. (2004). The broth in my brother's brothel: Morpho-orthographic segmentation in visual word recognition. Psychonomic Bulletin & Review, 11, 1090-1098). Evidence for this ‘morpho-orthographic’ perspective on complex word decomposition has been obtained in priming experiments where primes are masked and presented very briefly (42 msec), and therefore are unavailable for conscious report. Under these brief exposure conditions, significant and equivalent priming effects on visual lexical decision tasks for semantically related (e.g., darkness-dark), pseudo-morphological (e.g., corner-corn), and even illegal morphological (e.g., ‘spendical-spend’) pairs has been observed.

Meunier and Longtin have presented a third perspective on morphological complex word decomposition (Meunier, F., & Longtin, C. M. (2007). Morphological decomposition and semantic integration in word processing. Journal of Memory and Language, 56, 457-471). They suggested that the morphological recognition of complex words involves two stages: 1) An early stage of visual word processing that is rapid and natural, solely sensitive to the presence of morpho-orthographic printed stimulus information (e.g., applying equally to legal stem+legal suffix of the form of: a) semantically transparent complex words (e.g., darkness), b) semantically opaque complex words (e.g., corner) and c) morphologically-structured non-words (e.g., ‘habiter’)) followed by 2) a later analysis stage when semantic/syntactic information becomes available. This later processing stage consists of a licensing procedure during which these morpho-orthographic complex word segmentations are validated for semantic meaning and syntactic legality.

Preliminary accounts agree that morphologically-complex words are segmented at the morpheme boundary in a manner that enables the stimuli to (directly) activate the orthographic representations of their stems. In the popular classical interactive activation perspective, there is a level of morphemic representation that resides between orthographic representations of letters and words. This morphemic representation is namely the stem and affix units which are activated through the explicit morphemic visual segmentation of stimuli comprising more than one morpheme (e.g., ‘corner’ activated the stem unit [corn] and the affix unit—[er]) (Taft, M. (1994). Interactive-activation as a framework for understanding morphological processing. Language and Cognitive Processes, 9, 271-294).

Similarly, distributed-connectionist accounts suggest that morphologically-complex words can be represented in terms of their morphemic constituents (constituently) at the orthographic level, as the result of unique letter probability contours that characterize the stimuli. (Seidenberg, M. S. (1987). Sublexical structures in visual word recognition: Access units or orthographic redundancy. In M. Coltheart (Ed.) Attention and performance XII: The psychology of reading (pp. 245-263). Hillsdale, N.J.: Lawrence Erlbaum Associates) It is a language empirical fact that bigram and trigram frequencies within morphemes tend to be much higher than those frequencies across morpheme boundaries, thus providing a reliable mechanism for morphemic segmentation (Rastle, K., Davis, M. H., & New, B. (2004). The broth in my brother's brothel: Morpho-orthographic segmentation in visual word recognition. Psychonomic Bulletin & Review, 11, 1090-1098).

Both of these accounts reinforce the view that it is possible to segment a morphologically-complex stimulus into its constituents, the stem and affix components, by solely using orthographic information. However, perfect segmentation of this nature is possible for only around 61% of morphologically complex English words (Baayen, R. H., Piepenbrock, R., & van Rijn, H. (1993). The CELEX lexical database (CD-ROM). Philadelphia, Pa.: Linguistic Data Consortium, University of Pennsylvania). The remaining 39% of derived English words comprise some type of orthographic alteration that does not allow a perfect parse of the letter string into a complete morphemic unit. The majority of words in this group consist of modest rule based alterations e.g., ‘adorable’—stem ‘actor’ instead of stem ‘adore’.

In the same vein, McCormick demonstrated that the morphological decomposition process is robust to at least some of the regular orthographic alterations found in complex English words (McCormick S F, Rastle K, & Davis MH (2008). Is there a ‘fete’ in ‘fetish’? Effects of orthographic opacity on morpho-orthographic segmentation in visual word recognition. Journal of Memory & Language 58, 307-326). McCormick claimed that, in some ways, their experimental findings seem akin to evidence that orthographic representations are robust to minor surface alterations such as letter transpositions (Perea, M., & Lupker, S. J. (2003). Does jugde activate COURT? Transposed-letter similarity effects in masked associative priming. Memory & Cognition, 31, 829-841). This evidence has led a number of researchers to propose orthographic coding schemes that are highly flexible (Davis, C. J., & Bowers, J. S. (2006). Contrasting five different theories of letter position coding: Evidence from orthographic similarity effects. Journal of Experimental Psychology: Human Perception and Performance, 32 535-557; Schoonbaert, S., & Grainger, J. (2004). Letter position coding in printed word perception: Effects of repeated and transposed letters. Language and Cognitive Processes, 19, 333-367; Whitney, C. (2001). How the brain encodes the order of letters in a printed word: The SERIOL model and selective literature review. Psychonomic Bulletin and Review, 8, 221-243).

It is further hypothesized that a subject exercising fluid reasoning abilities to problem solve the herein presented new language settings involving novel configurations of relational lexical items belonging to any of the 5 classes of relational open-proto-bigrams words will result in a number of task related quantifiable neuroperformance and core domain skill gains. Accordingly, the expected measurable gains should at least encompass the following neuroperformance areas: I) sensory motor, II) perceptual, III) higher order cognitive relational abilities and, IV) cognitive non-relational abilities.

The present subject matter also specifically targets the promotion, stability, and enhancement of higher order relational cognition faculties and their interactive informational handshake with other non-relational cognitive abilities exemplified as follows.
1. Ability of a subject's higher order cognitive skills to abstractly conceptualize and enact a complex multidimensional mapping of novel and/or similar relational lexical knowledge stored in LTM from orthographic alphabetical languages, effectuated to infer and activate in parallel potential related LTM stored similar and/or new novel lexical meaning(s) to name: a) a concrete item, b) a relational item, or c) a relational situation-state. Complex conceptualization is defined as the speedy enactment of a web of interrelations (relational mapping), correlations, and cross-correlations among a minimum of 3 relational lexical items meanings;
2. Preferred bottom-up-top-down processing neural channels where a handshake of relational-relational or relational-non-relational lexical information promotes a faster and automatic direct cascaded (parallel) spread activation of meaning (effect) from orthography to semantics;
3. Faster relational lexical-sub-lexical items recognition-identification;
4. Fast processing of relational lexical items in at least the following conditions: a) when priming takes place in carrier-subword congruent conditions and b) when a target carrier-subword has no or few competitive orthographic relational-non-relational lexical neighbors items;
5. Ability to rapidly attain lexical meaning aided by proficiently performing degrees of alphabetical compressions (chunking of letters) on a number of lexical relational items at once in Visual Short Term Memory (VSTM);
6. Real-time conceptual manipulation of relational lexical knowledge/information becoming less attentionally taxing/demanding in: i) Working Memory (WM), ii) Short Term Memory (STM) e.g., monitoring (keeping track), and iii) Long Term Memory (LTM) e.g., encoding-retrieval;
7. Faster and greater on-line (real time) versatility in conceptually manipulating a larger number of relational lexical items in STM at once;
8. Ability to perform robust encoding (stronger relational consolidation among lexical items) and faster automatic retrieval of semantic meaning from relational lexical items from LTM;
9. Direct semantic track for fast retrieval of word relational literal meaning from serial orthographic discrimination;
10. Effective parallel activation of neighboring word forms including multi-letter graphemes (e.g., th, ch) and morphemes (e.g., ing, ous, or);
11. Direct fast word recall that strongly inhibits competing or non-congruent distracting word forms; and
12. For a proficient reader, when relational open proto-bigram words fulfill the role of a standalone function, such as connecting or relating a word unit in between words in a sentence, there will be no visual attentional sensitivity (and no arousal) to the orthographic form of the relational open proto-bigram (ROPB). More so, the semantic literal meaning of the ROPB words will be retrieved automatically as a result of an intrinsic orthographic-phonological representational capacity of the ROPB word, which affords maximal data compression (maximal chunking) along with a robust processing encoding and consolidation in STM-LTM. Namely, standalone connecting/relating ROPB words located in between other words in sentences are factually and automatically ‘known’/recognized implicitly. In other words, a proficient reader may not explicitly pay attention to these ROPBs (implicitly inhibiting paying attention to them) and will therefore remain minimally aroused to the orthographic appearance. In silent reading, the reader will not [silently] verbalize any of the ROPB words encounters while visually swiping through print in a sentence.

It is further assumed that constraining the presented new language settings in novel ways will directly bear an influence on how the subject sensory motor searches, perceptually recognizes, cognitively abstractly conceptualizes, and reasons (e.g., inductively infers) to problem solve and sensory motor perform a given exercise. More particularly, the new language settings will affect how a subject performs a lexical categorization and/or a lexical serial patterning to complete a given set of entailed relational lexical items and/or reorganize a given number of lexical items into a syntactic and grammatically correct structure. Therefore, it is expected that intentionally constraining the presented new language settings through novel fluent reasoning strategies will grant the exercising subject, in a relatively short period of time, an optimal capacity for implicit-explicit transfer of relational lexical knowledge, mainly for the task at hand. However, it is also contemplated that the task-specific acquired relational lexical knowledge can be implicitly transferred to other similar sensorial-perceptual-motor related tasks at a much later time.

The transfer of relational lexical meaning information can generate a direct measurable gain in the performance of the task at hand in the short term, as a result of an efficient sensory motor-perceptual adaptation and related implicit learning. In long run, the transfer of relational lexical meaning can generate a measurable gain in the exercised core skill domain, as a result of explicit learning due to the subject's capability of grasping the full depth of the generated complex multidimensional abstract mapping of relational lexical knowledge and the enacting of a deeper conceptualization concerning planning the best steps to take to correctly (minimize error) solve the task at hand. Therefore, the novel constraining of the presented new language settings aims to provide a subject with a greater affordance to higher order cognitive faculties, which is translated into multidimensional abstract conceptualization mapping and fast processing to activate, retrieve, or inhibit lexical meaning (literal or figurative) from relational language structures and their respective orthographic alphabetical distributions.

The present subject matter also claims that the presented new language settings grant a greater functional versatility to higher order cognitive faculties such that a subject will have the capacity to endure longer optimal cognitive functional stability and to better shield the subject against old age maladies stemming from cognitive decay.

Without limiting the scope of the present subject matter, a number of novel constrains implemented with the presented alphabetical language settings, are briefly listed below:
1) selected relational lexical items belong to specific relational lexical categorical domains;
2) all of the selected relational lexical items are intentionally serially organized according to pre-selected alphabetical orders;
3) the vast majority of the selected relational lexical items consist of letter strings that do not entail repeated letters; selected relational lexical items consisting of letter strings that entail serially non-contiguous repeated letters are also used to a lesser extent; and
4) all of the selected relational lexical items are sensorial modulated of their spatial and/or time perceptual related attributes.

A number of methodological constraints are implemented on the presented new language settings to facilitate and promote lexical implicit-explicit relational knowledge learning and comprehension. The new language settings involve one or more of the following language related processes: production-verbalization, reading silently-aloud, spatial distributions of visual symbols, mentation (e.g., abstract thinking-conceptualization to formulate inferences-deductions and categorical and/or analogical similarities/comparisons), and listening.

Specifically, the herein novel methodological constraints facilitate and promote the following higher order cognitive skills and processes:
1) Conceptual attainment of a greater depth of abstractness when thinking-conceptualizing the meaning of lexical relational properties. For example, the effortless capability of enacting a complex multidimensional abstract mapping involving direct lexical relations and lexical correlations among close and distant lexical relational items and quick abstract conceptualization of a robust casual (ruled or logic based) relational mapping, resulting in efficient linkage-alignment of the multiple involved related meanings of the lexical relational items;
2) Facilitation and promotion of abstract thinking engagement (inventive/creative thinking) concerning novel lexical items, resulting in quick creation/invention (from scratch) of new categorical relational lexical domains;
3) Competency to engage in abstract lexical conceptualizations allowing higher order cognitive handling of a multi-layer of relational lexical knowledge (interconnected and interrelated relational meanings web) on the fly, resulting in effortless powerful analogical thinking-reasoning that proficiently pinpoints and effortlessly extracts similarities of lexical items and makes comparisons among exemplars or retrieves a central tendency among a given number of exemplars, namely the ability to retrieve the “prototype” relational or concrete lexical item from a given sample of lexical or non-lexical items;
4) Competency to quickly, on the fly, and abstractly conceptualize a complex mapping of relational lexical meanings, enhancing the ability to handle/manipulate several interacting or interconnected dimensions of the abstract meanings of relational lexical items. Effortless capability to engage in meta-cognitive introspection states, namely the capability to develop a robust introspective access to metacognitive thinking related to complex interrelated meanings of relational lexical items. In many ways, metacognitive thinking acts to reformat a subject's goal oriented behavior so his/her performance is highly adaptable in the face of novel emerging (not contemplated) circumstances. Still, metacognitive states grant access to problem solving of complex relational lexical concepts/ideas/items, not previously known (novel) or stored (known from past experience) in long term memory. The latter said can be seen to relate best to a subject's ability to engage, on the fly, in metacognitive introspection to parameterize and problem solve a new requirement to perform (non or quasi-expected) relational lexical setting. Such problem solving may also be aided by a suitable learning strategy, such as serial or associative learning. Accordingly, the presented relational lexical setting scenario is conceptually segmented into a number of lexical abstract basic thoughts formulating, at least: ‘what’, ‘how’ and ‘when’ the subject should perform in order to successfully extract, infer-deduct, and analogize similarities/comparisons stored in past related relational lexical knowledge. Further, the conceptual segments are selected according to the new emerging circumstance where the subject will cognitively reciprocate by formulating an adaptive problem solving strategy. The related retrieved relational lexical knowledge will then be applied to task reshape and guide goal-oriented behavior in somewhat similar, although novel, situational circumstances. This kind of behavior can be characterized as imaginative/creative/resourceful;
5) Physiological arousal mechanisms dispose cognitive attention (visual/auditory) to orient and quickly, selectively identify the most likely pragmatic relational meaning in the context of a spoken or written language statement. A written language statement meaning: a) a grammatically correct sentence or sentences, b) a grammatically incorrect sentence or sentences, or c) a list of related or unrelated lexical items meanings [e.g., a written list of “names or numbers” or a written list of “words-like pseudo-non-words”].
6) Physiological arousal mechanisms dispose cognitive attention (visual/auditory) to orient accurately, quickly, and selectively detect and infer semantic relational congruencies or incongruences from spoken or written statements;
7) Physiological arousal mechanisms dispose (receptive) cognitive aural attention to orient selectively rapidly attuning to the prosody sound pattern of spoken language statements, particularly those which entail at least one stand-alone lexical relational item and/or those which entail more than one lexical relational items meaning embedded within one or more lexical relational carrier items meanings. A spoken language statement conveying semantic meaning could be any of the following kinds: a) a spoken grammatical-like correct language statement, b) a spoken non-grammatical-like correct language statement, and c) a spoken language statement in the form of a list of words conveying related or unrelated lexical items meanings [e.g., a spoken list of “names/numbers” words or a spoken list of “words-like non-words”—for example, special letter constructions of pseudowords to receptively suggest a semantic meaning];
8) Selective physiological arousal mechanisms dispose cognitive visual attention to (implicitly) pick up, on the fly, one or more entailed standalone salient lexical relational items meanings and/or one or more salient lexical relational sub-items embedded within one or more standalone lexical relational carrier items meanings when visually swiping/reading printed letter strings.

The related art substantiating the present subject matter is vast. The provided overwhelming evidence corroborates the position that claims relational knowledge as a unique emergent property that empowers and shapes higher order cognitive faculties due to the symbolic implementation-performance (production-reception) and related reasoning about generic alphabetical and lexical serial patterns embedded across all alphabetical languages. Indeed, humans possess a natural capacity for confronting change and adapting to novel introspective metacognitive states as well as social and environmental (physical) perturbations.

In general, the teachings of the present subject matter strongly suggest that higher order cognitive faculties reflect the unique human ability to engage in language mentation states (thinking activities) that abstractly and symbolically conceptualize the quickest best strategy to problem solve a particular undertaking in order to fulfill a goal oriented purpose (short or long term) in and through language.

The present subject matter aims to rapidly promote higher order cognitive relational abstract conceptual thinking-reasoning to rapidly facilitate orthographic and phonological lexical processing and direct cascade activation of related word form meanings. The present subject matter aims to attain the latter by revealing a methodology principally aimed to promote fluid inductive reasoning and novel lexical problem solving involving relational open proto-bigram words. Specifically, these open proto-bigram words are embedded and dynamically interacting, thereby activating one or more lexical meanings at a time in alphabetical language settings. Exemplary alphabetical language settings include: 1) when lexical items are arranged in alphabetical or inverse alphabetical order (or in any other preselected alphabetical order), 2) lexical categories, 3) similes & comparison-based speech statements, 4) analogy-based speech statements, 5) sentence-carrier sub-word layers of lexical embedding, and 6) figurative speech statements (e.g. metaphor, irony). The herein exercising of relational-based lexical knowledge also aims to facilitate and promote new learning and by extension reduce the cognitive taxing effects stemming from busy and distracted attentional processes due to the handling and retrieving of concrete non-relational lexical items from memory in real time.

The present subject matter is generally directed towards: a) reducing cognitive decline in the normal aging population and b) slowing down or reversing early stages of cognitive maladies, later resulting in neurodegeneration states such as Dementia and Alzheimer's disease. These directives are generally achieved through the safe implementation, via a computer, any other mobile device, or the like, of an easy to understand and user friendly, novel alphabetical language neuroperformance regimen of exercises aimed at sustaining the optimal functioning of cognitive brain as a whole, for as long as feasibly possible.

In particular, the interactive embodied informational reciprocal interactions are accomplished among higher order cognitive relational faculties, cognitive non-relational abilities, and sensorial-perceptual skills-systems. In these interactive embodied informational reciprocal interactions, the user becomes physiologically aroused and attentionally oriented (selectively predisposed) in order to be capable of performing the following at once or in a number of steps: alphanumeric pattern search, alphanumeric pattern recognition, alphanumeric pattern abstract conceptualization, alphanumeric pattern constraint, alphanumeric pattern organization (e.g., partial or complete; relate or reject), alphanumeric pattern production, alphanumeric pattern contemplation, and language relationally related to numerical quantities (e.g., the numerical digit value ‘7’ is relationally (related) bigger than the numerical digit value ‘6’; the numerical digit value ‘5’ is relationally (related) smaller than the numerical digit value ‘6’). Additionally, regarding the alphanumeric pattern contemplation, the relational higher order cognitive faculties, sensorial and perceptual skills systems also apply to a ‘social’ context, where language for the most part fulfills a ‘communicative’ acting role.

The implicit-explicit adaptive learning abilities enable humans, in a relatively short period of time, to master the core building blocks of native symbolic alphabetical language and the relative semantic meaning of number quantities in a series of numbers. Furthermore, the teachings of the present subject matter also claim that the learning of selective sequential spatial-temporal alphabetical orders, combinatorial orders, and/or statistical distributions of relational lexical items and the full or partial conceptualization of their resulting relational mappings-systems promotes and enhances cognitive higher order abstract relational thinking-reasoning and their resulting task-embodied performances.

For most part, these cognitive higher order abstract conceptualizations are conceived as portraying and setting in motion relational lexical reasoning processes. Such reasoning processes gradually succeed in enacting a lexical relational informational web of deep causal and logical (ruled based) direct interrelations, correlations, and cross-correlations among relational concepts/ideas/meanings, other concrete non-relational symbolic lexical items meanings (e.g., objects), and other quasi-lexical abstract conceptualizations depicting states (e.g., emotional conditions/feelings about self or others captured via imageability states due to their ambiguity, and rarely represented accurately by relational-non-relational lexical items in language). Nevertheless, these quasi-lexical abstract conceptualization states are also considered to be an important complementary building block of higher order cognition faculties if one is to grasp and master semantic language meaning.

Within the context of the present subject matter, higher order cognitive faculties reflect, more than anything else, the natural ability to engage in complex and interwoven degrees of abstract relational symbolic thinking-conceptualization. Consequently, the capabilities of human embodied sensory motor-perceptual-non-relational cognitive skills are expanded. In fact, these abstract relational and non-relational symbolic thinking-reasoning complex degrees of interactions unfold as introspective conceptualizations capable of simulating functional states related to oneself, others, events, and relational-concrete objects in the environment.

Still, the present subject matter is concerned with cognitive decline in normal aging, MCI, and the early and mild stages of neurodegenerative diseases, such as Dementia, Alzheimer's, and Parkinson's disease. In this respect, the present subject matter provides a non-pharmacological platform of novel alphabetical language neuro-performance exercises that specifically target and promote relational lexical thinking—reasoning problem solving.

Without limiting the scope, the examples of the implemented exercises set in motion an innovative methodology principally promoting fluid reasoning in order to encourage engaging relational lexical problem solving involving the innovative use and manipulation of a vast number of relational lexical items meanings across a multidisciplinary language landscape. Examples within the language landscape include, but are not limited to, categorical learning, figurative language, analogical reasoning in language, language morphology, orthographic-phonological code processing, conceptualization of relational language semantic meaning-mapping, and knowledge.

Still, without limiting the scope of the present subject matter, the herein examples aim to implement the novel use of relational open proto-bigrams lexical items meanings and other selected relational lexical word meanings through alphabetical, categorical, morphological, and various types of syntactic-grammatical language structures settings to achieve certain neuroperformance goals. Further, the parallel activation of distinct but correlated relational lexical meanings and their respective spatial and/or time perceptual related attribute changes, encourages the user to engage inductive abstract conceptualizations to enact complex relational lexical mappings in order to problem solve the presented relational language based settings. Neuroperformance goals may include the following without limitation: a) promote and sustain functional stability of non-relational cognitive processes for as long as feasibly possible; b) promote and sustain functional stability of higher order relational cognitive faculties for as long as feasibly possible; c) delay or shield the normal aging population from the aversive effects arising from non-relational cognitive decline; d) sustain or promote the cognitive drive to explicitly engage in learning; e) delay or shield the MCI population from progressing to the neurodegenerative state; f) promote or withstand (and to some extent enhance) normal performance ability in a selective core of non-relational cognitive skills; and g) facilitate metacognitive introspection ability to guide goal oriented behavior to: 1) successfully perform a selective core of daily instrumental activities and 2) develop encouragement to engage in social interaction.

The performance of a selective core of daily instrumental activities refers herein to innovative metacognitive states capable of introspectively simulating relational performance instances and their successful assembling into coherent embodied patterns (e.g., concrete and/or non-concrete lexical items) of behavior by promoting and guiding goal oriented performance. In these innovative metacognitive states, a subject reasons in order to correctly plan the steps that should be taken to execute future related actions (short & long term). Alternatively, a subject abstractly reasons new relational lexical alignments among a set of lexical item meanings in order to problem solve a real-time novel situation. On the fly, the subject cannot completely recall-retrieve the relational lexical mapping related to similar past performances from LTM to guide present imminent real-time behavior (e.g., real-time performance execution or inhibition).

The development of encouragement to engage in social interaction refers herein to the ability to promote and sustain a novel metacognitive language drive in the user that promotes and thus encourages social interaction (social cognition). Namely, this feature is designed to develop an affective relational motivation in the user for engaging others via relational language thinking and reasoning capable of mentally conceptualizing and simulating affective states.

### Methods

The definitions given to the terms below are in the context of their meaning when used in the body of this application and the claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

“Alphabetic array” is defined as an open serial order of letters, wherein the letters are not fixed to a specific ordinal position, and the letters may either be all different or repeated. An alphabetic array may encompass words and/or non-words.

### “Alphabetic Compression”

It has been empirically observed that when the first and last letter symbols of a word are kept in their respective serial ordinal positions, the reader's semantic meaning of the word may not be altered or lost by altering the ordinal positions or removing one or more letters in between the fixed first and last letters. This orthographic transformation is herein named “alphabetic compression”. Consistent with this empirical observation, the notion of “alphabetical compression” is extended into the following definitions:

If a “symbols sequence is subject to alphabetic compression”, which is characterized by the removal of one or more contiguous symbols located in between two predefined symbols in the sequence of symbols, the two predefined symbols may, at the end of the alphabetic compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the alphabetic compression of a letter sequence is considered to take place at two letters symbols sequential levels, “local” and “non-local”. Further, the non-local letters symbols sequential level comprises an “extraordinary letters symbols sequential compression case.”

A “local open proto-bigram term compression” is characterized by the omission or removal of one or two contiguous letters in a sequence of letters lying in between the two letters that form or assemble an open proto-bigram term. Upon the removal or omission of these letters, the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term. Upon the omission or removal of these letters, the two letters of the open proto-bigram term become contiguous letters in the letters sequence.

An “extraordinary non-local open proto-bigram compression” is a particular case of a non-local open proto-bigram term compression. This occurs in a letters sequence comprising N letters when the first and last letters in the letters sequence are the two selected letters forming or assembling an open proto-bigram term, and the N-2 letters lying in between are omitted or removed. Following the omission or the removal of these letters, the remaining two letters forming or assembling the open proto-bigram term become contiguous letters.

“Absolute incompleteness” is a relative property of serial arrangements of terms. Herein, this property is used only to depict alphabetic set arrays because a set array characterizes complete and closed serial orders of terms. For example, in the context of an alphabetic set array, the term incompleteness means ‘absolute’. Absolute incompleteness involves a number of serial arrangements of terms or parameters, such as number of missing letters, type of missing letters, and ordinal positions of missing letters.

“Affix” is defined as a morpheme that is attached to a word stem to form a new word. “Affixes” may be derivational, like English -ness and pre-, or inflectional, like English plural -s and past tense -ed. They are bound morphemes by definition. Prefixes and suffixes may be separable affixes. Affixation is, thus, the linguistic process speakers use to form different words by adding morphemes (affixes) at the beginning (prefixation), the middle (infixation) or the end (suffixation) of words.

“Alphabetic contiguity” is defined as a visual discrimination facilitation effect occurring when a pair of letters assemble any open bigram term. This is true even in case when 1 or 2 letters in orthographic contiguity lying in between the two edge letters form the open bigram term. It has been empirically confirmed that up to 2 letters located contiguously in between the open bigram term do not interfere with the visual perceptual identity and resulting sensorial perceptual discrimination process of the pair of letters making up the open bigram term. In other words, the visual perceptual identity of an open bigram term (letter pair) remains intact even where up to two letters held in between the two edge letters form the open bigram term.

For the particular case where open bigram terms orthographically directly convey a semantic meaning in a language (e.g., an open proto-bigram), the visual sensorial perceptual identity of the open proto-bigram terms is considered to remain intact even when more than 2 letters are held in between the edge letters forming the open proto-bigram term. This particular visual sensorial perceptual discrimination effect is considered to be an expression of: 1) a Local Alphabetic Contiguity effect, which is empirically manifested when up to two letters are held in between (LAC) for open bigrams and open proto-bigrams terms and 2) a Non-Local Alphabetic Contiguity (NLAC) effect, which is empirically manifested when more than two letters are held in between; this effect only takes place in open proto-bigrams terms. This NLAC defined property of relational open proto-bigrams (ROPB) of an alphabetic set array is also extended for when the ROPBs are present in alphabetic arrays which have a semantic meaning, namely when the two letters forming an ROPB are the first and last letters of a word.

Both LAC and NLAC are part of the novel methodology aiming to advance a flexible orthographic sensorial perceptual decoding and ultra-efficient/superior rapid processing view concerning sensory motor grounding of sensory perceptual-cognitive alphabetical, numerical, and alphanumeric information and/or knowledge. LAC correlates to the already known priming transposition of letters phenomena. NLAC is a new proposition concerning the visual perceptual discrimination of serial properties particularly possessed only by open proto-bigrams terms, which is enhanced by the performance of the proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and unknowingly causes inhibitory arousal in a subject while visually perceptually discriminating, processing, and serially relationally mapping the N letters held in between the 2 edge letters forming an open proto-bigram term. The result being the maximal alphabetical data compression of the letters sequence. As a consequence of the alphabetic contiguity orthographic phenomena, the space held in between any 2 non-contiguous letters forming an open proto-bigram term in the alphabet attains a critical perceptual related nature, designated herein the ‘Collective Critical Space Perceptual Related Attribute’ (CCSPRA). The CCSPRA of the open proto-bigram term, wherein the letters sequence, which is implicitly attentionally ignored-inhibited, should be conceptualized as if existing in a virtual abstract mental kind of state. This virtual abstract mental kind of state will remain effective even if the 2 letters making up the open proto-bigram term are in orthographic contiguity (maximal alphabetical serial data compression).

When there are a number of N letters held in between the two letters forming an open proto-bigram term, and when the serial ordinal positions of these two letters are the edge letters of a letters sequence (there being no additional letters on either side of the edge letters), the alphabetic contiguity property will only pertain to the edge letters forming the open proto-bigram term. This scenario discloses the strongest manifestation of the alphabetic contiguity property, where one of the letters making up an open proto-bigram term is the head and the other letter is the tail of a letters sequence. This particular case is designated herein as Extraordinary NLAC.

“Alphabetic expansion” of an open proto-bigram term is defined as the orthographic separation of the two (alphabetical non-contiguous letters) letters by a task requiring the serial sensory motor insertion of the corresponding incomplete alphabetic sequence directly related to the collective critical space according to predefined timings. This sensory motor insertion task referred to as ‘alphabetic expansion’ explicitly reveals the particular related virtual sequential state implicitly entailed in the collective critical space of this open proto-bigram term, thereby making it sensorially perceptually concrete.

“Alphabetic letter sequence”, unless otherwise specified, is defined as one or more complete “alphabetic letter sequences” from the group comprising: Direct alphabetic set array, Inverse alphabetic set array, Direct open bigram set array, Inverse open bigram set array, Direct open proto-bigram sequence, and Inverse open proto-bigram sequence.

“Alphabetical ordinal distance” (AOD) is the difference between the ordinal positions of any two letters in an alphabetic set array. The AOD may also be a virtual alphabetical ordinal distance in between any two letters in an alphabetic array of non-repeated contiguous letters. For example, in a direct or inverse alphabetic set array, there are 25 AOD between the letter A and the letter Z, 3 AOD between the letter O and the letter R, 11 AOD between the letter B and the letter M, and 1 AOD between the letters A and B. Between any two contiguous repeated letters in an alphabetic array the AOD is equal to zero.

“Alphabetic set array” is defined as a closed serial order of letters, wherein all of the letters are predefined to be different (not repeated). Each letter member of an “alphabetic set array” has a predefined different ordinal position in the alphabetic set array. An alphabetic set array is herein considered to be a Complete Non-Randomized alphabetical letters sequence. Letter symbol members are only graphically represented with capital letters herein. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.
Inverse alphabetic set array: Z, Y, X, W, V, U, T, S, R, Q, P, O, N, M, L, K, J, I, H, G, F, E, D, C, B, A.
Direct type alphabetic set array: A, Z, B, Y, C, X, D, W, E, V, F, U, G, T, H, S, I, R, J, Q, K, P, L, O, M, N.
Inverse type alphabetic set array: Z, A, Y, B, X, C, W, D, V, E, U, F, T, G, S, H, R, I, Q, J, P, K, O, L, N, M.
Central type alphabetic set array: A, N, B, O, C, P, D, Q, E, R, F, S, G, T, H, U, I, V, J, W, K, X, L, Y, M, Z.
Inverse central type alphabetic set array: N, A, O, B, P, C, Q, D, R, E, S, F, T, G, U, H, V, I, W, J, X, K, Y, L, Z, M.

“Arrangement of terms” (symbols, letters, and/or numbers) is defined as one of two classes of “arrangements of terms”, i.e., an arrangement of terms along a line, or an arrangement of terms in a matrix form. In an “arrangement of terms along a line,” terms are arranged along a horizontal line by default. When the arrangement of terms is meant to be implemented along a vertical, diagonal, or curvilinear line, it will be indicated. In an “arrangement of terms in a matrix form,” terms are arranged along a number of parallel horizontal lines, displayed in a two dimensional format. This arrangement is the same as the letters arrangement in a standard text book format.

“Arrays” are defined as the indefinite serial order of terms. By default, the total number and kind of terms in “arrays' are undefined.

“Attribute of a term” (alphanumeric symbol, letter, or number) is defined as a spatial distinctive related perceptual feature and/or a time distinctive related perceptual feature. An attribute of a term can also be understood as a related on-line perceptual representation carried through a mental simulation that effects the off-line conception of what has been perceived. (Louise Connell, Dermot Lynott. Principles of Representation: Why You Can't Represent the Same Concept Twice. Topics in Cognitive Science (2014) 1-17)

“Collective critical space” is defined as the alphabetic space held in between any two non-contiguous ordinal positions of different letters in a direct or inverse alphabetic set array. A “collective critical space” corresponds to any two non-contiguous different letters which form an open proto-bigram term. The postulation of a “collective critical space” is herein contingent on any pair of non-contiguous different letter symbols in a direct or inverse alphabetic set array, where the sensorial perceptual discriminated orthographic form of the different letter symbols directly and automatically relates a semantic meaning to the subject.

“Collective spatial perceptual related attribute” is defined as a spatial perceptual related attribute pertaining to the relative location of a particular letter term in relation to the other letter terms in a letter set array, an alphabetic set array, or an alphabetic letter symbol sequence. “Collective spatial perceptual related attributes” may include a symbol ordinal position, the physical space occupied by a symbol font, the distance between the physical spaces occupied by the fonts of two consecutive symbols or terms sensorially perceptually discriminated in orthographical form, and the left or right relative edge position of a sensorially perceptually discriminated term or symbol font in a set array. Even if the problem solving of a letter sequence triggers a collective spatial perceptual related attribute in a fluent reasoning subject, the resulting “collective spatial perceptual related attribute” does not generate or convey a semantic meaning by the perceptual relational serial mapping of the one or more letter symbols entailing this kind of spatial perceptual related attribute. In contrast, the “collective critical space” generates and explicitly conveys a semantic meaning in a fluent reasoning subject by the pair of non-contiguous letter symbols implicitly entailing the collective critical space.

“Direct alphabetical sequence” is defined as a serial order of letters from A to Z.

“Discrimination” is the sensorial perceptual discriminating of serial orders of symbols which do not intend or involve decoding or recall-retrieval activity enabling semantic whole word pattern recognition.

“Expletive” is defined to refer to any of the following:
Expletive syntactic: a word that performs a syntactic role but contributes nothing to meaning
Expletive pronoun: a pronoun used as subject or other verb argument that is meaningless but syntactically required
Expletive attributive: a word that contributes nothing to meaning but suggests the strength of feeling of the speaker
Profanity (or swear word): a word or expression that is strongly impolite or offensive.

“Function word” is defined as a word that expresses a grammatical or structural relationship with other words in a sentence. In contrast to a content word, a function word has little or no meaningful content. Function words are also known as grammatical words. “Function words” include determiners (e.g., the or that), conjunctions (e.g., and or but), prepositions (e.g., in or of), pronouns (e.g., she or they), auxiliary verbs (e.g., be or have), modals (e.g., may or could), and quantifiers.

“Generation of terms”, “number of terms generated” (symbols, letters and/or numbers) is defined as terms generally generated by two kinds of “term generation” methods—one method wherein the number of terms is generated in a predefined quantity; and another method wherein the number of terms is generated by a quasi-random method.

It is important to note that, in the above methods of promoting fluent reasoning abilities and in the following exercises and examples implementing the methods, the subject is performing sensorial perceptual discrimination concerning the serial properties of open bigrams or open proto-bigram terms in an array or series of open bigrams and/or open proto-bigram sequences without invoking explicit awareness or accessing prior learning. Such awareness concerns underlying implicit governing rules or abstract concepts/interrelationships characterized by relations, correlations, or cross-correlations among the sensorial perceptual searched, discriminated, and sensory motor manipulated open bigrams and open proto-bigrams terms. In other words, the subject is performing the sensorial perceptual search and discrimination without overtly thinking or strategizing from past experiences or learned pattern information recalled/retrieved from long term memory storage about the necessary actions to effectively accomplish any given sensory motor manipulation of the open bigrams and open proto-bigram terms.

As suggested above, the presented exercises contemplate the use of not only letters but also numbers and alphanumeric symbols relationships. These relationships include interrelations, correlations, and cross-correlations among open bigrams and/or open proto-bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, implications-consequences, fast sensorial perceptual visual and/or aural discrimination of serial patterns and irregularities, mental conceptualizations enacting serial relational mappings involving relations, correlations, and cross-correlations among one or more sequential orders of symbols, extrapolating, transforming sequential information, and abstract relational concept thinking.

It is also important to consider that the methods described herein are not limited to only alphabetic symbols. It is contemplated that the methods involve numeric serial orders and/or alpha-numeric serial orders to be used within the exercises. In other words, while the specific examples set forth employ serial orders of letter symbols, alphabetic open bigram terms and alphabetic open proto-bigram terms, it is contemplated that serial orders comprising numbers and/or alpha-numeric symbols can be used.

The library of complete open proto-bigram sequences comprises a predefined number of set arrays (closed serial orders of terms: alphanumeric symbols/letters/numbers), which may include alphabetic set arrays. Alphabetic set arrays are characterized by a predefined number of different letter terms. Each letter term has a predefined unique ordinal position in the closed set array, and none of the different letter terms are repeated within this predefined unique serial order of letter terms. A non-limiting example of a unique set array is the English alphabet, in which there are 13 predefined different open-bigram terms. In this case, each open-bigram term has a predefined consecutive ordinal position of a unique closed serial order among 13 different members of a set array only comprising 13 open-bigram term members.

In one aspect of the present subject matter, a predefined library of complete open-bigrams sequences may comprise set arrays. A unique serial order of open-bigram terms can be obtained from the English alphabet, as one among the at least six other different unique serial orders of open-bigram terms. In particular, an alphabetic set array obtained from the English alphabet is herein denominated direct alphabetic open-bigram set array. The other five different orders of the same open-bigram terms are also unique alphabetic open-bigram set arrays. These arrays are denominated: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or may comprise more different open-bigram set arrays. In an aspect of the present methods, the at least one unique serial order comprises a sequence of open-bigram terms. In this case, the predefined library of set arrays may comprise the following set arrays of sequential orders of open-bigrams terms: direct open-bigram set array, inverse open-bigram set array, direct type open-bigram set array, inverse type open-bigram set array, central type open-bigram set array, and inverse central type open-bigram set array. Each open-bigram term is a different member of the set array having a predefined unique ordinal position within the set. It is understood that the predefined library of set arrays may contain additional or fewer set arrays sequences than those listed above.

“Grapheme” is defined herein as the smallest semantically distinguishing unit in a written language, analogous to the phonemes of spoken languages. A “grapheme” may or may not carry meaning by itself and may or may not correspond to a single phoneme. Graphemes include alphabetic letters, typographic ligatures, Chinese characters, numerical digits, punctuation marks, and other individual symbols of any of the world's writing systems. In languages that use alphabetic writing systems, graphemes stand in principle for the phonemes (significant sounds) of the language. In practice, however, the orthographies of such languages entail at least a certain amount of deviation from the ideal of exact grapheme-phoneme correspondence. A phoneme may be represented by a multigraph, a sequence of more than one grapheme. The digraph sh represents a single sound in English, however, sometimes a single grapheme may represent more than one phoneme (e.g., the Russian letter 51). Some graphemes may not represent any sound at all (e.g., the b in English debt). Often the rules of correspondence between graphemes and phonemes become complex or irregular, particularly as a result of historical sound changes that are not necessarily reflected in spelling. “Shallow” orthographies such as those of standard Spanish and Finnish have relatively regular (though not always one-to-one) correspondence between graphemes and phonemes, while those of French and English have much less regular correspondence.

“Higher-order complex relational conceptualization process” is defined as a higher order cognitive abstract thinking activity involving the parallel activation among multiple interacting relational semantic meanings at once. The multiple interacting relational semantic meanings enact a relational knowledge language mapping (lexical relational web) consisting in multiple parallel activated relational semantic meanings relationships of the following types: direct relations among semantic meanings, correlations among semantic meanings, and cross-correlations among semantic meanings. These parallel, dynamically activated, relational semantic meanings relationships mentally coexist with each other. The higher order cognitive complex relational conceptualization process enacts an abstract web of relational language knowledge interactions consisting of dynamic interacting semantic meanings relationships that simultaneously involve at least “3” distinct relational semantic meanings. This lexical relational language web is herein amplified by novel combinations among one or more spatial and/or time perceptual related attribute changes that sensorially perceptually and sensory motor ground and relate the semantic meaning of a term(s) to its orthographic and/or phonological representation(s) (letters, numbers and alphanumeric).

“Incomplete serial order” refers, only in relation, to a serial order of terms which has been previously defined as “complete”.

“Individual spatial perceptual related attribute” is defined as a “spatial perceptual related attribute” that pertains to a particular term. Individual spatial perceptual related attributes may include, symbol case; symbol size; symbol font; symbol boldness; symbol tilted angle relative to a horizontal line; symbol vertical line of symmetry; symbol horizontal line of symmetry; symbol vertical and horizontal lines of symmetry; symbol infinite lines of symmetry; symbol no line of symmetry; and symbol reflection (minor) symmetry.

“Inverse alphabetical sequence” is a serial order of letters from Z to A.

“Left visual field” is the visual field comprising the display surface located on the left side intersecting the sagittal plane of a subject viewing that which is being displayed.

“Letter set arrays” are closed serial orders of letters, wherein same letters may be repeated.

“Letter symbol” is defined as a sensorial perceptual graphical representation of a sign or a sensorial perceptual aural discrimination triggering arousal which enables the depiction of one or more specific phonological uttered sounds related to the spoken (uttered) letter symbol in a language. In the same language, different sensorial perceptual graphical discriminated signs depict a particular same letter symbol like letter symbol “a” and “A”.

“Letter term” is defined as a mental abstract conceptualization of a sensorial perceptual discriminated graphical sign or a sensorial perceptual aural phonological discrimination of same. Generally, a letter term is characterized as not representing a concrete thing, item, form, or shape in the physical world. Different alphabetical languages may use the same sensorial perceptual discriminated graphical sign(s) or the same sensorial perceptual aural phonological discriminated sounds to sensorially perceptually represent a particular “letter term” (like letter term “s”).

“Metaphor” (see also conceptual metaphor below) is defined as a figure of speech that identifies one thing as being the same as an unrelated other thing. Metaphors strongly imply the similarities between the two things. A metaphor is a figure of speech that implies comparison between two unlike entities, as distinguished from simile, an explicit comparison signaled by the words “like” or “as.” The distinction is not simple. The “metaphor” makes a qualitative leap from a reasonable, perhaps prosaic comparison, to an identification or fusion of two objects, to make one new entity partaking of the characteristics of both. Many critics regard the making of metaphors as a system of thought antedating or bypassing logic, A metaphor is thus considered more rhetorically powerful than a simile. A simile compares two items, whereas a metaphor directly equates them, without applying any words of comparison, such as “like” or “as.” Metaphor is a type of analogy closely related to other rhetorical figures of speech that achieve their effects via association, comparison, or resemblance including allegory, hyperbole, and simile. One of the most prominent examples of a metaphor in English literature is:
“All the world's a stage”
And all the men and women merely players;
They have their exits and their entrances;
William Shakespeare, As You Like It

This quotation contains a metaphor because the world is not literally a stage. By figuratively asserting that the world is a stage, Shakespeare uses the points of comparison between the world and a stage to convey an understanding about the mechanics of the world and the lives of the people within it. The Philosophy of Rhetoric (1937) by I. A. Richards describes a metaphor as having two parts, the tenor and the vehicle. The tenor is the subject (topic-target) to which attributes are ascribed. The vehicle is the object whose attributes are borrowed. In the previous example, “the world” is compared to a stage, describing it with the attributes of “the stage”. “The world” is the tenor (target), and “a stage” is the vehicle. “Men and women” is the secondary tenor and “players” is the secondary vehicle. Other writers employ the general terms ground and figure to denote the tenor and the vehicle. In cognitive linguistics, the conceptual domain from which metaphorical expressions are drawn to understand another conceptual domain is known as the source domain. The conceptual domain understood in this way is the target domain. Thus, the source domain of the sharks (e.g., aggressive non-merciful) is commonly used to explain the target domain of the lawyers.

“Conceptual Metaphors” are defined as being part of the basic-common conceptual apparatus shared by members of a culture. They are systematic in that there is a fixed correspondence between the structure of the domain to be understood (e.g., death) and the structure of the domain in terms of what is understood (e.g., departure). Conceptual metaphors are usually understood in terms of common experiences. They are largely unconscious though attention may be drawn to them. Their operation in cognition is almost automatic. They are widely conventionalized in language. There are a great number of words and idiomatic expressions in our language whose meanings depend upon those conceptual metaphors” (George Lakoff and Mark Turner, More Than Cool Reason. Univ. of Chicago Press, 1989). In Metaphors We Live By, Lakoff and Johnson mention the following variations on the conceptual metaphor:
Time is Money
You're wasting my time.
This gadget will save you hours.
I don't have the time to give you.
How do you spend your time these days?
That flat tire cost me an hour.
I've invested a lot of time in her.
You're running out of time.
Is that worth your while?
He's living on borrowed time.

Conceptual Metaphor theory rejects the notion that metaphor is a decorative device, peripheral to language and thought. Instead, the theory holds that metaphor is central to thought, and therefore to language. From this starting point, a number of tenets, with particular reference to language, are derived. These tenets are:
Metaphors structure thinking;
Metaphors structure knowledge;
Metaphor is central to abstract language;
Metaphor is grounded in physical experience; and
Metaphor is ideological.

(Alice Deignan, Metaphor and Corpus Linguistics. John Benjamins, 2005).

“Morpheme” is defined as a category representing the smallest unit of grammar. The field of study dedicated to “morphemes” is called morphology. A morpheme is not identical to a word. The principal difference between the two is that a morpheme may or may not stand alone, whereas a word, by definition, is freestanding. When a morpheme stands by itself, it is considered a root because it has a meaning of its own (e.g. the morpheme cat). When a morpheme depends on another morpheme to express an idea, it is considered an affix because it has a grammatical function (e.g., the -s in cats to specify that it is plural). Every word comprises one or more morphemes. The more combinations a morpheme is found in, the more productive it is said to be. Morphemes function as the foundation of language and syntax, the arrangement of words and sentences to create meaning, A morpheme is a meaningful linguistic unit consisting of a word (such as dog) or a word element (such as the -s at the end of dogs) that cannot be divided into smaller meaningful parts. Adjective: morphemic. Morphemes can be divided into two general classes: free morphemes can stand alone as words of a language; and bound morphemes, which must be attached to other morphemes. Free morphemes can be further subdivided into content words and function words. Content words carry most of the content of a sentence whereas function words generally perform some kind of grammatical role, carrying little meaning of their own.

“Non-alphabetic letter sequence” is any letter series that does not follow the sequence and/or ordinal positions of letters in any of the alphabetic set arrays.

“Open bigram” is defined as a closed serial order formed by any two contiguous or non-contiguous letters of the above alphabetic set arrays, unless specified otherwise. Under the provisions set forth above, an “open bigram” may also refer to pairs of numerical or alphanumerical symbols.

For alphabetic set arrays where the members are defined as open bigrams, the following 3 direct and 3 inverse alphabetic open bigrams set arrays are herein defined:
Direct alphabetic open bigram set array: AB, CD, EF, GH, U, KL, MN, OP, QR, ST, UV, WX, YZ.
Inverse alphabetic open bigram set array: ZY, XW, VU, TS, RQ, PO, NM, LK, JI, HG, FE, DC, BA.
Direct alphabetic type open bigram set array: AZ, BY, CX, DW, EV, FU, GT, HS, IR, JQ, KP, LO, MN.
Inverse alphabetic type open bigram set array: ZA, YB, XC, WD, VE, UF, TG, SH, RI, QJ, PK, OL, NM.
Central alphabetic type open bigram set array: AN, BO, CP, DQ, ER, FS, GT, HU, IV, JW, KX, LY, MZ.
Inverse alphabetic central type open bigram set array: NA, OB, PC, QD, RE, SF, TG, UH, VI, WJ, XK, YL, ZM.

“Open bigram term” is a lexical orthographic unit characterized by a pair of letters (n-gram) depicting a minimal sequential order consisting of two letters. The open bigram class to which an “open bigram term” belongs may or may not convey an automatic direct access to semantic meaning in an alphabetic language to a reader.

“Open bigram term sequence” is herein defined as a letters symbol sequence, where two letter symbols are presented as letter pairs representing a term in the sequence instead of an individual letter symbol representing a term in the sequence.

There are 4 classes of open bigram terms, there being a total of 676 different open bigram terms in the English alphabetical language.

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms, wherein 2 open bigram terms are also open bigram terms members of Class I.

Class III—Within the context of the present subject matter, Class III entails the vast majority of open bigram terms in the English alphabetical language, except for all open bigram terms members of Classes I, II, and IV. Specifically, Class III comprises a total of 550 open bigram terms.

Class IV—Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

“Open proto-bigram sequence type” is a complete alphabetic “open proto-bigram sequence” characterized by the pairs of letters comprising each open proto-bigram term in a way that the serial distribution of such open proto-bigram terms establishes a sequence of open proto-bigram terms type that follows a direct or an inverse alphabetic set array order. There are two complete alphabetic open proto-bigram sequence types.

### Types of Open Proto-Bigram Sequences:

Direct type open proto-bigram sequence: AM, AN, AS, AT, BE, BY, DO, GO, IN, IS, IT, MY, NO, OR
Inverse type open proto-bigram sequence: WE, US, UP, TO, SO, ON, OF, ME, IF, HE.
“Complete alphabetic open proto-bigram sequence groups” within the context of the present subject matter, Class I open-proto bigram terms, are further grouped in three sequence groups:

Open Proto-Bigram Sequence Groups:
Left Group: AM, BE, HE, IF, ME
Central Group: AN, AS, AT, BY, DO, GO, IN, IS, IT, MY, OF, WE
Right Group: NO, ON, OR, SO, TO, UP, US

“Ordinal position” is defined as the numerical order corresponding to the relative location of a term in the closed series of any of the six alphabetic set arrays or any of the six alphabetic open-bigram set arrays of the predefined libraries of complete alphabetic serial orders. The first term of any set array will have a numerical “ordinal position” of #1, and each of the following terms in the alphabetic sequence will have the “ordinal positions” of the following integer numbers (#2, #3, #4, . . . ). Therefore, in relation to the 26 different letters of the direct alphabetic set array of the English language (see above), ordinal position #1 will relate to the letter “A”, and ordinal position #26 will relate to the letter “Z”. In relation to a predefined alphabetic set array, the ordinal position of a particular letter term or a particular open-bigram term will always be conserved as an intrinsic relational serial order property of the particular letter term or particular open-bigram term.

“Orthographic letters contiguity” is the contiguity of letters symbols in a written form by which words are represented in most written alphabetical languages.

“Orthographic letter patterns” are defined as the different one or more kinds of serial orders that can be present in a letter sequence. Serial orders of letters may define different orthographic patterns of: relational open proto-bigrams (ROPB); vowels; consonants; the first and/or last letters of a sequence being a vowel or a consonant; direct or inverse alphabetic serial order of each consecutive pair of letters in a sequence; alphabetic ordinal distance between a pair of consecutive or non-consecutive letters; and for a closed sequence, the total number of letters, vowels, and/or consonants.

“Orthographical topological expansion” of a symbol letter or number is defined as the outcome of introducing graphical changes directed to extend the periphery of the orthographical representation of a symbol letter or number. An “orthographical topological expansion (extension) of a symbol” is achieved by means of adding distinctive points and/or short line segments to the perimeter of its graphical display. An orthographical topological expansion of a symbol aims to enhance a subject's sensorial perception readiness to discriminate the orthographically topological expanded (extended) symbol letter or number faster as a stand-alone orthographic representation or when standing among other orthographic representations.

“Particle” is a word that does not change its form through inflection (morphemes that signal the grammatical variants of a word). Inflection is a process of word formation in which items are added to the base form of a word to express grammatical meanings. Inflections in English include the genitive—'s; the plural -s (e.g., at the end of “ideas”); the third-person singular -s (e.g., she makes but I make and they make); the past tense -d, -ed, or -t; the negative particle -'nt; the gerund forms of verbs -ing; the comparative -er; and the superlative -est. Inflections do not easily fit into the established system of parts of speech. Many word “particles” are closely linked to verbs to form multi-word verbs, such as go away. Other word particles include “to”, used with an infinitive and “not” (a negative particle). Particles are short words, which with just one or two exceptions, are all prepositions unaccompanied by any complement of their own. Some of the most common prepositions belong to the particle category “along, away, back, by, down, forward, in, off, on, out, over, round, under, and up.”

“Phoneme” is defined as a basic unit of a language's phonology, which is combined with other “phonemes” to form meaningful units, such as words or morphemes. The phoneme can be described as “the smallest contrastive linguistic unit which may bring about a change of meaning”. The difference in meaning between the English words kill and kiss is a result of the exchange of the phoneme /l/ for the phoneme /s/. Two words that differ in meaning through a contrast of a single phoneme form a minimal pair. Within linguistics there are differing views as to exactly what phonemes are and how a given language should be analyzed in phonemic (or phonematic) terms. However, a phoneme is generally regarded as an abstraction of a set (or equivalence class) of speech sounds (phones), which are perceived as equivalent to each other in a given language. In English, for example, the “k” sounds in the words kit and skill are not identical, but they are distributional variants of a single phoneme /k/. Different speech sounds that are realizations of the same phoneme are known as allophones. Allophonic variation may be conditioned, in which case a certain phoneme is realized as a certain allophone in particular phonological environments. Alternatively, the phoneme may be free, in which case it may vary randomly. Phonemes are often considered to constitute an abstract underlying representation for segments of words, while speech sounds make up the corresponding phonetic realization, or surface form. While phonemes are normally conceived of as abstractions of discrete segmental speech sounds (vowels and consonants), there are other features of pronunciation, principally tone and stress., In some languages, tone and stress can change the meaning of words in the way that phoneme contrasts do and are consequently called phonemic features of those languages. Still, phonemic stress is encountered in languages such as English. For example, the word invite, which is stressed on the second syllable is a verb, but when it is stressed on the first syllable (without changing any of the individual sounds) it becomes a noun. The position of the stress in the word affects the meaning. Therefore, a full phonemic specification, providing enough detail to enable the word to be pronounced unambiguously, would include indication of the position of the stress: /In'vaIt/ for the verb, /'InvaIt/ for the noun.

“Polysemy” (from Greek: πoλυ-, poly-, “many” and σ\tilde{η}μα, sêma, “sign”) is defined as the capacity for a sign(s) (e.g., a word, phrase, etc.) to have multiple related meanings (sememes). It is usually regarded as distinct from homonymy, in which the multiple meanings of a word may be unconnected or unrelated. Charles Fillmore and Beryl Atkins' definition stipulates three elements: (i) the various senses of a polysemous word have a central origin; (ii) the links between these senses form a network; and (iii) understanding the ‘inner’ one contributes to understanding of the ‘outer’ one. Accordingly, polyseme is a word or phrase with different but related senses. Since the test for polysemy is the vague concept of relatedness, judgments of polysemy can be difficult to make. Since applying pre-existing words to new situations is a natural process of language change, looking at the etymology of words is helpful in determining polysemy, but it is not the only solution. As words become lost in etymology, what once was a useful distinction of meaning may no longer be so. Some apparently unrelated words share a common historical origin, so etymology is not an infallible test for polysemy. Dictionary writers also often defer to speakers' intuitions to judge polysemy in cases where it contradicts etymology. English has many words which are polysemous. For example, the verb “to get” can mean “procure” (e.g., I'll get the drinks), “become” (e.g, she got scared), “understand” (e.g, I get it), etc. In vertical polysemy, a word refers to a member of a subcategory (e.g., ‘dog’ for ‘male dog’). A closely related idea is a figure of speech named a metonym, in which one word or phrase with one original meaning is substituted for another with which it is closely connected or associated (e.g., “crown” for “royalty”). There are several tests for polysemy. One in particular is zeugma. If one word seems to exhibit zeugma when applied in different contexts, it is likely that the contexts bring out different polysemes of the same word. If the two senses of the same word do not seem to fit, yet seem related, then it is likely that they are polysemous. The fact that this test depends on speakers' judgments about relatedness means that this test for polysemy is not infallible, but is merely a helpful conceptual aid. The difference between homonyms and polysemes is subtle. Lexicographers define polysemes within a single dictionary lemma, numbering different meanings, while homonyms are treated in separate lemmata. Semantic shift can separate a polysemous word into separate homonyms. For example, “check” as in “bank check”, “check” in chess, and “check” meaning “verification” are considered homonyms because they originated as a single word derived from chess in the 14th century. Psycholinguistic experiments have shown that homonyms and polysemes are represented differently within people's mental lexicon. While the different meanings of homonyms, which are semantically unrelated, tend to interfere or compete with each other during comprehension, this does not usually occur for the polysemes that have semantically related meanings. Results for this contention, however, have been mixed.

“Prepositions” (or more generally adpositions) are a class of words expressing spatial or temporal relations (e.g., in, under, towards, before) or mark various syntactic and semantic roles (e.g., of, for). Their primary function is relational. A “preposition” word typically combines with another constituent (called its complement) to form a prepositional phrase relating the complement to the context. The word preposition (from Latin: prae, before and ponere, to put) refers to the situation in Latin and Greek, where prepositions are placed before their complement and hence pre-positioned. English is another language employing them in this way. Similarly, circumpositions consist of two parts that appear on each side of the complement. The technical term used to refer collectively to prepositions, postpositions, and circumpositions is adpositions. Some linguists use the word “preposition” instead of “adposition” for all three cases. Some examples of English prepositions (marked in bold) as used in phrases are:
as an adjunct (locative, temporal, etc.) to a {noun} (marked within braces)
   the {weather} in May
   {cheese} from France with live bacteria
as an adjunct (locative, temporal, etc.) to a {verb}
   {sleep} throughout the winter
   {danced} atop the tables for hours
as an adjunct (locative, temporal, etc.) to an {adjective}
   {happy} for them
   {sick} until recently

The following properties are characteristic of most adpositional systems.
Adpositions are among the most frequently occurring words in languages that have them. For example, one frequency ranking for English word forms begins as follows (adpositions underlined): the, of, and, to, a, in, that, it, is, was, I, for, on, you, . . .
The most common adpositions are single, monomorphemic words. According to the ranking cited above, the most common English prepositions are the following: on, in, to, by, for, with, at, of, from, up, but . . .
Adpositions form a closed class of lexical items and cannot be productively derived from words of other categories.

Semantic classification—Adpositions can be used to express a wide range of semantic relations between their complement and the rest of the context. The following list is not an exhaustive classification:
spatial relations: location (inclusion, exclusion, proximity) and direction (origin, path, endpoint)
temporal relations
comparison relations: equality, opposition, price, rate
content relations: source, material, subject matter
agent
instrument, means, manner
cause, purpose; and
reference.

Most common adpositions are highly polysemous, and much research is devoted to the description and explanation of the various interconnected meanings of particular adpositions. In many cases a primary, spatial meaning can be identified, which is then extended to non-spatial uses by metaphorical or other processes.

Classification by grammatical function—Particular uses of adpositions can be classified according to the function of the adpositional phrase in the sentence.
Modification
   adverb-like
   The athlete ran {across the goal line}.
   adjective-like
   attributively
   A road trip {with children} is not the most relaxing vacation.
   in the predicate position
   The key is {under the plastic rock}.
Syntactic functions
   complement
   Let's dispense with the formalities

Here, the words dispense and with complement one another, functioning as a unit to mean forego. They also share the direct object [the formalities]. The verb dispense would not have this meaning without the word with to complement it).
{In the cellar} was chosen as the best place to hide the bodies.

Adpositional languages typically single out a particular adposition for the following special functions:
marking possession
marking the agent in the passive construction; and
marking the beneficiary role in transfer relations.

“Pseudowords” are alphabetic arrays which have no semantic meaning, but are pronounceable because they conform to the orthography of the language. In contrast, non-words are not pronounceable and have no semantic meaning.

“Relational correlation(s)” is defined as a reasoning activity that involves inferring a positive or negative relational relationship(s). On one hand, relational correlations can encapsulate and conceptually expose a deep implicit order-pattern structure taking place between temporal events, spatial things, and/or numerical quantity values and alphabetic arrays depicting the same, similar, or different semantic meanings in a language via the formulation of one or more rule based algorithms. On the other hand, relational correlations may intrinsically resist inference of a causal relational direct alignment between these temporal events, spatial objects, numerical quantity values and/or alphabetic arrays.

“Relational direct relation” is defined as a reasoning activity that involves identifying an explicit and straightforward causal relational-link order (alignment) between interacting temporal events, spatial things, and/or numerical quantity values and alphabetic arrays depicting the same, similar, or different semantic meanings in a language.

“Relational open proto-bigram (ROPB)” is an open proto-bigram of class I contained in an alphabetic array, which retains its intrinsic identity even for the case where the two letters forming the open proto-bigram are separated by up to two other letters. An ROPB may also occur for the case where the two letters forming an open proto-bigram are the first and last letters of alphabetic arrays, which are words or a letter sequence from an alphabetic set array, regardless of the length of the sequence in between the first and last letters.

In a provided alphabetic array representing a word, embedded ROPBs that are not sensorially perceptually graphically represented (or sensorially perceptually visually missing) in the sensorially perceptually discriminated alphabetic array are considered to be orthographically absent. In other words, the two letters forming the ROPB are omitted from the sensorial perceptual graphical representation of the alphabetic array provided to the subject. Orthographically absent ROPBs may be part of a carrier word or carrier non-word. In either case, the two letters forming the ROPB are separated by no more than two other letters of the carrier word.

“Relative incompleteness” is used in association with any previously selected alphabetical serial order, which for the sake of the intended task to be performed by a subject, should be considered to be a complete alphabetical serial order.

“Right visual field” is the visual field comprising the display surface located on the right side intersecting the sagittal plane of a subject viewing that which is being displayed.

“ROPB type I words” are defined as ROPB words formed by a vowel letter serially followed by a consonant (VC) letter. A “ROPB type I” word is of a group comprising 13 different ROPB's words members: AM, AN, AS, AT, IF, IN, IS, IT, OF, ON, OR, UP, US. ROPB type I words stand in addition to the following predefined ROPB type's word groups: Direct Type, Inverse Type, Left Group Type, Central Group Type, and Right Group Type.

“ROPB Type II words” are defined herein as ROPB words formed by a consonant letter serially followed by a vowel (CV) letter. A “ROPB Type II” word is of a group comprising the following 11 different ROPB's words members: BE, BY, DO, GO, HE, ME, MY, NO, SO, TO, WE. ROPB type II words stand in addition to the following predefined ROPB type's word groups: Direct Type, Inverse Type, Left Group Type, Central Group Type, and Right Group Type.

“Selected separable affix” is defined as “selected separable affix” letters which are part of a direct or an inverse alphabetical sequence.

“Serial order” is defined as a sequence of terms characterized by a number of serial constraints including: (a) the relative ordinal spatial position of each term and the relative ordinal spatial positions of those terms following and/or preceding it; (b) the nature of a serial order sequential structure: i) an “indefinite serial order” is defined herein as a “serial order” of terms where neither the first nor the last term are predefined; ii) an “open serial order” is defined herein as a “serial order” where only the first term is predefined; iii) a “closed serial order” is defined herein as a “serial order” where only the first and last terms are predefined; and (c) its number of terms members are predefined exclusively by “a closed serial order”.

“Serial terms” are defined as the individual symbol components of a symbols series.

“Series” is defined as an orderly sequence of terms.

“Set arrays” are defined as closed serial orders of terms, wherein each term is intrinsically a different member of the set and where the kinds of terms, if not specified in advance, are undefined. If the total number of terms is not predefined by the method(s) herein, then the total number of terms is undefined by default.

“Spatial perceptual related attribute” is defined as characterizing a “spatial related perceptual feature” of a term, which can be attended and discriminated by sensorial perception. There are two kinds of spatial related perceptual attributes.

“Stem” is defined as part of a word in linguistics. However, the term “stem” is used with slightly different meanings. In one usage, a stem is a form to which affixes can be attached, In this usage, the English word friendships contains the stem friend, to which the derivational suffix -ship is attached to form a new stem friendship, to which the inflectional suffix -s is attached. In a variant of this usage, the root of the word (in the example, friend) is not counted as a stem. In a slightly different usage, a word has a single stem, namely the part of the word that is common to all its inflected variants. In this usage, all derivational affixes are part of the stem. For example, the stem of friendships is friendship, to which the inflection suffix -s is attached. Stems may be root, e.g., run, or they may be morphologically complex, as in compound words (cf. the compound nouns meat ball or bottle opener) or words with derivational morphemes (cf. the derived verbs black-en or standard-ize). Thus, the stem of the complex English noun photographer is photo•graph•er but not photo. In another example, the root of the English verb form destabilized is stabil-, a form of stable the does not occur alone. The stem is de•stabi•ize, which includes the derivational affixes de- and -ize, but not the inflectional past tense suffix -(e)d. A stem is that part of a word that inflectional affixes attach to.

“Syllable” (from the Greek συλλαβ\acute{η}, syn=‘co, together’+labe=‘grasp’, thus meaning a handful [of letters]) is defined as a unit of organization for a sequence of speech sounds. A syllable is unit of spoken language, above a speech sound, and consisting of one or more vowel sounds, a syllabic consonant, or either with one or more consonant sounds preceding or following. For example, the word water is composed of two syllables: wa and ter. A syllable is typically made up of a syllable nucleus (most often a vowel) with optional initial and final margins (typically consonants). Syllables are often considered the phonological “building blocks” of words. They can influence the rhythm of a language, its prosody, its poetic meter, and its stress patterns. A word that consists of a single syllable (like English dog) is called a monosyllable and is monosyllabic. Similar terms include disyllable (disyllabic) for a word of two syllables; trisyllable (trisyllabic) for a word of three syllables; and polysyllable (polysyllabic), which may refer either to a word of more than three syllables or to any word of more than one syllable. The earliest recorded syllables are on tablets written around 2800 BC in the Sumerian city of Ur. This shift from pictograms to syllables has been called “the most important advance in the history of writing”.

“Symbol” is defined herein as the name label given in a language to a mental abstract conceptualization of a sensorial perceptual discrimination of a graphical sign or representation which includes letters and numbers.

“Terminal points” are defined as the one or more end points of the symbol lines by which the perimeter is graphically represented in the orthographic morphological representation of a symbol letter or number.

“Terms” are represented by one or more symbols or letters, numbers, or alphanumeric symbols.

“Terms arrays” are defined as open serial orders of terms. By default, the total number and kind of terms members in an open serial order of terms is undefined.

“Time perceptual related attribute” is defined as characterizing a temporal related perceptual feature of a term (symbol, letter, or number), which can be attended and discriminated by sensorial perception, such as a) any color of the RGB full color range of the symbols term; b) frequency range for the intermittent display of a symbol, a letter, or a number from a very low frequency rate, up to a high frequency (flickering) rate; frequency is quantified as 1/t, where t is in the order of seconds of time; c) particular sound frequencies through which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is considered to take place along a horizontal axis in a spatial direction to be predefined. If the visual perception of constant motion is implemented on a computer screen, the value of V to be assigned is given in pixels per second at a predefined screen resolution.

“Vertice” is defined as the one or more intersection points of any two lines of a symbol perimeter, in the morphological graphical representation of a symbol letter or number, where the two intersecting lines originate from different directions in the morphologic space representing the symbol letter or number.

“Virtual sequential state” is defined as an implicit incomplete alphabetic sequence assembled by the letters corresponding to the ordinal positions entailed in a “collective critical space”. There is at least one implicit incomplete alphabetic sequence entailed per each open proto-bigram term.

These implicit incomplete alphabetic sequences are herein conceptualized to exist in a virtual-like perceptual-cognitive mental state of the subject. Every time this virtual-like perceptual-cognitive mental state is grounded in the subject by means of a programmed goal oriented sensory-motor activity, the subject's reasoning and related mental higher order cognitive relational ability is enhanced.

Based on the above definitions, a letters sequence, which at least entails two non-contiguous letters assembling an open proto-bigram term, will be entitled to possess a “collective critical spatial perceptual related attribute” as a direct consequence of the implicit perceptual condition of the at least one incomplete alphabetic sequence arising from the “virtual sequential state” corresponding with the open proto-bigram term.

This virtual-like (implicit) serial state actualizes and becomes concrete every time a subject is required to reason and perform a goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing an “alphabetical compression” of a selected letters sequence or by performing an “alphabetical expansion” of a selected letters sequence in accordance with the definitions of the terms given below.

Moreover, for a general form of these definitions, the “collective critical space”, “virtual sequential state”, and “collective critical spatial perceptual related attribute” for a predefined Complete Numerical Set Array and a predefined Complete Alphanumeric Set Array, for alphabetic series can also be extended to include numerical and alphanumerical series.

### Example 1

### Sensorial Perceptual Search and Discrimination of One or More Similarities Between the Serial Order of Letters in a Non-Word Name Labels Group Represented by a Predefined Relational Non-Word Name Label and One or More Word Name Labels from a Group of Words

A goal of the exercises presented in Example 1 is to exercise elemental fluid intelligence ability. Particularly, the exercises of Example 1 intentionally promote fluid reasoning to quickly enact an abstract conceptual mental web where a number of relational direct, inverse, and incomplete alphabetic arrays interact, correlate, and cross-correlate with each other such that the processing and manipulation of these arrays is maximized in short-term memory. Importantly, the alphabetic arrays utilized herein are purposefully selected and arranged with the intention of bypassing long-term memory processing and storage in a subject. The selected alphabetic arrays do not require the subject to use cognitive resources, e.g. retrieval-recall of prior semantic knowledge, to solve the present exercises. Rather, the present exercises minimize or eliminate the subject's need to access prior semantic knowledge by focusing on the seriality of the alphabetic arrays, even when the presented alphabetic arrays convey a semantic meaning.

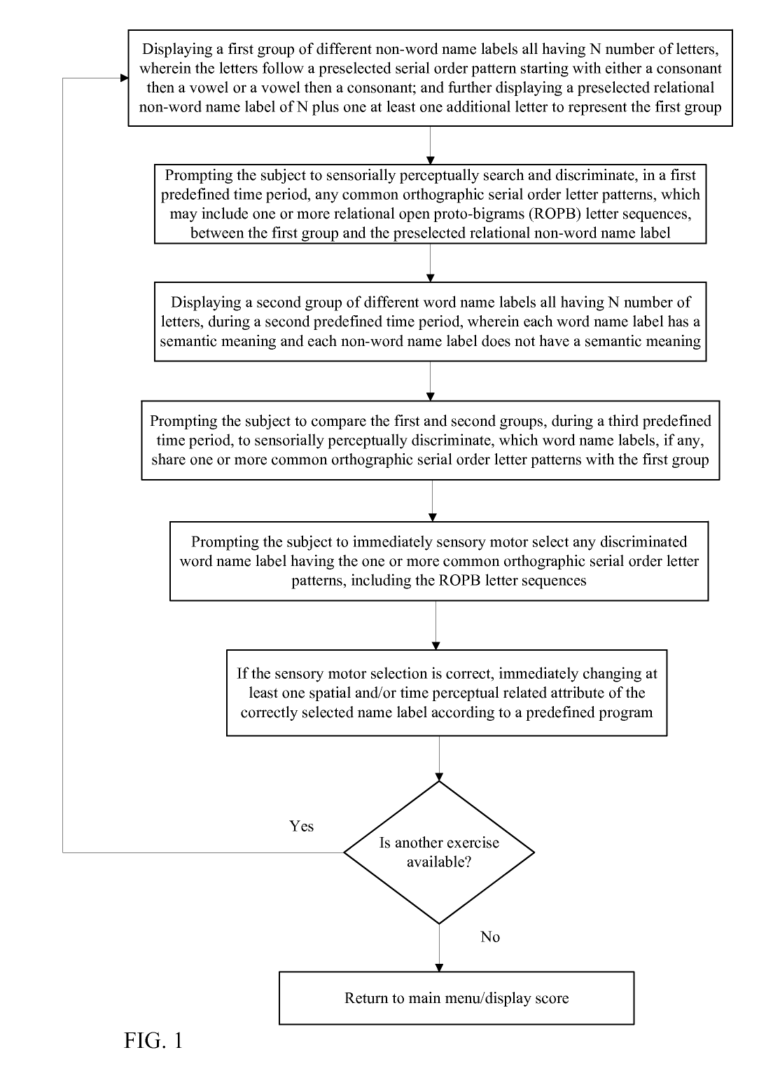

FIG. 1 is a flow chart setting forth the method that the present exercises use in promoting fluid intelligence abilities in a subject by sensorially perceptually searching and discriminating one or more similarities between the serial order of letters in non-word name label groups, belonging to a relational category represented by a preselected relational non-word name label, and one or more word name labels from a group of words. As can be seen in FIG. 1, the method of promoting fluid intelligence abilities in a subject comprises displaying a first group of different non-word name labels all having N number of letters, wherein the first two letters of each name label follow a preselected serial order pattern which starts with either a consonant letter followed by a vowel letter or a vowel letter followed by a consonant letter, and further displaying a preselected relational non-word name label of N plus at least one additional letter to represent the first group of name labels, where the at least one additional letter is different from the N number of letters of the first group.

Initially, all of the displayed name labels have the same spatial and time perceptual related attributes. The subject is then prompted, during a first predefined time period, to sensorially perceptually search and discriminate any common orthographic serial order letter patterns between the first group and the preselected relational non-word name label. The subject is also simultaneously prompted to sensorially perceptually search and discriminate any relational open proto-bigrams (ROPB) present in the first group.

After the first predefined time period, a second group of different word name labels all having N number of letters is displayed during a second predefined time period. Each word name label has a semantic meaning that is either different or similar to the semantic meanings of the other words in the second group. Additionally, the non-word name labels do not carry a semantic meaning. The subject is then prompted to compare the first and second groups in order to sensorially perceptually search and discriminate, which second group name labels, if any, share one or more common orthographic serial order letter patterns with the first group, during a third predefined time period.

At the end of the third predefined time period, the subject is prompted to immediately sensory motor select any discriminated word name label having the one or more common orthographic serial order letter patterns, which may further include one or more ROPB letter sequences. For each word name label selection, the subject is required to perform a sensory motor activity corresponding to the selection. If the sensory motor selection made by the subject is a correct selection, then at least one spatial and/or time perceptual related attribute of the correctly selected word name label is immediately changed according to a predefined program.

The above steps in the method are repeated for a predetermined number of iterations separated by one or more predefined time intervals. Upon completion of the predetermined number of iterations for each sensorial perceptual search and discrimination exercise, the subject is provided with a score. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 1, the method of promoting fluid intelligence abilities in a subject is implemented through a computer program product. In particular, the subject matter in Example 1 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a first group of different non-word name labels all having N number of letters, wherein the first two letters of each name label follow a preselected serial order pattern starting with either a consonant letter followed by a vowel letter or a vowel letter followed by a consonant letter, and further displaying a preselected relational non-word name label of N plus at least one additional letter to represent the first group of name labels, where the at least one additional letter is different from the N number of letters of the first group.

Initially, all of the displayed name labels have the same spatial and time perceptual related attributes. The subject is then prompted, during a first predefined time period, to sensorially perceptually search and discriminate any common orthographic serial order letter patterns between the first group and the preselected relational non-word name label. The subject is also simultaneously prompted to sensorially perceptually search and discriminate any relational open proto-bigrams (ROPB) present in the first group of name labels.

After the first predefined time period, a second group of different word name labels all having N number of letters is displayed during a second predefined time period. Each word name label has a semantic meaning that is either different or similar to the semantic meanings of the other words in the second group. Additionally, the non-word name label do not carry a semantic meaning. The subject is then prompted to compare the first and the second groups in order to sensorially perceptually search and discriminate, which second group word name labels, if any, share one or more common orthographic serial order letter patterns with the first group, during a third predefined time period.

At the end of the third predefined time period, the subject is prompted to immediately sensory motor select any discriminated word name label having the one or more common orthographic serial order letter patterns, which may further include at least one ROPB letter sequence. For each word name label selection, the subject is required to perform a sensory motor activity corresponding to the selection. If the sensory motor selection made by the subject is a correct selection, then at least one spatial and/or time perceptual related attribute of the correctly selected word name label is immediately changed according to a predefined program. The above steps in the method are repeated for a predetermined number of iterations separated by one or more predefined time intervals. Upon completion of the predetermined number of iterations for each sensorial perceptual search and discrimination exercise, the subject is provided with a score.

In a further aspect of Example 1, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a first group of different non-word name labels all having N number of letters on the GUI, wherein the first two letters of each name label follow a preselected serial order pattern starting with either a consonant letter followed by a vowel letter or a vowel letter followed by a consonant letter, and further displaying a preselected relational non-word name label of N plus at least one additional letter to represent the first group of name labels on the GUI, where the at least one additional letter is different from the N number of letter of the first group.

Initially, all of the displayed name labels have the same spatial and time perceptual related attributes. The subject is then prompted on the GUI, during a first predefined time period, to sensorially perceptually search and discriminate any common orthographic serial order letter patterns between the first group and the preselected relational non-word name label. The subject is also simultaneously prompted to sensorially perceptually search and discriminate any relational open proto-bigrams (ROPB) present in the first group.

After the first predefined time period, a second group of different word name labels all having N number of letters is displayed during a second predefined time period on the GUI. Each word name label has a semantic meaning that is either different or similar to the semantic meanings of the other words in the second group. Additionally, the non-word name labels do not carry a semantic meaning. The subject is then prompted on the GUI to compare the first and the second groups in order to sensorially perceptually search and discriminate, which second group name labels, if any, share one or more common orthographic serial order letter patterns with the first group, during a third predefined time period.

At the end of the third predefined time period, the subject is prompted on the GUI to immediately sensory motor select any discriminated word name label having the one or more common orthographic serial order letter patterns, which may further include one or more ROPB letter sequences. For each word name label selection, the subject is required to perform a sensory motor activity corresponding to the selection. If the sensory motor selection made by the subject is a correct selection, then at least one spatial and/or time perceptual related attribute of the correctly selected word name label is immediately changed on the GUI according to a predefined program. The above steps in the method are repeated for a predetermined number of iterations separated by one or more predefined time intervals. Upon completion of the predetermined number of iterations for each sensorial perceptual search and discrimination exercise, the subject is provided with a score on the GUI.

In a preferred embodiment, Example 1 includes two block exercises, each having at least two sequential trial exercises. In each trial exercise, a number of first group of different non-word name labels having N number of letters which follow a preselected serial order pattern (e.g., vowel-consonant letters or consonant-vowel letters) are presented to the subject. The subject is also presented with a preselected relational non-word name label that is similar to the first group. During a first predefined time period, the subject is required to sensorially perceptually search the first group to discriminate any orthographic serial order letter patterns that are common to the first group and the preselected relational non-word name label. The subject is also required to sensorially perceptually search and discriminate, which first group non-word name labels, if any, contain at least one relational open proto-bigrams (ROPB) therein.

A second group of different word name labels, each having a different semantic meaning, is then displayed during a second predefined time period. Thereafter, the subject is required to compare the first and second groups to sensorially perceptually search and discriminate, which second group name labels, if any, share one or more common orthographic serial order letter patterns with the first group, during a third predefined time period. Importantly, the present trial exercises have been designed to reduce cognitive workload by minimizing the dependency of the subject's reasoning and derived inferring skills on real-time manipulation of lexical information by the subject's working memory. Accordingly, the preselected relational non-word name label is purposefully presented as a non-word in each trial exercise. Further the preselected relational non-word name label serves as a sensorial perceptual relational symbolic cue for the subject to reason without the use of learned, stored and processing of lexical associations, by quickly extracting the correct related serial order letter patterns shared with the first group of non-word name labels.

The subject is given a limited time frame within which the subject must validly sensory motor perform the exercises. In this example, the subject is required to correctly sensory motor select the second group word name label(s) which share the discriminated common orthographic serial order letter patterns, including any shared ROPB letter sequences. If the subject does not sensory motor perform a given exercise within the second predefined time interval, also referred to as “a valid performance time period”, then after a delay, which could be of about 2 seconds, the next iteration for the subject to perform is automatically displayed. Importantly, the subject is not provided with any performance feedback for any failed trial exercise. In one embodiment, the second predefined time interval or maximal valid performance time period for lack of sensory motor response is from 10-20 seconds, preferably 15-20 seconds, and more preferably 17 seconds. In another embodiment, the second predefined time interval is at least 30 seconds.

In providing the exercises in Example 1, the first group of different non-word name labels may be displayed in a predefined number of rows arranged from left to right. It is also contemplated that the second group of different word name labels may be displayed in a similar predefined number of rows arranged from left to right. In another aspect of Example 1, the first and second group name labels and a predefined list of ROPBs may be displayed together in a predefined configuration.

In one aspect of the exercises of Example 1, the preselected relational non-word name label representative of the first group may be either a non-word or a pseudoword. The preselected relational non-word name label also may or may not contain at least one embedded relational open proto-bigram (ROPB). In one preferred embodiment of the exercises, the first and/or the last letter of the preselected relational non-word name label is a preselected vowel letter or consonant letter.

In another aspect of the exercises of Example 1, the consonant letters of the preselected relational non-word name label are all different from any of the consonant letters displayed in the first group of non-word name labels.

In another aspect of the exercises of Example 1, the number of name labels displayed per group is not particularly limited. In one preferred embodiment, the first and second groups each have between 3 and 7 name labels. The N number of letters of each name label is also not particularly limited. In one preferred embodiment, the N number of letters is from 3 to 5 letters for each name label.

In a further aspect of the present exercises, the subject will be provided a certain amount of time to sensory motor perform each step of the method. In one embodiment, the first predefined time period, during which the subject must sensorially perceptually search and discriminate common orthographic serial order letter patterns and/or embedded ROPBs in the first group, may comprise any time interval between 5 and 15 seconds for each non-word name label displayed in the first group. Likewise, the second group may then be displayed during a second predefined time period for any time interval between 5 and 15 seconds for each word name label displayed in the second group. The third predefined time period, during which the subject is prompted to compare the first and second groups in order to sensorially perceptually search and discriminate common orthographic serial order letter patterns, may comprise any time interval between 5 and 15 seconds for each word name label displayed in the second group. It is further contemplated that the first, second, and/or third predefined time periods may be adjusted according to a predefined performance criteria.

In another aspect of the exercises of Example 1, the common orthographic serial order letter patterns between the first and second group name labels are selected from one or more of a) the same embedded ROPBs in a portion of or all of the displayed name labels; b) the same serial order of vowel letters or consonant letters in a portion of or all of the displayed name labels; c) the first and/or last letters of the displayed name labels are either all consonant letters or all vowel letters; d) the first, second, and/or third consecutive pairs of letters in the displayed name labels all have either a direct or inverse alphabetical order; and e) the same alphabetical ordinal distance between pairs of letters in the displayed name labels for some or all of the pairs of letters.

In a further aspect of the exercises of Example 1, the display location of a selected name label impacts the change(s) in spatial and/or time perceptual related attribute(s). For example, a correctly selected word name label located in the right visual field of the subject may have a different spatial and/or time perceptual related attribute change than a correctly selected word name label located in the left visual field of the subject. In another example, the changed spatial and/or time perceptual related attributes of the two letter forming a discriminated ROPB embedded in a correctly selected name label are different that the changed spatial and/or time perceptual related attributes of the other letters in the correctly selected name label.

As discussed above, upon sensory motor selection of a correct word name label by the subject, the correctly selected name label is immediately displayed with a changed spatial and/or time perceptual related attribute that is different from the displayed first and second groups and the preselected relational non-word name label. An embedded ROPB in the correctly selected name label may be further changed to be different from the correctly selected name label. The changed spatial or time perceptual related attributes of the two symbols forming an embedded ROPB in a correctly selected name label may include, without being limited to, the following: symbol color, symbol sound, symbol size, symbol font style, symbol spacing, symbol case, boldness of symbol, angle of symbol rotation, symbol mirroring, or combinations thereof. Furthermore, the selected symbols of an embedded ROPB may be displayed with a time related perceptual attribute “flickering” behavior in order to further highlight the differences in perceptual related attributes thereby facilitating the subject's sensorial perceptual discrimination of the differences.

In one embodiment of the exercises of Example 1, the changed spatial and/or time perceptual related attributes may be affected based on whether the correctly selected word name label is a carrier word name label. For the case when the correctly selected word name label is a carrier word, any embedded ROPB therein, that is also a sub-word, may be further highlighted in the correctly selected carrier word name label by at least one additional changed spatial and/or time perceptual related attributes. Additionally, for the case where a correctly selected carrier word name label has more than one sub-word ROPB embedded therein, each ROPB may be further highlighted in the carrier word name label by having at least one different spatial and/or time perceptual related attribute that is also different from the other embedded ROPB.

As previously indicated above with respect to the general methods for implementing the present subject matter, the exercises in Example 1 are useful in promoting fluid intelligence abilities in the subject through the sensorial motor and perceptual domains that jointly engage when the subject performs the given exercise. That is, the serial manipulating or discriminating of relational open proto-bigrams by the subject engages body movements to execute selecting the next ROPB, and combinations thereof. The motor activity engaged within the subject may be any motor activity jointly involved in the sensorial perception of the complete and incomplete alphabetic arrays. While any body movements can be considered motor activity implemented by the subject's body, the present subject matter is mainly concerned with implemented body movements selected from body movements of the subject's eyes, head, neck, arms, hands, fingers, and combinations thereof.

In a preferred embodiment, the sensory motor activity the subject is required to perform is selected from the group including: mouse-clicking on the name label, voicing each of the name label letters in a sequential manner, touching one or more letters of the name label in a sequential manner with a finger or stick, or combinations thereof. Additionally, the sensory motor activity may be performed at one or more preselected locations of the displayed name label.

By requesting that the subject engage in specific degrees of body motor activity, the exercises of Example 1 require the subject to bodily-ground cognitive fluid intelligence abilities. The exercises of Example 1 cause the subject to revisit an early developmental realm wherein the subject implicitly acted and/or experienced a fast and efficient enactment of fluid cognitive abilities when specifically dealing with serial pattern sensorial perceptual search and discrimination of non-concrete symbol terms and/or symbols terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 1 downplay or mitigate, as much as possible, the subject's need to recall/retrieve and use semantic or episodic knowledge from memory storage in order to support or assist inductive reasoning strategies to problem solve the exercises.

The exercises of Example 1 mainly concern promoting fluid intelligence, in general, and do not rise to the cognitive operational level of promoting crystalized intelligence via explicit associative learning and/or word recognition strategies facilitated by retrieval of declarative semantic knowledge from long term memory. Accordingly, the first group of non-word name labels, the preselected relational non-word name label, and the second group of word name labels are intentionally selected and the respective symbol terms therein are purposefully serially arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 1, the predefined library, which supplies the name labels for each exercise, comprises words, non-words, and pseudowords any of which may or may not contain relational open proto-bigrams.

In an aspect of the present subject matter, the exercises of Example 1 include providing a preselected relational non-word name label to the subject when providing the subject with the first group of name labels. The perceptual visual presence of the preselected relational non-word name label helps the subject to relate the higher order cognitive reasoning and abstract conceptualization thinking process (e.g., steps and strategy) used to problem solve an exercise to the grounding sensory motor performance of the same. By prompting the subject to sensorially perceptually search and discriminate serial order letter pattern(s), the exercises of Example 1 promote fluent reasoning to infer and successfully relationally extract the common serial order letter pattern(s) by matching one or more similarities between groups of non-word and word name labels or between groups of pseusowords and word name labels.

The methods implemented by the exercises of Example 1 also contemplate situations in which the subject fails to sensory motor perform the given task. The following failure to perform criteria is applicable to any exercise of the present task in which the subject fails to sensory motor perform. Specifically, there are two kinds of “failure to perform” criteria. The first kind of “failure to perform” criteria occurs in the event the subject fails to perform by not click-selecting. In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise without receiving any performance feedback. In some embodiments, this valid performance time period is 17 seconds.

The second “failure to perform” criteria occurs in the event where the subject fails to make a correct word name label selection for three consecutive attempts. As an operational rule applicable for any failed trial exercise in Example 1, failure to perform results in the automatic display of the next trial exercise to be performed from the predefined number of iterations. Importantly, the subject is not provided with any performance feedback during any failed trial exercise.

In the event the subject fails to correctly sensorially perceptually search, discriminate, and sensory motor select a correct word name label in excess of 2 non-consecutive trial exercises (a single block exercise), then one of the following two options will occur: 1) if the failure to perform occurs for more than 2 non-consecutive trial exercises, then the subject's current block-exercise performance is immediately halted. After a time interval of about 2 seconds, the next trial exercise to be performed from the predetermined number of iterations will immediately be displayed and the subject is not provided with any performance feedback; or 2) when there are no other further trial exercises left to be performed, the subject will be immediately exited from the exercise and returned back to the main menu of the computer program without receiving any performance feedback.

The total duration of the time to complete the exercises of Example 1, as well as the time it took to implement each of the individual trial exercises, are registered in order to help generate an individual and age-gender group performance score. Records of all of the subject's incorrect word name label selections from each trial exercise are generated and may be displayed. In general, the subject will perform this task about 6 times during the based brain mental fitness training program.

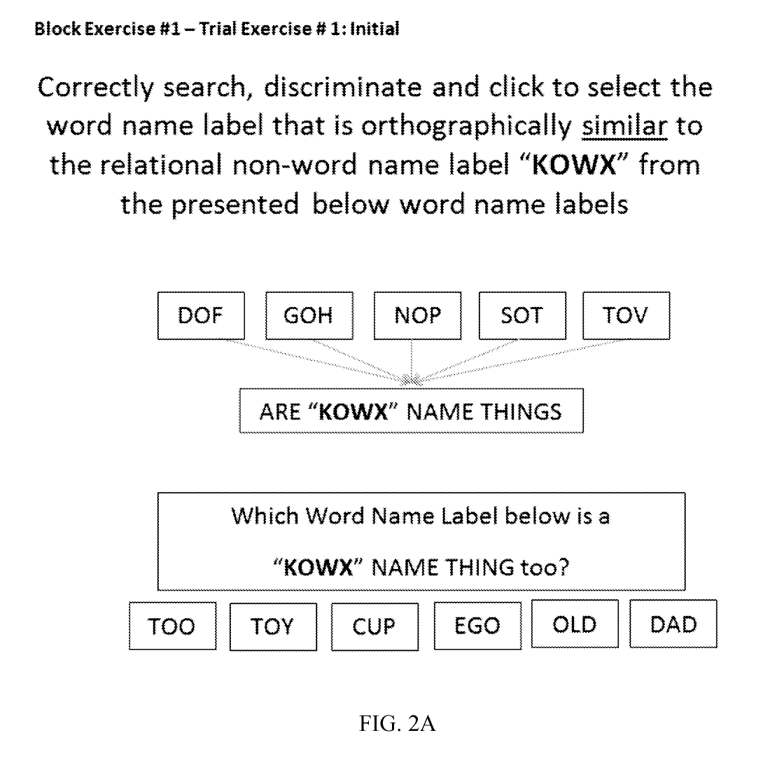

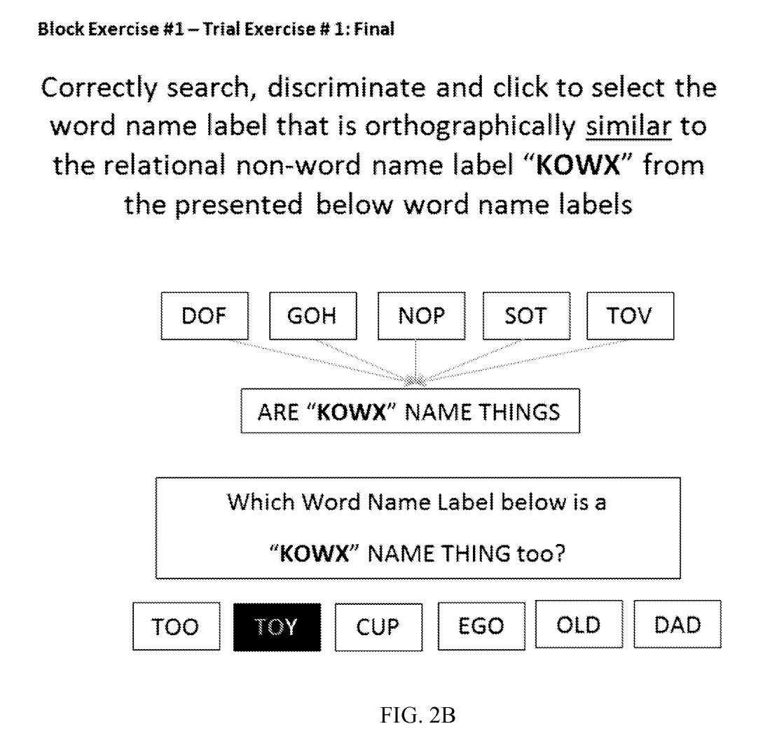

FIGS. 2A and 2B depict a number of non-limiting examples of the block 1 exercises for sensorially perceptually searching and discriminating one or more similarities between the serial order of letters in non-word name labels and at least one word name label from a group of words. FIG. 2A shows the first group of non-word name labels including DOF, GOH, NOP, SOT, and TOV and the preselected relational non-word name label KOWX, which represents the first group. As discussed herein, during the first predefined time period, the subject will be required to scan the first group to sensorially perceptually search and discriminate any relational open proto-bigrams (ROPB) contained therein as well as any orthographic serial order letter pattern(s) common to the first group and the preselected relational non-word name label. Notably, the first letter of each non-word name label follows an incomplete direct alphabetic serial order from left to right. Further, the first consecutive pair of letters in each non-word name label forms an ROPB that carries a semantic meaning.

A second group of word name labels is displayed underneath the first group non-word name labels and the preselected relational non-word name label. As shown in FIG. 2A, the second group includes the word name labels TOO, TOY, CUP, EGO, OLD, and DAD. The subject is then prompted to compare the first and second group name labels in order to sensorially perceptually discriminate which second group name labels, if any, share one or more common orthographic serial order letter pattern with the first group.

FIG. 2B shows the correctly sensory motor selected word name label TOY, which is also a carrier word. It is important to note that even though TOO, which is another carrier word, shares some common orthographic serial order letter patterns with the first group, the word name label TOY is the correct answer. In this example, TOY is the correct answer because the third letter in the serial order letter pattern is a consonant letter, which is the same serial order letter pattern as the first group. In contrast, the third letter of the serial order letter pattern of the word name label TOO is a vowel. Once sensory motor selected, the correct carrier word name label TOY is immediately highlighted by changing at least one spatial and/or time perceptual related attribute thereof. In this example, TOY is displayed with a white font over a black background. Additionally, the embedded ROPB ‘TO’, which is also a sub-word, is further highlighted in the carrier word ‘TOY’ by the changed time perceptual related attribute of font color from default to blue.

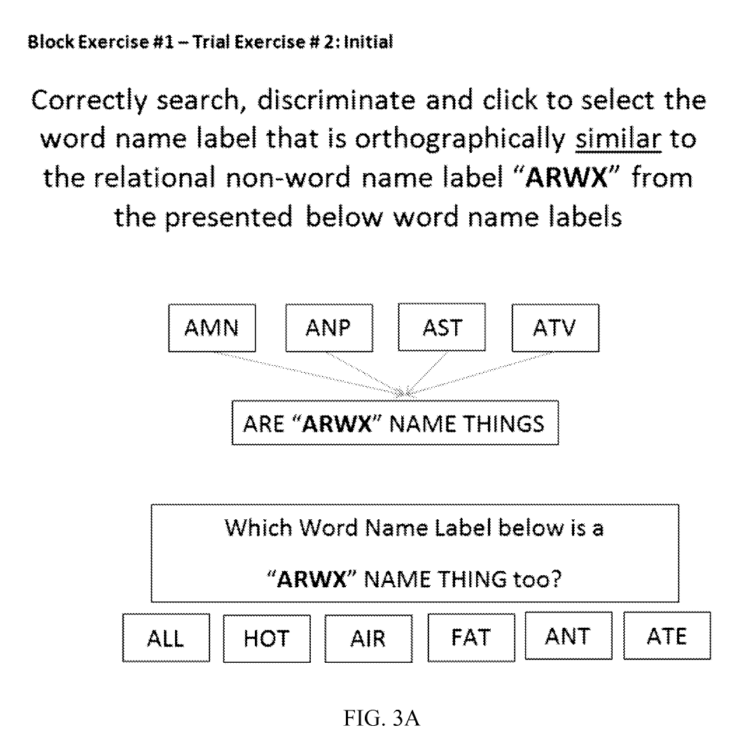

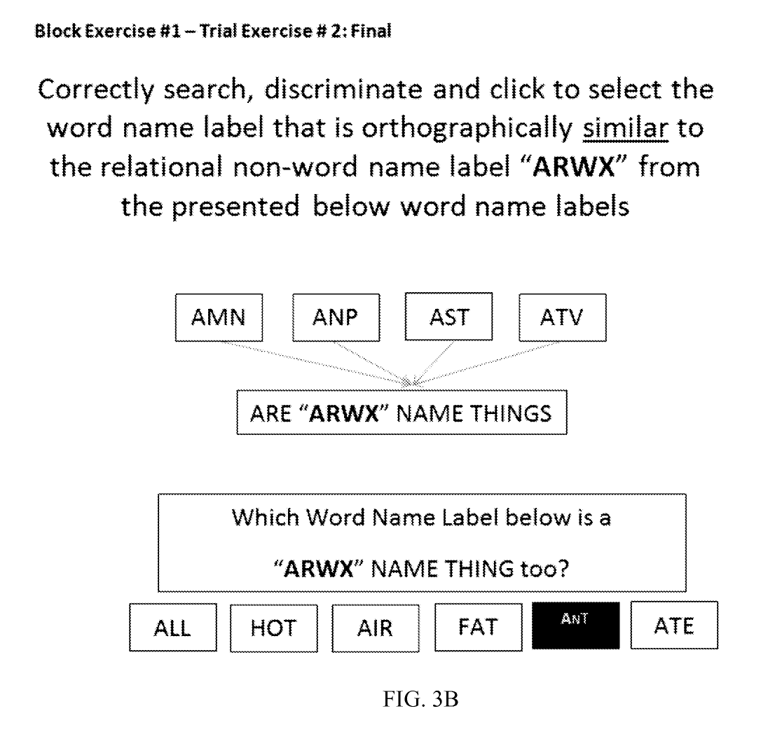

FIGS. 3A and 3B depict another non-limiting example of the block 1 exercises for sensorially perceptually searching and discriminating one or more similarities between the serial order of letters in non-word name labels and at least one word name label from a group of words. FIG. 3A shows the first group of non-word name labels including AMN, ANP, AST, and ATV and the preselected relational non-word name label ARWX, which represents the first group. The subject is required to scan the first group to sensorially perceptually search and discriminate any relational open proto-bigrams (ROPB) contained therein as well as any orthographic serial order letter pattern(s) common to the first group and the preselected relational non-word name label. Notably, the first letter of each non-word name label begins with the same vowel ‘A’. Further, the second and third letters in each non-word name label follow the serial order letter pattern of non-repeated consonants.

A second group of word name labels is displayed underneath the first group and the preselected relational non-word name label. As shown in FIG. 3A, the second group includes the word name labels ALL, HOT, AIR, FAT, ANT, and ATE. The subject is then prompted to compare the first and second group name labels in order to sensorially perceptually discriminate which second group name labels, if any, share one or more common orthographic serial order letter patterns with the first group.

FIG. 3B shows the correctly selected word name label ANT, which is also a carrier word. In this example, ANT is the correct answer because it shares the most common serial order letter patterns with the first group. More specifically, the serial order letter pattern of ANT starts with ‘A’ and is followed by two non-repeated consonants. Once sensory motor selected, the correct carrier word name label ANT is immediately highlighted by changing at least one spatial and/or time perceptual related attribute thereof. In this example, ANT is displayed with a yellow font over a black background and has the changed spatial perceptual related attribute of font size. The embedded ROPB ‘AN’, which is also a sub-word, is further highlighted in the carrier word ‘ANT’ by the changed spatial perceptual related attribute of font boldness. Similarly, the embedded ROPB ‘AT’, which is another sub-word, is further highlighted in the carrier word ‘ANT’ by the changed spatial perceptual related attribute of font size. In this exercise, each embedded ROPB in the carrier word ‘ANT’ is depicted with a different spatial perceptual related attribute than the other ROPB to illustrate the differences between the two embedded sub-words to the subject. As previously discussed above, the differences between the two embedded sub-word ROPBs may also be highlighted by different time perceptual related attributes changes.

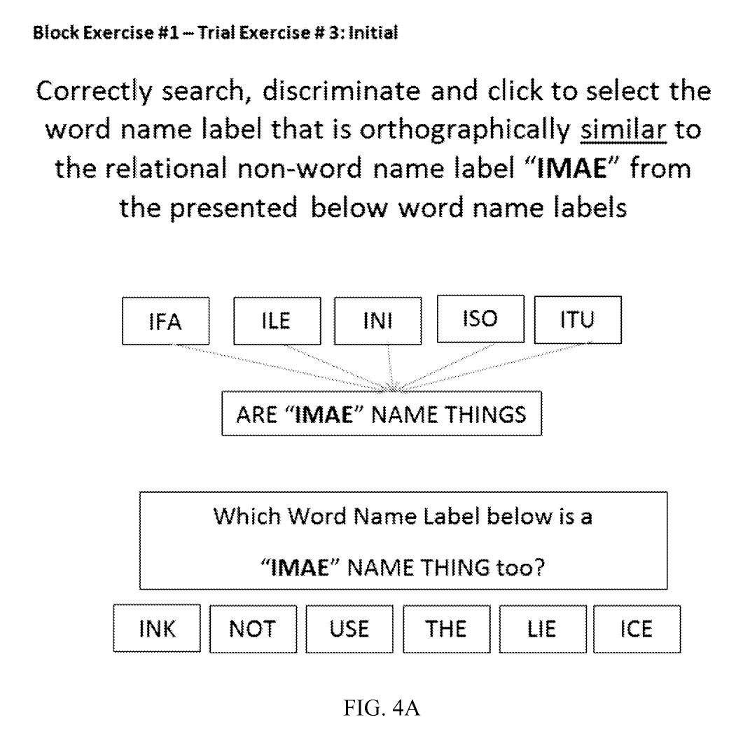

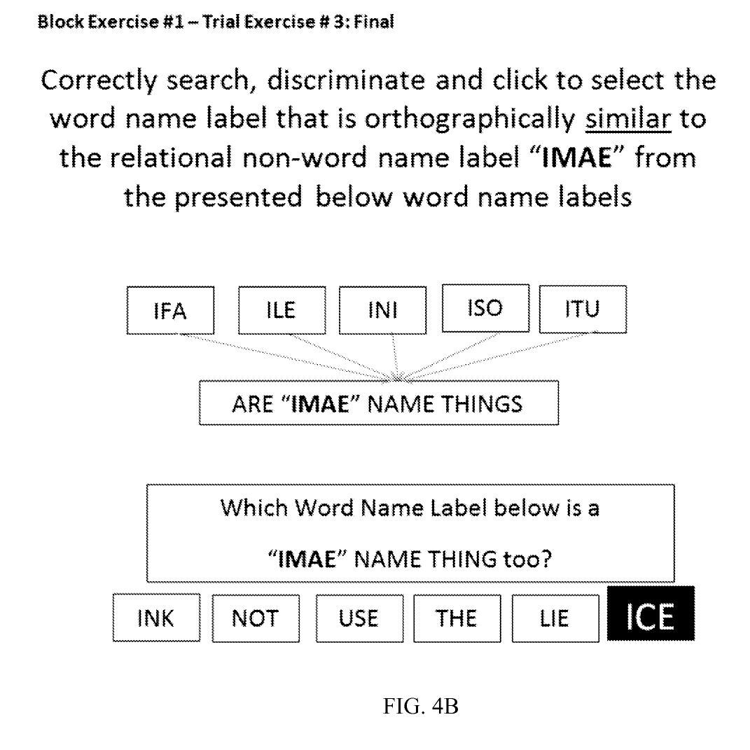

FIGS. 4A and 4B depict another non-limiting example of the block 1 exercises for sensorially perceptually searching and discriminating one or more similarities between the serial order of letters in non-word name labels and at least one word name label from a group of words. FIG. 4A shows the first group of non-word name labels including IFA, ILE, INI, ISO and ITU and the preselected relational non-word name label IMAE, which represents the first group. The subject is required to scan the first group to sensorially perceptually search and discriminate any relational open proto-bigrams (ROPB) contained therein as well as any orthographic serial order letter pattern(s) common to the first group and the preselected relational non-word name label. Notably, the first letter of each non-word name label begins with the same vowel ‘I’. Further, the second and third letters in each non-word name label follow the serial order letter pattern of consonant and vowel, respectively.

A second group of word name labels is displayed underneath the first group and the preselected relational non-word name label. As shown in FIG. 4A, the second group includes the word name labels INK, NOT, USE, THE, LIE, and ICE. The subject is then prompted to compare the first and second group name labels in order to sensorially perceptually discriminate which second group name labels, if any, share one or more common orthographic serial order letter patterns with the first group.

FIG. 4B shows the correctly selected word name label ICE. In this example, ICE is the correct answer because its serial order letter pattern, from left to right, starts with ‘I’ which is followed by a consonant letter and then another vowel letter. Once sensory motor selected, the correct word name label ICE is immediately highlighted by changing at least one spatial and/or time perceptual related attribute thereof. In this example, ICE is displayed with a white font over a black background and is further highlighted by the changed spatial perceptual related attribute of font size.

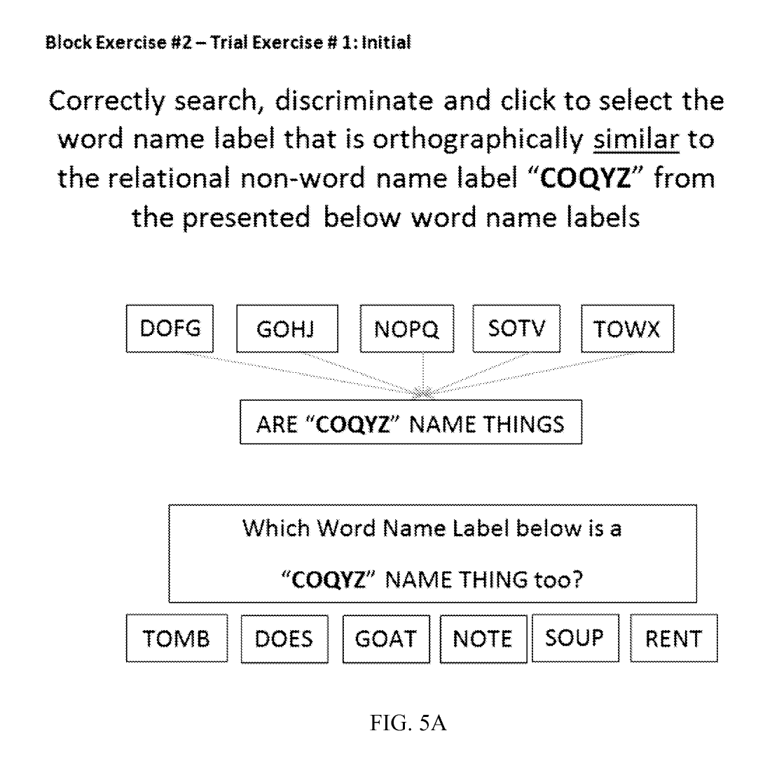

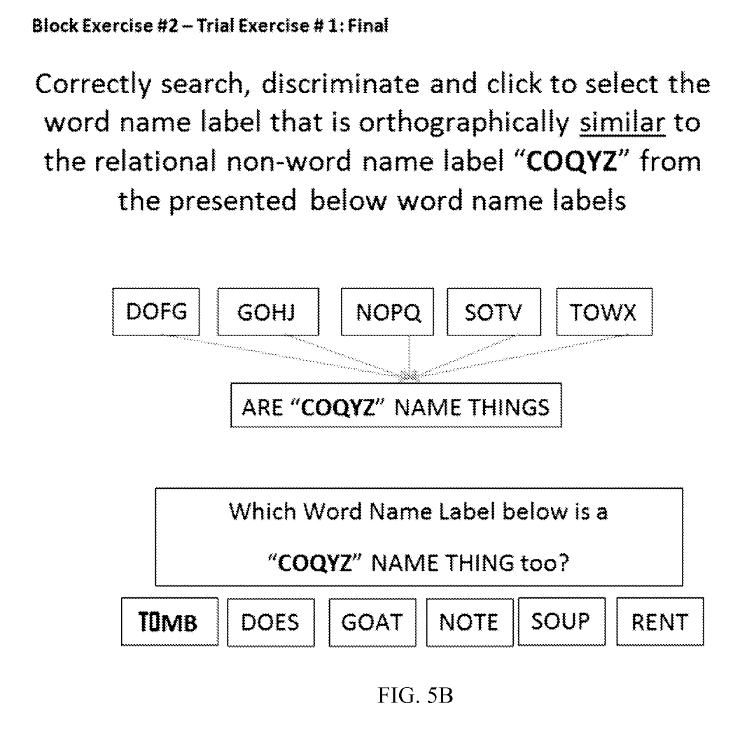

FIGS. 5A and 5B depict a number of non-limiting examples of the block 2 exercises for sensorially perceptually searching and discriminating one or more similarities between the serial order of letters in non-word name labels and at least one word name label from a group of words. FIG. 5A shows the first group of non-word name labels including DOFG, GOHJ, NOPQ, SOTV, and TOWX and the preselected relational non-word name label COQYX, which represents the first group. As discussed herein, during the first predefined time period, the subject will be required to scan the first group to sensorially perceptually search and discriminate any relational open proto-bigrams (ROPB) contained therein as well as any orthographic serial order letter pattern(s) common to the first group and the preselected relational non-word name label. Notably, the first letter of each non-word name label follows an incomplete direct alphabetic serial order from left to right. Further, the first consecutive pair of letters in each non-word name label forms an ROPB that carries a semantic meaning.

A second group of word name labels is displayed underneath the first group and the preselected relational non-word name label. As shown in FIG. 5A, the second group includes the word name labels TOMB, DOES, GOAT, NOTE, SOUP, and RENT. The subject is then prompted to compare the first and second group name labels in order to sensorially perceptually discriminate which second group name labels, if any, share one or more common orthographic serial order letter patterns with the first group.

FIG. 5B shows the correctly selected word name label TOMB, which is also a carrier word. It is noted that even though RENT shares some common orthographic serial order letter patterns with the first group, TOMB is the correct answer. In this exercise, TOMB is the correct answer because the first consecutive pair of letters in the serial order letter pattern of TOMB form an ROPB which carries a semantic meaning, which is also the case in the first group. In contrast, the first consecutive pair of letters of the serial order letter pattern of RENT does not form an ROPB. Once sensory motor selected, the correct carrier word name label TOMB is immediately highlighted by changing at least one spatial and/or time perceptual related attribute thereof. In this example, TOMB is highlighted by the changed spatial perceptual related attribute of font boldness. Additionally, the embedded ROPB ‘TO’, which is also a sub-word, is further highlighted in the carrier word ‘TOMB’ by the changed spatial perceptual related attribute of font type.

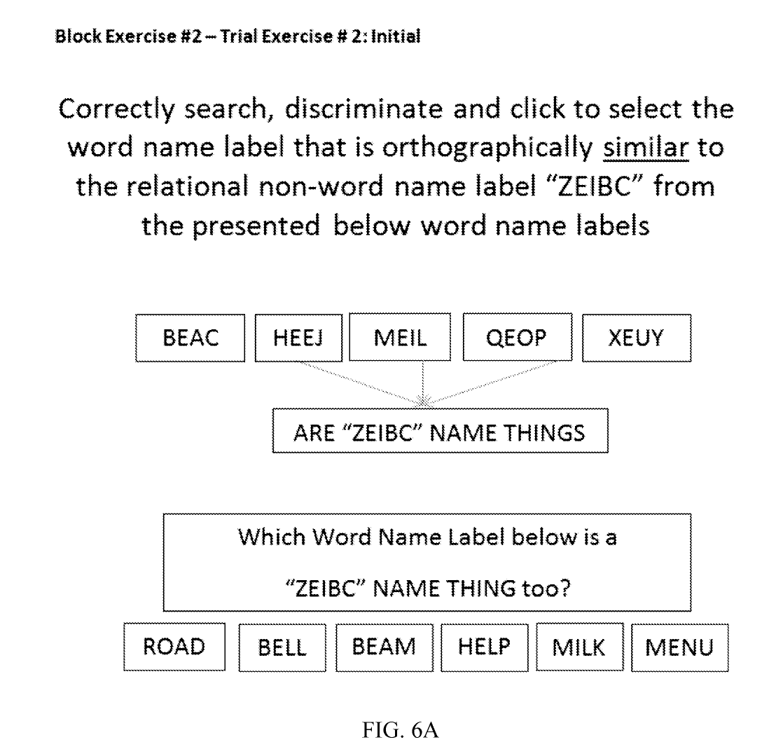

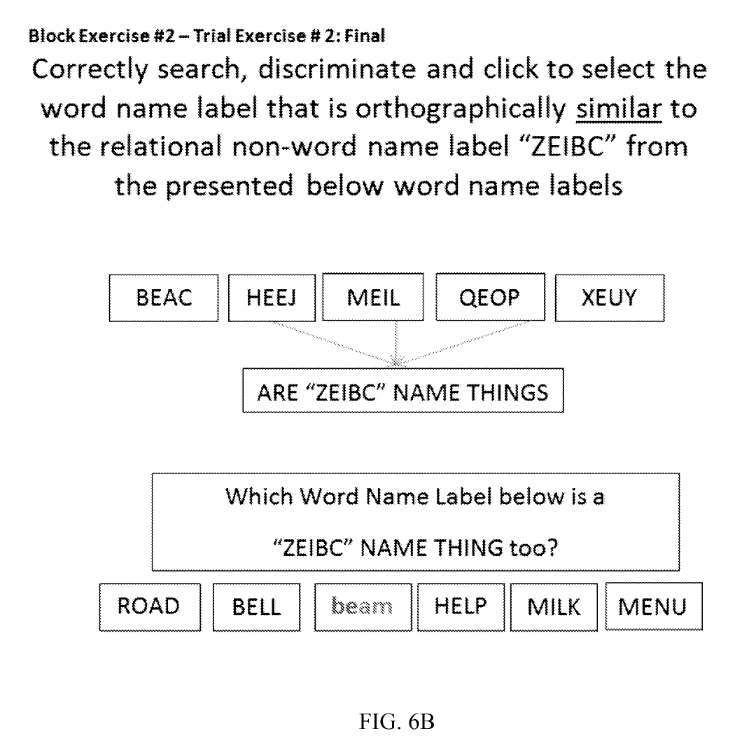

FIGS. 6A and 6B depict another example of the block 2 exercises for sensorially perceptually searching and discriminating one or more similarities between the serial order of letters in non-word name labels and at least one word name label from a group of words. FIG. 6A shows the first group of non-word name labels including BEAC, HEEJ, MEIL, QEOP, and XEUY and the preselected relational non-word name label ZEIBC, which represents the first group. As discussed herein, during the first predefined time period, the subject will be required to scan the first group to sensorially perceptually search and discriminate any relational open proto-bigrams (ROPB) contained therein as well as any orthographic serial order letter pattern(s) common to the first group and the preselected relational non-word name label. In this exercise, the first letter of each non-word name label follows an incomplete direct alphabetic serial order from left to right. Likewise, the last letter of each non-word name label also follows an incomplete direct alphabetic serial order from left to right. Further, the second letter in each non-word name label is an ‘E’ and the third letter in each non-word name label is vowel letter.

A second group of word name labels is displayed underneath the first group and the preselected relational non-word name label. As shown in FIG. 6A, the second group includes the word name labels ROAD, BELL, BEAM, HELP, MILK, and MENU. The subject is then prompted to compare the first and second group name labels in order to sensorially perceptually discriminate which second group name labels, if any, share one or more common orthographic serial order letter patterns with the first group.

FIG. 6B shows the correctly selected word name label BEAM, which is also a carrier word. BEAM is the correct answer because it is the only word name label that has a serial order letter pattern with an ‘E’ as the second letter and a third letter that is a vowel. Once sensory motor selected, the correct carrier word name label BEAM is immediately highlighted by changing at least one spatial and/or time perceptual related attribute thereof. In this example, BEAM is highlighted by the changed spatial perceptual related attribute of font letter case. Additionally, the embedded ROPBs ‘BE’ and ‘AM’, which are also both sub-words, are further highlighted in the carrier word ‘BEAM’ by the changed time perceptual related attribute of font color from default to red and from default to blue, respectively.

What is claimed:

1. A method to promote fluid intelligence abilities in a subject comprising:
a) displaying a first group of different non-word name labels all having N number of letters, wherein the letters follow a preselected serial order pattern starting with either a consonant letter followed by a vowel letter or a vowel letter followed by a consonant letter; and further displaying a preselected relational non-word name label of N plus at least one additional letter to represent the first group;
b) prompting the subject to sensorially perceptually search and discriminate, in a first predefined time period, any common orthographic serial order letter patterns, which may include one or more relational open proto-bigrams (ROPB) letter sequences, between the first group and the preselected relational non-word name label;
c) displaying a second group of different word name labels all having the same N number of letters, during a second predefined time period, wherein each word name label has a semantic meaning and each non-word name label does not have a semantic meaning;
d) prompting the subject to compare the first and second groups, during a third predefined time period, to sensorially perceptually discriminate, which word name labels, if any, share one or more common orthographic serial order letter patterns with the first group;
e) prompting the subject to immediately sensory motor select any discriminated word name label having the one or more common orthographic serial order letter patterns, including the ROPB letter sequences of step b);
f) if the sensory motor selection made by the subject is a correct selection, then immediately changing at least one spatial and/or time perceptual related attribute of the correctly selected word name label according to a predefined program;
g) repeating the above steps for a predefined number of iterations; and
h) providing the subject with a score at the end of the predefined number of iterations.

2. The method of claim 1, wherein the first group name labels are displayed in a predefined number of rows from left to right.

3. The method of claim 1, wherein the preselected relational non-word name label is a non-word or a pseudoword, and either contains or does not contain at least one relational open proto-bigram (ROPB).

4. The method of claim 1, wherein the first and last letter of the preselected relational non-word name label is a preselected vowel letter or consonant letter.

5. The method of claim 1, wherein the first and second group name labels and a predefined list of ROPBs are displayed together in a predefined configuration.

6. The method of claim 1, wherein the first and second groups each have between 3 and 7 name labels.

7. The method of claim 1, wherein the N number of letters is from 3 to 5 letters.

8. The method of claim 1, wherein the first predefined time period of step b) is any time interval from 5 to 15 seconds for each displayed first group non-word name label.

9. The method of claim 1, wherein the second predefined time period of step c) is any time interval from 5 to 15 seconds for each displayed second group word name label.

10. The method of claim 1, wherein the third predefined time period of step d) is any time interval from 5 to 15 seconds for each displayed second group word name label.

11. The method of claim 1, wherein the first, second, and/or third predefined time periods are adjusted according to a predefined performance criteria.

12. The method of claim 1, wherein the common orthographic serial order letter patterns between the second group and the first group name labels are selected from one or more of the group including: a) same ROPB(s) in some or all of the displayed name labels; b) same serial order of vowel letters or consonant letters in some or all of the displayed name labels; c) first and/or last letters of the displayed name labels are either all consonant letters or all vowel letters; d) first, second, and/or third consecutive pairs of letters in the displayed name labels all have either a direct or inverse alphabetical order; and e) same alphabetical ordinal distance between pairs of letters in the displayed name labels for some or all of the pairs of letters.

13. The method of claim 1, wherein the sensory motor activity is selected from the group of mouse-clicking the name label, voicing each of the name label letters in a sequential manner, touching one or more letters of the name label in a sequential manner with a finger or stick, or combinations thereof.

14. The method of claim 1, wherein the changed spatial and/or time perceptual related attributes of the two letters forming a discriminated sub-word ROPB name label in a correctly sensory motor selected carrier word name label are different than the changed spatial and/or time perceptual related attributes of the other letters in the correctly selected carrier word name label.

15. The method of claim 1, wherein the changed spatial and/or time perceptual related attributes of a second group word name label located in a right visual field of the subject is different than the changed spatial and/or time perceptual related attributes of a second group word name label located in a left visual field of the subject.

16. The method of claim 1, wherein if the subject fails to perform the sensory motor activity in step e) for a time interval greater than 30 seconds, then the iteration is immediately exited and a new iteration according to a predefined sequence of iterations begins.

17. The method of claim 1, wherein the predefined number of iterations is between 3 and 10.

18. The method of claim 16, wherein the subject does not receive any performance feedback when failing to sensory motor perform or when failing to make a correct sensory motor selection after either three consecutive attempts or more than two non-consecutive attempts.

19. A computer program product for promoting fluid intelligence abilities in a subject, stored on a non-transitory computer-readable medium, which when executed causes a computer system to perform a method comprising the steps of:
a) displaying a first group of different non-word name labels all having N number of letters, wherein the letters follow a preselected serial order pattern starting with either a consonant letter followed by a vowel letter or a vowel letter followed by a consonant letter; and further displaying a preselected relational non-word name label of N plus at least one additional letter to represent the first group;
b) prompting the subject to sensorially perceptually search and discriminate, in a first predefined time period, any common orthographic serial order letter patterns, which may include one or more relational open proto-bigrams (ROPB) letter sequences, between the first group and the preselected relational non-word name label;
c) displaying a second group of different word name labels all having the same N number of letters, during a second predefined time period, wherein each word name label has a semantic meaning and each non-word name label does not have a semantic meaning;
d) prompting the subject to compare the first and second groups, during a third predefined time period, to sensorially perceptually discriminate which word name labels, if any, share one or more common orthographic serial order letter patterns with the first group;
e) prompting the subject to immediately sensory motor select any discriminated word name label having the one or more common orthographic serial order letter patterns, including the ROPB letter sequences of step b);
f) if the sensory motor selection made by the subject is a correct selection, then immediately changing at least one spatial and/or time perceptual related attribute of the correctly selected word name label according to a predefined program;
g) repeating the above steps for a predefined number of iterations; and
h) providing the subject with a score at the end of the predefined number of iterations.

20. A system for promoting fluid intelligence abilities in a subject, the system comprising:
a computer system comprising:
a processor, memory, and a graphical user interface (GUI),
wherein the processor contains instructions for:
a) displaying a first group of different non-word name labels all having N number of letters on the GUI, wherein the letters follow a preselected serial order pattern starting with either a consonant letter followed by a vowel letter or a vowel letter followed by a consonant letter; and further displaying a preselected relational non-word name label of N plus at least one additional letter on the GUI to represent the first group;
b) prompting the subject on the GUI to sensorially perceptually search and discriminate, in a first predefined time period, any common orthographic serial order letter patterns, which may include one or more relational open proto-bigrams (ROPB) letter sequences, between the first group and the preselected relational non-word name label;
c) displaying a second group of different word name labels all having the same N number of letters on the GUI during a second predefined time period, wherein each word name label has a semantic meaning and each non-word name label does not have a semantic meaning; d) prompting the subject on the GUI to compare the first and second groups, during a third predefined time period, to sensorially perceptually discriminate which word name labels, if any, share one or more common orthographic serial order letter patterns with the first group;
e) prompting the subject on the GUI to immediately sensory motor select any discriminated word name label having the one or more common orthographic serial order letter patterns, including the ROPB letter sequences of step b);
f) if the sensory motor selection made by the subject is a correct selection, then immediately changing at least one spatial and/or time perceptual related attribute of the correctly selected word name label on the GUI according to a predefined program;
g) repeating the above steps for a predefined number of iterations; and
h) providing the subject with a score on the GUI at the end of the predefined number of iterations.
